(19) United States
(12) Patent Application Publication
(10) Pub. No.: US 2025/0162850 A1
(43) Pub. Date: May 22, 2025

(54) LIFT DEVICE

(71) Applicant: Oshkosh Corporation, Oshkosh, WI (US)

(72) Inventors: Wenton Miller, Oshkosh, WI (US); Scott Riley, Oshkosh, WI (US); Aaron Powers, Oshkosh, WI (US); James Smyly, Oshkosh, WI (US); Taylor Ramsey, Oshkosh, WI (US); Jeff Schaeffer, Oshkosh, WI (US); Matthew Gilbride, Oshkosh, WI (US); Robert Law, Jr., Oshkosh, WI (US); David Roncin, Oshkosh, WI (US); Eric Hackenberg, Oshkosh, WI (US); Nick Jones, Oshkosh, WI (US); Peter Gilbert, Oshkosh, WI (US); Bogdan Marinoiu, Oshkosh, WI (US); David Lombardo, Oshkosh, WI (US); Daniel Yednock, Oshkosh, WI (US)

(73) Assignee: Oshkosh Corporation, Oshkosh, WI (US)

(21) Appl. No.: 18/814,390

(22) Filed: Aug. 23, 2024

Related U.S. Application Data
(60) Provisional application No. 63/578,593, filed on Aug. 24, 2023.
(60) Provisional application No. 63/578,597, filed on Aug. 24, 2023.
(60) Provisional application No. 63/654,626, filed on May 31, 2024.
(60) Provisional application No. 63/534,433, filed on Aug. 24, 2023.
(60) Provisional application No. 63/534,434, filed on Aug. 24, 2023.
(60) Provisional application No. 63/578,601, filed on Aug. 24, 2023.
(60) Provisional application No. 63/534,435, filed on Aug. 24, 2023.
(60) Provisional application No. 63/534,428, filed on Aug. 24, 2023.
(60) Provisional application No. 63/682,959, filed on Aug. 14, 2024.

(51) Int. Cl. B66F 11/04

(52) U.S. Cl. CPC B66F 11/044

(57) ABSTRACT

A system may include a boom assembly comprising a base member and an extension member. The system may include a hydraulic assembly comprising: a cylinder housing having an internal cavity, a piston positioned partially within the internal cavity and coupled to the extension member at a distal end of the piston, a piston head coupled to the piston at a proximal end of the piston, the piston head located within the cylinder, a pressure tube coupled to the cylinder and positioned within the internal cavity, a sensor element extending within the pressure tube, and a magnet coupled to the piston and proximate at least a portion of the sensor element.

### CROSS-REFERENCE TO RELATED PATENT APPLICATIONS

This application (a) claims the benefit of: (i) U.S. Provisional Application No. 63/578,593, filed Aug. 24, 2023; (ii) U.S. Provisional Application No. 63/654,626, filed May 31, 2024; (iii) U.S. Provisional Application No. 63/578,597, filed Aug. 24, 2023; (iv) U.S. Provisional Application No. 63/682,959, filed Aug. 14, 2024; (v) U.S. Provisional Application No. 63/534,435, filed Aug. 24, 2023; (vi) U.S. Provisional Application No. 63/534,428, filed Aug. 24, 2023; (vii) U.S. Provisional Application No. 63/534,433, filed Aug. 24, 2023; (viii) U.S. Provisional Application No. 63/578,601, filed Aug. 24, 2023; and (ix) U.S. Provisional Application No. 63/534,434, filed Aug. 24, 2023, and (b) is related to: (i) U.S. patent application Ser. No. ______ (Atty. Dkt. No. 061300-6271), filed Aug. 23, 2024, which claims the benefit of U.S. Provisional Application No. 63/578,593, filed Aug. 24, 2023, and U.S. Provisional Application No. 63/654,626, filed May 31, 2024; (ii) U.S. patent application Ser. No. ______ (Atty. Dkt. No. 061300-6278), filed Aug. 23, 2024, which claims the benefit of U.S. Provisional Application No. 63/578,597, filed Aug. 24, 2023, and U.S. Provisional Application No. 63/682,959, filed Aug. 14, 2024; (iii) U.S. patent application Ser. No. ______ (Atty. Dkt. No. 061300-6276), filed Aug. 23, 2024, which claims the benefit of U.S. Provisional Application No. 63/534,435, filed Aug. 24, 2023; (iv) U.S. patent application Ser. No. ______ (Atty. Dkt. No. 061300-6273), filed Aug. 23, 2024, which claims the benefit of U.S. Provisional Application No. 63/534,428, filed Aug. 24, 2023; (v) U.S. patent application Ser. No. ______ (Atty. Dkt. No. 061300-6275), filed Aug. 23, 2024, which claims the benefit of U.S. Provisional Application No. 63/534,433, filed Aug. 24, 2023; (vi) U.S. patent application Ser. No. ______ (Atty. Dkt. No. 061300-6280), filed Aug. 23, 2024, which claims the benefit of U.S. Provisional Application No. 63/578,601, filed Aug. 24, 2023; (vii) U.S. patent application Ser. No. ______ (Atty. Dkt. No. 061300-6282), filed Aug. 23, 2024, which claims the benefit of U.S. Provisional Application No. 63/534,434, filed Aug. 24, 2023, all of which are incorporated herein by reference in their entireties.

### BACKGROUND

The present disclosure relates to lift devices. More specifically, the present disclosure relates to measuring the position of lift devices, a system for facilitating relative movement between a chassis and a turntable of a vehicle, controlling lift devices, charging lift devices, energy storage systems for lift devices, and a sensor mount for monitoring rotating joints in a lift device.

### SUMMARY

In some aspects, the techniques described herein relate to a lift device including: a boom assembly including a base member and an extension member; and a hydraulic assembly including: a cylinder housing having an internal cavity, a piston positioned at least partially within the internal cavity and coupled to the extension member at a distal end of the piston, a piston head coupled to the piston at a proximal portion of the piston, the piston head located within the cylinder, a pressure tube extending through the piston head and at least a portion of the piston, a sensor element extending within the pressure tube, and a magnet positioned between the piston head and the proximal end of the piston.

In some aspects, the techniques described herein relate to a lift device, further including a first magnet spacer positionally proximate the magnet at a first face of the magnet and a second magnet spacer positionally proximate the magnet at a second face of the magnet.

In some aspects, the techniques described herein relate to a lift device, wherein the magnet is a hollow cylinder radially disposed about the pressure tube.

In some aspects, the techniques described herein relate to a lift device, wherein the magnet is positioned between an internal face of the piston head and a proximal face of the cylinder.

In some aspects, the techniques described herein relate to a lift device, further including: a retention plate having a first face positionally proximate the proximal face of the cylinder; a first spacer having a first spacer face positionally proximate a second face of the retention plate and a second spacer face of the first spacer positionally proximate a first magnet face of the magnet; and a second spacer having a third spacer face positionally proximate a second magnet face of the magnet.

In some aspects, the techniques described herein relate to a lift device, further including a wave washer having a first washer face positionally proximate a fourth spacer face of the second spacer, and a second washer face positionally proximate an internal face of the piston head.

In some aspects, the techniques described herein relate to a lift device, wherein a fourth spacer face of the second spacer is positionally proximate an internal face of the piston head.

In some aspects, the techniques described herein relate to a lift device, wherein the sensor element is magnetorestrictive wire.

In some aspects, the techniques described herein relate to a lift device, further including a plug coupled to a distal end of the pressure tube, the plug sealing an interior of the pressure tube from the interior of the cylinder.

In some aspects, the techniques described herein relate to a lift device, wherein the sensor element extends through a position sensor, wherein the position sensor is an induction pickup coil.

In some aspects, the techniques described herein relate to a lift device including: a base assembly; a boom assembly coupled with the base assembly and configured to extend and retract, the boom assembly including: an extension member, a base member, configured to house the extension member, a cylinder coupled to the base member, and a piston positioned at least partially within the cylinder and coupled to the extension member and configured to extend the extension member; a platform assembly coupled with an end of the extension member of the boom assembly, the platform assembly configured to be raised and lowered by the boom assembly; and a control system including processing circuitry configured to: receive, from a sensor internal to the cylinder, a signal corresponding to a position of the extension member in relation to the base member, assign a value to the signal, determine, based on the value, a position of the extension member, and transmit the position of the extension member.

In some aspects, the techniques described herein relate to a lift device, wherein the sensor uses microwaves to measure the position of the extension member.

In some aspects, the techniques described herein relate to a lift device, wherein the sensor is a magnetorestrictive position sensor housed within a pressure tube extending within the cylinder.

In some aspects, the techniques described herein relate to a lift device, wherein the sensor uses microwaves to measure the position of the extension member.

In some aspects, the techniques described herein relate to a lift device including: a base assembly; a boom assembly coupled with the base assembly and configured to extend and retract, the boom assembly including: an extension member, a base member, configured to house the extension member, and a cylinder coupled to the base member and the extension member and configured to extend the extension member; a platform assembly coupled with an end of the extension member of the boom assembly, the platform assembly configured to be raised and lowered by the boom assembly; and a control system including processing circuitry configured to: receive, from a sensor external to the cylinder, a signal corresponding to a position of the extension member in relation to the base member; assign a value to the signal; determine, based on the value, a position of the extension member; and transmit the position of the extension member.

In some aspects, the techniques described herein relate to a lift device, wherein the sensor is a magnetorestrictive sensor including a magnet and a sensing element.

In some aspects, the techniques described herein relate to a lift device, wherein the magnet is coupled to the base member.

In some aspects, the techniques described herein relate to a lift device, wherein the magnet is coupled to the extension member.

In some aspects, the techniques described herein relate to a lift device, further including: a magnetorestrictive wire coupled to the base member; and a magnet coupled to the extension member.

In some aspects, the techniques described herein relate to a lift device, wherein the magnet moves relative to the magnetorestrictive wire during movement of the extension member.

At least one embodiment relates to a lift device. The lift device includes a base assembly having a drive motor, a platform assembly, a lift assembly coupled between the base assembly and the platform assembly and including a lift actuator configured to raise or lower the platform assembly, a rotary motor configured to rotate the platform assembly, and a controller in communication with the drive motor, the lift actuator, and the rotary motor. The controller is configured to record steps performed by the lift actuator and the rotary motor during a positioning event that moves the platform assembly from an initial position to a work site, and operate the lift actuator and the rotary motor to perform the steps performed during the positioning event in a reverse order and in a movement direction that is opposite to a direction of the steps recorded during the positioning event to automate movement of the platform assembly from the work site to the initial position.

At least one embodiment relates to a lift device. The lift device includes a base assembly including a drive motor, a platform assembly, a lift assembly coupled between the base assembly and the platform assembly and including a plurality of actuators configured to move the platform assembly relative to the base assembly, a user interface configured to receive one or more inputs and control operation of the plurality of actuators, and a controller in communication with the plurality of actuators and the user interface. The controller is configured to record steps input to the user interface during a positioning event that moves the platform assembly from an initial position to a work site, wherein each of the steps in the positioning event includes a first direction and a magnitude associated with moving one of the plurality of actuators, and operate the plurality of actuators to perform the steps recorded during the positioning event in a reverse order to automate movement of the platform assembly from the work site to the initial position, wherein each of the steps performed in the reverse order include a second direction, opposite to the first direction, and the magnitude associated with moving the one of the plurality of actuators recorded during the positioning event.

At least one embodiment relates to a method for controlling a platform assembly of a lift device. The method includes recording an input to a user interface during a positioning event that results in movement a platform assembly from an initial position to a work site. The input is recorded as a step that includes moving an actuator or motor in a first direction with a magnitude. The method further includes triggering a travel replay procedure, and in response to triggering the travel replay procedure, performing the step recorded during the positioning event in a reverse order to automate movement of the platform assembly from the work site to the initial position. The step performed in the reverse order includes moving the actuator or motor in a second direction, opposite to the first direction, and the magnitude.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

At least one embodiment relates to a vehicle including a chassis, a chassis component coupled to the chassis, a turntable rotatably coupled to the chassis, a turntable component coupled to the turntable, and a flexible member assembly. The flexible member assembly has a first end portion coupled to the chassis, a second end portion coupled to the turntable, and a wound portion between the first end portion and the second end portion. The flexible member assembly includes a flexible member coupling the chassis component to the turntable component.

Another embodiment relates to a lift device including a chassis, a chassis component coupled to the chassis, a turntable configured to rotate relative to the chassis about an axis of rotation, a lift assembly coupled to the turntable and including an actuator, a cable configured to transfer electrical energy between the chassis component and the actuator, a tray coupled to the chassis, a coil management arm coupled to the turntable, and a clamp radially offset from the axis of rotation. The cable has a first portion coupled to the chassis, a second portion, and a middle portion between the first portion and the second portion. The tray at least partially supports the middle portion of the cable. The clamp fixedly couples the second portion of the cable to the coil management arm. The coil management arm is configured to wrap the middle portion around the axis of rotation as the turntable rotates relative to the chassis.

Another embodiment relates to a coil management system for a vehicle including a cable extending between a chassis and a turntable. The coil management system includes a first clamp configured to couple a first end portion of the cable to the chassis of the vehicle, a coil management arm configured to be coupled to the turntable of the vehicle, a second clamp configured to fixedly couple a second end portion of the cable to the coil management arm, and a tray configured to be coupled to the chassis of the vehicle. The tray includes a horizontal support surface and a barrier extending upright from the horizontal support surface. The coil management arm is configured to cause the cable to wrap around the barrier in response to the turntable rotating relative to the chassis.

One embodiment of the present disclosure is a lift device. The lift device includes a base assembly, a lift assembly, a platform assembly, and a control system. The lift assembly is coupled with the base assembly. The lift assembly is configured to raise or lower. The platform assembly is coupled with an end of the lift assembly. The platform assembly is configured to be raised and lowered by the lift assembly. The control system includes processing circuitry. The processing circuitry is configured to receive a user input. The user input includes a request to move the platform assembly in a direction along a wall surface relative to the wall surface while maintaining a constant distance from the wall surface and orientation relative to the wall surface. The processing circuitry is configured to operate at least the lift assembly to move the platform assembly in the direction along the wall surface.

In some embodiments, the user input includes a request to move the platform assembly upwards along the wall surface, downwards along the wall surface, left along the wall surface, or right along the wall surface. In some embodiments, the user input includes a request to move the platform assembly in the direction along the wall surface in a fixed coordinate system that is offset from the wall surface.

In some embodiments, the control system is configured to operate at least the lift assembly to move the platform assembly in the direction along a concave surface. In some embodiments, the control system is configured to operate at least the lift assembly to move the platform assembly in the direction along a convex surface.

In some embodiments, the control system is configured to operate at least the lift assembly to move the platform assembly in the direction along a flat surface. In some embodiments, the control system further includes multiple sensors disposed on the platform assembly. The sensors are configured to measure a distance between the platform assembly and the wall surface. The processing circuitry is configured to operate the lift assembly according to the request to move the platform assembly in the direction along the wall surface while maintaining a specific distance between the platform assembly and the wall surface based on feedback from the sensors.

Another embodiment of the present disclosure is a system for a lift device. The lift device includes a platform assembly and processing circuitry. The platform assembly is coupled with an end of a lift assembly. The platform assembly is configured to be raised and lowered by the lift assembly. The processing circuitry is configured to receive a user input. The user input includes a request to move the platform assembly in a direction along a local coordinate system of a wall surface. The processing circuitry is also configured to operate at least the lift assembly to move the platform assembly in the direction along the wall surface.

In some embodiments, the user input includes a request to move the platform assembly upwards along the wall surface, downwards along the wall surface, left along the wall surface, or right along the wall surface. In some embodiments, the user input includes a request to move the platform assembly in the direction along the wall surface in a fixed plane that is offset from the wall surface.

In some embodiments, the system is configured to operate at least the lift assembly to move the platform assembly in the direction along a concave surface. In some embodiments, the system is configured to operate at least the lift assembly to move the platform assembly in the direction along a convex surface. In some embodiments, the system is configured to operate at least the lift assembly to move the platform assembly in the direction along a flat surface.

In some embodiments, the system further includes multiple sensors disposed on the platform assembly. The sensors are configured to measure a distance between the platform assembly and the wall surface. The processing circuitry is configured to operate the lift assembly according to the request to move the platform assembly in the direction along the wall surface while maintaining a specific distance between the platform assembly and the wall surface based on feedback from the sensors.

Another embodiment of the present disclosure is a method of controlling a lift device. The method includes obtaining a user input indicating a requested direction of motion of a platform assembly relative to a wall surface. The method also includes determining a control of actuators of a lift assembly on which the platform assembly is coupled. The method includes operating the actuators of the lift assembly to move the platform assembly in the requested direction relative to the wall surface.

In some embodiments, the requested direction includes a direction of motion relative to a local coordinate system of the wall surface. In some embodiments, the wall surface includes a concave or convex wall surface and the requested direction of motion includes a requested direction of motion of the platform assembly along the concave or convex wall while maintaining a constant distance and orientation of the platform assembly relative to the concave or convex wall.

In some embodiments, the method includes obtaining sensor data from multiple sensors disposed on the platform assembly. The sensors are configured to measure a distance between the platform assembly and the wall surface. The method also includes determining the control of the actuators based on the sensor data in order to move the platform assembly in the requested direction relative to the wall surface while maintaining a specific distance and orientation between the platform assembly and the wall surface based on feedback from the sensors.

In some embodiments, the user input includes an upwards, downward, left, or right direction of motion relative to the wall surface. In some embodiments, the control of the actuators are determined to move the platform assembly in the upwards, downward, left, or right direction of motion relative to the wall surface while maintaining a specific distance between the platform assembly and the wall surface.

In some embodiments, the method includes obtaining a selection of a mode of operation from multiple modes of operation including a distance mode or a fixed plane mode. In the distance mode, the method comprises operating the lift assembly to maintain a current distance between the platform assembly and the wall surface. In the fixed plane mode, the method includes operating the lift assembly to maintain the platform assembly within a fixed plane of movement at a fixed orientation.

One embodiment relates to a vehicle. The vehicle includes an energy storage device, a door configured to move between an open position and a closed position relative to the vehicle, an onboard power connector electrically coupled with the energy storage device, and a controller. An external power connector electrically coupled with an external power source is configured to couple with the onboard power connector to facilitate transferring electrical energy from the external power source to the energy storage device. The controller is configured to monitor a position of the door and limit the transfer of electrical energy from the external power source to the energy storage device when (i) the external power connector is coupled with the onboard power connector and (ii) the door is in the open position.

Another embodiment relates to a control system for a vehicle. The vehicle includes a one or more processing circuits configured to determine, responsive to detection of a connector, that the vehicle is electrically coupled with a power source via the connector, the power source configured to provide power to charge a battery of the vehicle, receive, via the connector, from the power source, a first signal to initiate charging of the battery, transmit, via the connector, to the power source, a second signal to indicate a first plurality of parameters to define a first amount of power to receive from the power source, electrically couple, via the connector, the battery with the power source to charge the battery using the first amount of power, detect that a component of the vehicle has moved from a first position to a second position, and transmit, via the connector, to the power source, a third signal to indicate a second plurality of parameters to define a second amount of power to receive from the power source.

Still another embodiment relates to a method for charging a vehicle. The method includes providing the vehicle including an energy storage device, an onboard power connector electrically coupled with the energy storage device, and a door configured to move between an open position and a closed position relative to the vehicle to provide selective access to the onboard power connector, monitoring a position of the door, determining whether the door is in the open position or the closed position, determining whether an external power connector is coupled with the onboard power connector, wherein the external power connector is electrically coupled with an external power source, and limiting the transfer of electrical energy from the external power source to the energy storage device based on a determination that (i) the external power connector is coupled with the onboard power connector and (ii) the door is in the open position.

One embodiment of the present disclosure is a battery pack for a lift device. The battery pack includes a housing, multiple battery cells, a resistor, a conductive element, and a member. The housing includes an opening. The battery cells are positioned within the housing. The resistor is electrically coupled with a positive terminal of the plurality of battery cells and is positioned within the housing. The conductive element is positioned within the housing and is configured to transition between an open state in which a discharge path is not defined between the positive terminal of the battery cells and a negative terminal or a ground, and a closed state in which the discharge path is defined between the positive terminal of the battery cells to the negative terminal or the ground through the resistor. The member is disposed at the opening and accessible from an exterior of the housing. The member is manually transitionable by a technician between a first state in which the conductive element is in the first state, and a second state in which the conductive element is driven into the second state such that the plurality of battery cells discharge remaining electrical energy via the discharge path.

In some embodiments, the member includes a plate having a protrusion in a center. In the first state, the member is fastened over the opening such that the protrusion is external to the housing. In the second state, the member is fastened over the opening such that the protrusion extends into the housing through the opening and drives the conductive element into the closed state.

In some embodiments, the member includes a screw configured to be received within the opening. The screw is configured to be accessed from the exterior of the housing by the technician such that the screw is driven to rotate to translate into the second state to bias the conductive element into the closed state.

In some embodiments, the conductive element includes a cantilever beam having a fixed end and a free end. The conductive element is configured to be driven by the member to bend such that a protrusion of the free end engages the negative terminal or the ground in the closed state.

In some embodiments, the battery pack includes an insulator disposed on a side of the conductive element opposite a side from which a protrusion extends. The member is configured to engage the insulator to transition the conductive element from the open state to the closed state.

In some embodiments, the battery pack includes a spacer disposed on a tip of the conductive element. The spacer is configured to align the tip of the conductive element and deform as the conductive element is driven by the member to the closed state. In some embodiments, conductive element includes a cantilever beam having a fixed end coupled with the housing and a free end configured to be driven to engage the negative terminal or the ground in the closed state.

Another embodiment of the present disclosure is a lift device. The lift device includes a lift assembly, and a battery pack. The lift assembly is configured to raise or lower. The battery pack is configured to provide electrical energy to the lift assembly. The battery pack includes a housing, battery cells, a resistor, a conductive element, and a member. The housing includes an opening. The battery cells are positioned within the housing. The resistor is electrically coupled with a positive terminal of the battery cells and is positioned within the housing. The conductive element is positioned within the housing and is configured to transition between an open state in which a discharge path is not defined between the positive terminal of the battery cells and a negative terminal or a ground, and a closed state in which the discharge path is defined between the positive terminal of the battery cells to the negative terminal or the ground through the resistor. The member is disposed at the opening and is accessible from an exterior of the housing. The member is manually transitionable by a technician between a first state in which the conductive element is in the first state, and a second state in which the conductive element is driven into the second state such that the battery cells discharge remaining electrical energy via the discharge path.

In some embodiments, the member includes a plate having a protrusion in a center. In the first state the member is fastened over the opening such that the protrusion is external to the housing. In the second state, the member is fastened over the opening such that the protrusion extends into the housing through the opening and drives the conductive element into the closed state.

In some embodiments, the member includes a screw configured to be received within the opening. The screw is configured to be accessed from the exterior of the housing by the technician such that the screw is driven to rotate to translate into the second state to bias the conductive element into the closed state.

In some embodiments, the conductive element includes a cantilever beam having a fixed end and a free end. The conductive element is configured to be driven by the member to bend such that a protrusion of the free end engages the negative terminal or the ground in the closed state.

In some embodiments, the battery pack comprises an insulator disposed on a side of the conductive element opposite a side from which a protrusion extends. The member is configured to engage the insulator to transition the conductive element from the open state to the closed state.

In some embodiments, the battery pack further includes a spacer disposed on a tip of the conductive element. The spacer is configured to align the tip of the conductive element and deform as the conductive element is driven by the member to the closed state.

In some embodiments, the conductive element includes a cantilever beam having a fixed end coupled with the housing and a free end configured to be driven to engage the negative terminal or the ground in the closed state. In some embodiments, the lift device is a fully electric boom.

Another embodiment of the present disclosure is a method of completely discharging a battery. The method includes providing a device including a removable battery. The removable battery includes a member configured to be transitioned between a first state and a second state. The method also includes performing an operation with the device using energy provided by the removable battery. The method also includes removing the removable battery from the device. The method also includes transitioning the member from the first state into the second state such that a discharge electrical path is defined across terminals of cells of the removable battery through a resistor to completely discharge the cells of the removable battery.

In some embodiments, transitioning the member from the first state to the second state includes removing the member from a side of a housing of the removable battery. The member includes a protrusion on one side with the protrusion oriented in an outwards direction when the member is in the first state. The method also includes re-orienting and reinstalling the member in the second state on the side of the housing such that the protrusion extends through an opening in the housing of the removable battery and biases a conductive member to contact a negative terminal or ground of the removable battery such that energy is depleted from cells of the removable battery through a resistor.

In some embodiments, transitioning the member from the first state to the second state includes screwing the member into a side of a housing of the removable battery such that the member protrudes further into the removable battery and drives a conductive member to contact a negative terminal or ground of the removable battery such that energy is depleted from cells of the removable battery through a resistor. In some embodiments, transitioning the member from the first state to the second state drives a conductive member having the form of a cantilever beam into engagement with a ground or a negative terminal of the removable battery. The conductive member is electrically coupled with a positive terminal of the removable battery through a resistor. In some embodiments, transitioning the member from the first state to the second state includes removing a fastener that couples the member with a side of a housing of the removable battery, re-orienting the member, and re-installing the fastener.

At least one embodiment relates to a lift device including a base assembly and a lift assembly coupled with the base assembly and configured to raise or lower a platform coupled with an end of the lift assembly. The lift assembly includes an arm supported by the base assembly and a first pivot comprising a first pivot pin, the arm rotatably relative to the base assembly by the first pivot. The lift assembly further includes a rotary sensor supported by the base assembly, the rotary sensor configured to monitor a rotation of one of the arm or the first pivot pin about an axis. The rotary sensor includes a mounting cup configured to receive at least a portion of the first pivot pin, wherein the first pivot pin is rotatable relative to the mounting cup; an indicator coupled to one of the portion of the first pivot pin or the mounting cup, an electronic sensor coupled to the other of the portion of the first pivot pin or the mounting cup, the electronic sensor configured to monitor a rotation of the indicator, and a resilient member configured to exert at least one of an axial force or torsional force on the mounting cup along the axis.

Another embodiment relates to a rotary sensor for a work machine including a mounting cup configured to receive at least a portion of a pin configured to rotate relative to the mounting cup about an axis, an indicator coupled to one of the mounting cup or the pin, an electronic sensor coupled to the other of the mounting cup or the pin, the electronic sensor configured to monitor a rotation of the indicator, a resilient member configured to exert at least one of an axial force or torsional force on the mounting cup along the axis, and a fixed rod extending partially within the mounting cup, wherein the fixed rod prevents the mounting cup from rotating 360 degrees.

Another embodiment relates to A pin joint for a work machine including a first member including a fork with a first side and a second side, wherein the first side and the second side have concentric fork apertures, a second member including an eye, wherein the eye is concentric with the fork apertures, and a pin extending through the fork apertures and the eye to rotatably couple to the first member and the second member. The pin is fixedly coupled to the second member via a bolt passing through the second member and the pin orthogonal to a rotational axis of the pin, wherein the bolt is retained by a cone-shaped bushing, and the bolt passes through the threaded aperture of the second member, a threaded center of the bushing, the pin, and a second aperture of the second member to secure the pin to the second member.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a lift device, according to some embodiments

FIG. 2 is a perspective view of a base of the lift device of FIG. 1, according to some embodiments.

FIG. 3 is a perspective view of an axle assembly of the lift device of FIG. 1, according to some embodiments.

FIG. 4 is a perspective view of a platform assembly of the lift device of FIG. 1, according to some embodiments.

FIG. 5A is a section view of a portion of a boom assembly with an internal position sensor of the lift device of FIG. 1, according to some embodiments.

FIG. 5B is a section view of a portion of the boom assembly of FIG. 5A with an internal position sensor, according to some embodiments.

FIG. 5C is a perspective view of a portion of the boom assembly of FIG. 5A with an internal position sensor, according to some embodiments.

FIG. 5D is a section view of a portion of a boom assembly, according to some embodiments.

FIG. 6A is a perspective view of a portion of a boom assembly with an external position sensor of the lift device of FIG. 1, according to some embodiments.

FIG. 6B is a perspective view of a portion of the boom assembly of FIG. 6A with an external position sensor, according to some embodiments.

FIG. 6C is a perspective view of a portion of the boom assembly of FIG. 6A with an external position sensor, according to some embodiments.

FIG. 7 is a perspective view of a portion of a boom assembly of the lift device of FIG. 1 with an external position sensor, according to some embodiments.

FIG. 8A is a perspective view of a boom assembly of FIG. 1 with an external position sensor, according to some embodiments.

FIG. 8B is a front view of the external position sensor of FIG. 8A, according to some embodiments.

FIG. 9 is a side view of the boom assembly of FIG. 1 with a position sensor, according to some embodiments.

FIG. 10A is a bottom view of the boom assembly of FIG. 1 with a position sensor, according to some embodiments.

FIG. 10B is a rear view of the boom assembly of FIG. 1 with a position sensor, according to some embodiments.

FIG. 11A is a perspective view of the boom assembly of FIG. 1 with an external position sensor, according to some embodiments.

FIG. 11B is a perspective view of the external position sensor of FIG. 11A, according to some embodiments.

FIG. 12A is a section view of the boom assembly of FIG. 1 with an internal position sensor, according to some embodiments.

FIG. 12B is a section view of the internal position sensor of FIG. 12A, according to some embodiments.

FIG. 13 is a side view of a boom assembly of FIG. 1 with a position sensor, according to some embodiments.

FIGS. 14A-14C illustrate various rear views of a position sensor, according to some embodiments.

FIG. 15 is a section view of an internal position sensor, according to an embodiment.

FIG. 16A is a perspective view of an external position sensor mounted on a hydraulic assembly, according to an embodiment.

FIG. 16B is a section view of the position sensor of FIG. 16A, according to an embodiment.

FIG. 17A is a perspective view of an external position sensor mounted between boom arms, according to an embodiment.

FIG. 17B is a section view of the position sensor of FIG. 17A, according to an embodiment.

FIG. 17C is a perspective view of a mounting element for the position sensor of FIG. 17A, according to an embodiment.

FIG. 18 is a side, section view of the position sensor of FIG. 17A, according to an embodiment.

FIG. 19 is a front, section view of the position sensor of FIG. 17A, according to an embodiment.

FIG. 20 is a perspective view of a lift device with a platform assembly positioned at a work site, according to some embodiments;

FIG. 21 is a schematic illustration of a platform assembly of a lift device moving from an initial position to a work site, according to some embodiments;

FIG. 22 is a block diagram of a control system of the lift device of FIG. 1, according to some embodiments; and

FIG. 23 is a flowchart outlining the steps in a method of operating a lift device, according to some embodiments.

FIG. 24 is a front section view of a coil management system that connects the base of FIG. 2 and a turntable of the lift device of FIG. 1, according to some embodiments.

FIG. 25 is an exploded view of the coil management system of FIG. 24.

FIG. 26 is a top section view of the coil management system of FIG. 24.

FIG. 27 is a perspective view of a portion of the coil management system of FIG. 24.

FIG. 28 is a perspective view of a coil management system that connects the base of FIG. 2 and the turntable of FIG. 24, according to another embodiment.

FIG. 29 is a front section view of the coil management system of FIG. 28 with the base of FIG. 2 and the turntable of FIG. 24.

FIGS. 30-32 are perspective views of the coil management system of FIG. 28.

FIG. 33 is a top view of the coil management system of FIG. 28.

FIG. 34 is a top view of the coil management system of FIG. 28.

FIG. 35 is a perspective view of a flexible member assembly of the coil management system of FIG. 28.

FIGS. 36-38 are perspective views of a tray and a coil management arm of the coil management system of FIG. 28.

FIG. 39 is a top view of the lift device of FIG. 1 including a control system for following a flat surface, according to some embodiments.

FIG. 40 is a side view of the lift device of FIG. 39, according to some embodiments.

FIG. 41 is a top view of the lift device of FIG. 39 following a concave surface, according to some embodiments.

FIG. 42 is a side view of the lift device of FIG. 41, according to some embodiments.

FIG. 43 is a top view of the lift device of FIG. 39 following a convex surface, according to some embodiments.

FIG. 44 is a side view of the lift device of FIG. 43, according to some embodiments.

FIG. 45 is a block diagram of the control system of FIG. 39 configured to receive user inputs to adjust position of a platform assembly relative to a wall surface and control actuators of the lift device to move the platform assembly along the wall surface, according to some embodiments.

FIG. 46 is a flow diagram of a process for operating a lift device to follow a wall surface, according to some embodiments.

FIG. 47 is a perspective view of a platform assembly for the lift device of FIG. 39 including multiple platform sensors, according to some embodiments.

FIG. 48 is a diagram of articulable and adjustable components of the lift device of FIG. 1 illustrated by vectors, according to some embodiments.

FIG. 49 is a side view of the lift device of FIG. 1 including a door in an open position and a plurality of sensors, according to some embodiments.

FIG. 50 is a perspective view of the lift device of FIG. 1 including a sensor and a bracket assembly, according to some embodiments.

FIG. 51 is a side view of the sensor and bracket assembly of FIG. 50 with the door in the open position, according to some embodiments.

FIG. 52 is a side view of the sensor and bracket assembly of FIG. 50 with the door in a closed position, according to some embodiments.

FIG. 53 is a perspective view of a sensor of the lift device of FIG. 1, according to some embodiments.

FIG. 54 is a front view of a power connector interlock system of the lift device of FIG. 1 with the door in the open position, according to some embodiments.

FIG. 55 is a front view of the power connector interlock system of FIG. 54 with the door in the closed position, according to some embodiments.

FIG. 56 is a diagram of the power connector interlock system of FIG. 54, according to some embodiments.

FIG. 57 is a diagram of the power connector interlock system of FIG. 54 including a relay system, according to some embodiments.

FIG. 58 is a flow diagram of a method for charging the lift device of FIG. 1, according to some embodiments.

FIG. 59 is a block diagram of a system to control charging of a battery, according to some embodiments.

FIG. 60 is a block diagram including a schematic block diagram of one or more components for a machine power system, according to some embodiments.

FIG. 61 is a sequence diagram of a process to control charging of a battery for a machine, according to some embodiments.

FIG. 62 is a sequence diagram of a process to control charging of a battery for a machine, according to some embodiments.

FIG. 63 is a sequence diagram of a process to control charging of a battery for a machine, according to some embodiments.

FIG. 64 is a sequence diagram of a process to control charging of a battery for a machine, according to some embodiments.

FIG. 65 is a schematic block diagram including one or more components of the system illustrated in FIG. 60, according to some embodiments.

FIG. 66 is a schematic block diagram including one or more components of the system illustrated in FIG. 60, according to some embodiments.

FIG. 67 is a perspective view of a battery of the lift device of FIG. 1 with a member of the battery installed in a first position, according to some embodiments.

FIG. 68 is a perspective view of the member of the battery of FIG. 67 including a protrusion on one side, according to some embodiments.

FIG. 69 is a perspective view of a portion of the top of the battery of FIG. 67 with the member installed in a second position, according to some embodiments.

FIG. 70 is a perspective view of a portion of the top of the battery of FIG. 67 with the member removed, according to some embodiments.

FIG. 71 is a perspective view of a portion of the top of the battery of FIG. 67 with the member installed in a second position, according to some embodiments.

FIG. 72 is a sectional view of an interior of the battery of FIG. 67 including a discharge mechanism, with the member in the first position, according to some embodiments.

FIG. 73 is a sectional view of the interior of the battery of FIG. 67 including the discharge mechanism, with the member in the second position, according to some embodiments.

FIG. 74 is a sectional view of the interior of the battery of FIG. 67 including a discharge mechanism that includes a spacer, with the member in the first position, according to some embodiments.

FIG. 75 is a sectional view of the interior of the battery of FIG. 67 including the discharge mechanism that includes the spacer, with the member in the second position, according to some embodiments.

FIG. 76 is a flow diagram of a process for using and discharging a battery of electrical equipment, according to some embodiments.

FIG. 77 is a sectional view of the interior of the battery of FIG. 67 including another discharge mechanism that includes a screw to initiate discharge of the battery, according to some embodiments.

FIG. 78 is a right side of the lift device of FIG. 1 including a modular turntable hood.

FIG. 79 is a perspective view of a pivot point of the lift device of FIG. 78 including a rotary sensor mount.

FIG. 80 is a perspective view of an interior of the rotary sensor mount of FIG. 79.

FIG. 81 is another perspective view of an interior of the rotary sensor mount of FIG. 79.

FIG. 82 is a perspective view of a rotary sensor mount for the lift device of FIG. 1, according to another embodiment.

FIG. 83 is a perspective view of a mounting cup of the rotary sensor mount of FIG. 79.

FIG. 84 is a perspective view of a pin of a rotary sensor mount of FIG. 79.

FIG. 85 is a section view of the rotary sensor mount of FIG. 79.

FIG. 86 is perspective view of a pivot point of a lift device with a bolt assembly.

FIG. 87 is a section view of the pivot point and bolt assembly of FIG. 86, according to some embodiments.

FIG. 88 is cross-section view of the bolt assembly of FIG. 86.

FIG. 89 is a perspective view of a rotary sensor mount for the lift device of FIG. 1, according to another embodiment.

FIG. 90 is a top view of the rotary sensor mount of FIG. 89.

FIG. 91 is a bottom view of the rotary sensor mount of FIG. 89.

FIG. 92 is a front view of the rotary sensor mount of FIG. 89.

FIG. 93 is a perspective of a cross-section view of the rotary sensor mount of FIG. 92.

FIG. 94 is a top view of the cross-section view of FIG. 93.

FIG. 95 is a section view of the rotary sensor mount of FIG. 90.

FIG. 96 is a section view of the rotary sensor mount of FIG. 91.

FIG. 97 is a side view of the rotary sensor mount of FIG. 89.

FIG. 98 is a perspective view of a pivot point of the lift device of FIG. 78 including a rotary sensor mount, according to another embodiment.

FIG. 99 is a section view of the rotary sensor mount of FIG. 98.

FIG. 100 is a perspective view of a rotary sensor mount for the lift device of FIG. 1, according to another embodiment.

FIG. 101 is a section view of the rotary sensor mount of FIG. 100.

FIG. 102 is a perspective view of a rotary sensor mount for the lift device of FIG. 1, according to another embodiment.

FIG. 103 is a section view of the rotary sensor mount of FIG. 102.

FIG. 104 is a perspective view of a rotary sensor mount for the lift device of FIG. 1, according to another embodiment.

FIG. 105 is a perspective view of a rotary sensor mount for the lift device of FIG. 1, according to another embodiment.

FIG. 106 is a section view of a rotary sensor mount for the lift device of FIG. 1, according to another embodiment.

### DETAILED DESCRIPTION

Before turning to the figures, which illustrate the exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overview

Referring generally to the figures, a lift device includes a control system that is configured to receive a user input and operate the lift device. During operation of the lift device, a position sensor disposed on or within a lift assembly determines the position of an extension member of the lift assembly and transmits the determined position to at least a display panel of the lift device. Various position sensor embodiments are disclosed herein.

In general, a positioning event includes movement of one or more motors and/or actuators that results in placement of a platform at a work site where an operator can perform a job. Positioning events are typically difficult and time consuming for lift devices (e.g., boom lifts), often requiring several individual movements of different components on the lift device to reach a work site. Referring generally to the FIGURES, a lift device includes a control system (e.g., a controller) that is configured to record operations (e.g., movement of a platform, lift arms (tower, boom, jib, etc.), a turntable, and a base (drive motors)) during a positioning event as a platform is moved to a work site. Recording the operations during the positioning event enables the controller to implement a travel replay procedure (e.g., either in response to a request or input). The travel replay procedure may enable the controller to automate the recorded positioning event, either forward or backwards. For example, a positioning event may be recorded (e.g., first step to last step) while a platform is moved from an initial position to a work site.

Upon the platform reaching the work site, the controller is configured to implement the travel replay procedure to perform a reverse of each recorded step in the positioning event in a reverse order (e.g., last step to first step). For example, if a platform is raised in one step during the positioning event, the platform will be lowered the same amount during the travel replay procedure, or if a platform is rotated in a first direction during the positioning event, the platform will be rotated in a second direction, opposite to the first direction, in the travel replay procedure. In this way, for example, the process of returning the platform to the initial position is automated and does not require an operator to perform the complex order of steps that were used to reach the work site. In some embodiments, the replay procedure may automate the platform returning from the initial position to the work site by replaying the steps in the positioning event in a forward order (e.g., first step to last step). In some embodiments, the lift device includes one or more object detection sensors that are configured to override the travel replay procedure if an object is detected within a predefined distance of any portion of the lift device.

Referring generally to the Figures, a coil management system is shown according to various exemplary embodiments. Some lift devices include a chassis or base assembly that rests on the ground (e.g., directly or through one or more tractive elements) and a turntable that is rotatable relative to the chassis. Some such lift devices include systems (e.g., hydraulic systems, pneumatic systems, electrical systems, etc.) that extend between the turntable and the chassis. In order to function, such systems may require electrical or fluid (e.g., hydraulic, pneumatic, etc.) communication between the lift assembly 14 and the base assembly 12 (e.g., for data communication, to transfer electrical energy, to transfer hydraulic power, etc.).

Some lift devices form such a connection by directly connecting a flexible member (e.g., a hose or cable) between a chassis and a turntable. However, relative rotation between the base and the turntable twists the hose or cable. Accordingly, the potential for damage to the flexible member caused by twisting the flexible member limits the maximum rotation of the turntable. This rotational limitation is undesirable, as a rotational limit may require an operator to reverse direction to avoid hitting an operating limit. In other lift devices, slip rings, rotary unions, rotary joints, or other rotational connectors are used to permit relative rotation of two or more wires or hoses. These rotational connectors permit unlimited rotation of the turntable relative to the base. However, such rotational connectors can be expensive, difficult to install, and prone to failure.

The coil management system according to various exemplary embodiments described herein improves on such systems by providing a coiled, flexible assembly. The flexible assembly includes one or more flexible members (e.g., conduits, hoses, wires, cables, etc.) connected to one another and arranged extending parallel to one another. One end of the flexible assembly is fixedly coupled to the chassis, and an opposing second end of the flexible assembly is fixedly coupled to the turntable. The flexible assembly is coiled around a vertical axis into a spiral arrangement and supported on a tray. As the turntable rotates relative to the chassis, the second end of the flexible assembly rotates about the vertical axis. When rotating in a first direction, the coil of the flexible assembly tightens (e.g., the spaces between the windings become smaller). When rotating in a second direction, the coil of the flexible assembly loosens (e.g., the spaces between the windings become tighter). This deformation is applied as a bending of the flexible assembly along the entire length of the coil, minimizing the strain effect of the rotation on the flexible members within the flexible assembly. Accordingly, the coil management system provides a much greater range of rotation (e.g., 360 degrees, 720 degrees, 1080 degrees, etc.) than an arrangement where a hose or cable extends directly between the chassis and the turntable. Due to the use of hoses and cables, the coil management system is more robust and cost-effective than using a rotational connector.

Referring generally to the FIGURES, a lift device includes a control system that is configured to receive a user input and operate the lift device in a manner relative to a surface at which a platform of the lift device is proximate. In this way, instead of commanding direct extension or retraction of a particular member (e.g., a telescoping boom segment), the operator may provide a requested input to move upwards or downwards the surface, left or right on the surface, etc., while maintaining a desired distance from the surface. The lift device may include a controller that receives the user input and obtains feedback from sensors to determine specific controls of one or more controllable components to cause motion of the platform relative to the surface according to the user input.

Referring generally to the FIGURES, a lift device includes a power connector interlock system that is configured to selectively prevent a transfer of electrical energy from an external power source to an internal energy storage system of the lift device during charging operations. The power connector interlock system includes a door that is pivotable between an open position and a closed position. The power connector interlock system further includes a sensor configured to monitor a position of the door and provide a signal indicative of the position of the door. The external power source is configured to selectively prevent the transfer of electrical energy to the internal energy storage system (e.g., halt charging operations) based on the signal indicating that the door is in the open position. The power connector interlock system prevents electrical arcing that occurs in other power connector interlock systems during charging operations.

Referring generally to the FIGURES, a lift device includes a battery having multiple cells positioned within a housing that are configured to receive, store, and discharge electrical energy for one or more electrical loads of the lift device (e.g., an electric motor, an electric linear actuator, lighting devices, controllers, etc.). The battery includes a mechanism that is configured to be manually activated in order to discharge the cells of the battery (e.g., to convert the electrical energy into heat). In some embodiments, when the battery is about to be transported (e.g., due to defects, servicing, or end-of-life conditions), the mechanism can be manually activated in order to ensure that the cells of the battery are completely or substantially depleted of energy before handling and shipping of the battery.

Referring generally to the FIGURES, a rotary sensor mount is shown according to various exemplary embodiments. Some lift devices include a platform with a position controlled by one or more rotatable joints of a lift assembly. The position of the platform is derived from measuring the rotation of the one or more rotatable joints. Some lift devices measure the rotation with protractor angle sensors susceptible to large angle errors based on mounting misalignment between the sensor and the sensed rotating member.

The rotary sensor mount according to various exemplary embodiments described herein improves such systems by providing a mount for a non-contact rotary angle sensor. The mount includes one or more force members (e.g., springs, actuators, etc.) connected to the mount to preload the mount and maintain the axial and radial position of the mount relative to the axis. A first force member parallel to the axis exerts an axial force to engage radial surfaces of the mount with radial surfaces of the rotating member along the rotating axis to maintain the axial position of the mount. A second force member perpendicular to the axis exerts a rotating force on the mount in a first direction, while a braking member (pin, rod, stop, etc.) exerts a counteracting rotating force on the mount to resist the rotating force and maintain the rotational position of the mount. Lateral surfaces of the mount engage with lateral surfaces of the rotating member to keep the sensor concentric with the axis.

As the rotating member rotates, the abutting radial and lateral surfaces of the rotating member rotate relative to the mount. The first force member exerts the axial force to keep the mount in contact with the rotating member. The mount remains substantially fixed relative to the rotating member due to the rotational force from the second force member acting to preload the mount and substantially prevent the mount from rotating with the rotating member due to friction.

In some lift devices the rotatable joints are pin joints with a fork and an eye or bushing rotatable coupled to each other by a pin. Some such lift devices may fix the pin to the eye and measure a rotation of the pin as a proxy for the rotation of the eye, however rotational backlash in the connection between the pin and the eye can interfere with an accurate measurement with precision.

The rotary sensor mount according to various exemplary embodiments described herein improves such systems by providing a tapered cone that threads into a corresponding threaded aperture in the eye and extending into a corresponding tapered countersink in the pin. A bolt passes through the eye, the tapered cone, and the pin to fix the pin to the eye. The inner diameter of the tapered cone is threaded to retain the bolt. The tapered cone prevents relative motion between the eye and the pin.

### Lift Device

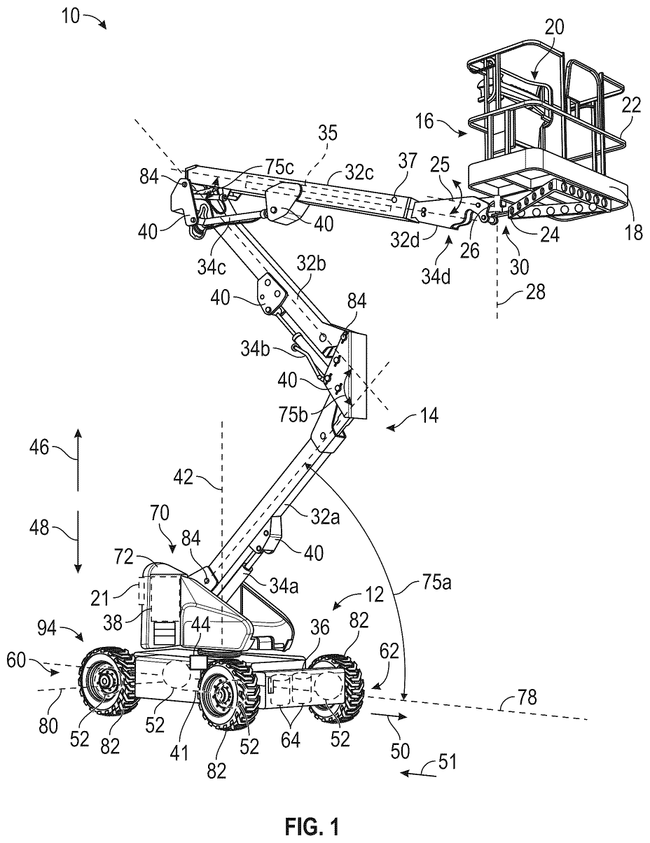

Referring to FIG. 1, a lifting apparatus, lift device, or mobile elevating work platform (MEWP) (e.g., a telehandler, an electric boom lift, a towable boom lift, a lift device, a fully electric boom lift, etc.), shown as lift device 10 includes a base assembly 12 (e.g., a base, a support assembly, a drivable support assembly, a support structure, a chassis, etc.), a platform assembly 16 (e.g., a platform, a terrace, etc.), and a lift assembly 14 (e.g., a boom, a boom lift assembly, a lifting apparatus, an articulated arm, a scissors lift, etc.). The lift device 10 includes a front end (e.g., a forward-facing end, a front portion, a front, etc.), shown as front 62, and a rear end (e.g., a rearward facing end, a back portion, a back, a rear, etc.) shown as rear 60. The lift assembly 14 is configured to elevate the platform assembly 16 in an upward direction 46 (e.g., an upward vertical direction) relative to the base assembly 12. The lift assembly 14 is also configured to translate the platform assembly 16 in a downward direction 48 (e.g., a downward vertical direction). The lift assembly 14 is also configured to translate the platform assembly 16 in either a forward direction 50 (e.g., a forward longitudinal direction) or a rearward direction 51 (e.g., a rearward longitudinal direction). The lift assembly 14 generally facilitates performing a lifting function to raise and lower the platform assembly 16, as well as movement of the platform assembly 16 in various directions.

The base assembly 12 defines a longitudinal axis 78 and a lateral axis 80. The longitudinal axis 78 defines the forward direction 50 of lift device 10 and the rearward direction 51. The lift device 10 is configured to translate in the forward direction 50 and to translate backwards in the rearward direction 51. The base assembly 12 includes one or more wheels, tires, wheel assemblies, tractive elements, rotary elements, treads, etc., shown as tractive elements 82. The tractive elements 82 are configured to rotate to drive (e.g., propel, translate, steer, move, etc.) the lift device 10. The tractive elements 82 can each include an electric motor 52 (e.g., electric wheel motors) configured to drive the tractive elements 82 (e.g., to rotate tractive elements 82 to facilitate motion of the lift device 10). In other embodiments, the tractive elements 82 are configured to receive power (e.g., rotational mechanical energy) from electric motors 52 or through a drive train (e.g., a combination of any number and configuration of a shaft, an axle, a gear reduction, a gear train, a transmission, etc.). In some embodiments, one or more tractive elements 82 are driven by a prime mover 41 (e.g., electric motor, internal combustion engine, etc.) through a transmission. In some embodiments, a hydraulic system (e.g., one or more pumps, hydraulic motors, conduits, valves, etc.) transfers power (e.g., mechanical energy) from one or more electric motors 52 and/or the prime mover 41 to the tractive elements 82. The tractive elements 82 and electric motors 52 (or prime mover 41) can facilitate a driving and/or steering function of the lift device 10. In some embodiments, the electric motors 52 are optional, and the tractive elements 82 are powered or driven by an internal combustion engine.

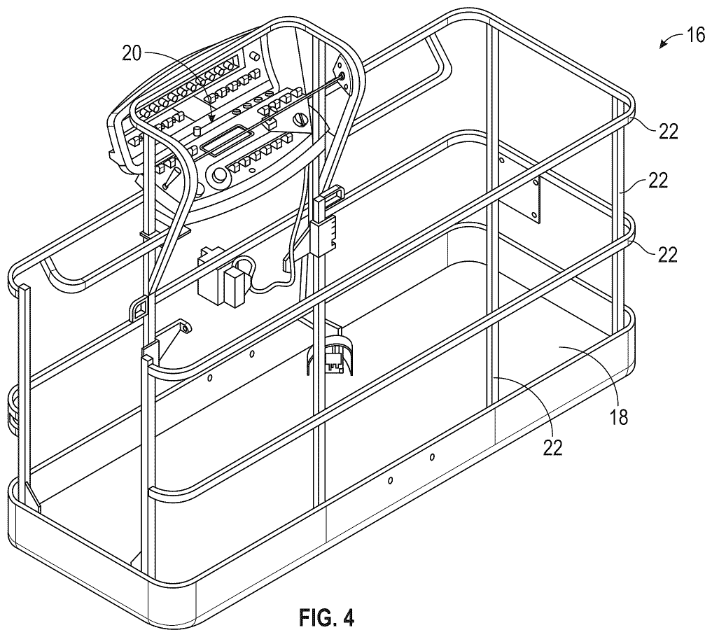

With additional reference to FIG. 4, the platform assembly 16 is shown in further detail. The platform assembly 16 is configured to provide a work area for an operator of the lift device 10 to stand/rest upon. The platform assembly 16 can be pivotally coupled to an upper end of the lift assembly 14. The lift device 10 is configured to facilitate the operator accessing various elevated areas (e.g., lights, platforms, the sides of buildings, building scaffolding, trees, power lines, etc.). The lift device 10 may use various electrically-powered motors and electrically-powered linear actuators or hydraulic cylinders to facilitate elevation and/or horizontal movement (e.g., lateral movement, longitudinal movement) of the platform assembly 16 (e.g., relative to the base assembly 12, or to a ground surface that the base assembly 12 rests upon). In some embodiments, the lift device 10 uses internal combustion engines, hydraulics, a hydraulic system, pneumatic cylinders, etc.

The platform assembly 16 includes a base member, a base portion, a platform, a standing surface, a shelf, a work platform, a floor, a deck, etc., shown as a deck 18. The deck 18 provides a space (e.g., a floor surface) for a worker to stand upon as the platform assembly 16 is raised and lowered.

The platform assembly 16 includes a railing assembly including various members, beams, bars, guard rails, rails, railings, etc., shown as rails 22. The rails 22 extend along substantially an entire perimeter of the deck 18. The rails 22 provide one or more members for the operator of the lift device 10 to grasp while using the lift device 10 (e.g., to grasp while operating the lift device 10 to elevate the platform assembly 16). The rails 22 can include members that are substantially horizontal to the deck 18. The rails 22 can also include vertical structural members that couple with the substantially horizontal members. The vertical structural members can extend upwards from the deck 18.

The platform assembly 16 can include a human machine interface (HMI) (e.g., a user interface, an operator interface, etc.), shown as the user interface 20. The user interface 20 is configured to receive user inputs from the operator at or upon the platform assembly 16 to facilitate operation of the lift device 10. The user interface 20 can include any number of buttons, levers, switches, keys, etc., or any other user input device configured to receive a user input to operate the lift device 10. The user interface 20 may also provide information to the user (e.g., through one or more displays, lights, speakers, haptic feedback devices, etc.). The user interface 20 can be supported by one or more of the rails 22.

Referring to FIG. 1, the platform assembly 16 includes a frame 24 (e.g., structural members, support beams, a body, a structure, etc.) that extends at least partially below the deck 18. The frame 24 can be integrally formed with the deck 18. The frame 24 is configured to provide structural support for the deck 18 of the platform assembly 16. The frame 24 can include any number of structural members (e.g., beams, bars, I-beams, etc.) to support the deck 18. The frame 24 couples the platform assembly 16 with the lift assembly 14. The frame 24 may be rotatably or pivotally coupled with the lift assembly 14 to facilitate rotation of the platform assembly 16 about an axis 28 (e.g., a vertical axis). The frame 24 can also rotatably/pivotally couple with the lift assembly 14 such that the frame 24 and the platform assembly 16 can pivot about an axis 25 (e.g., a horizontal axis).

The lift assembly 14 includes one or more beams, articulated arms, bars, booms, arms, support members, boom sections, cantilever beams, etc., shown as lift arms 32a, 32b, and 32c. The lift arms are hingedly or rotatably coupled with each other at their ends. The lift arms can be hingedly or rotatably coupled to facilitate articulation of the lift assembly 14 and raising/lowering and/or horizontal movement of the platform assembly 16. The lift device 10 includes a lower lift arm 32a, a central or medial lift arm 32b, and an upper lift arm 32c. The lower lift arm 32a is configured to hingedly or rotatably couple at one end with the base assembly 12 to facilitate lifting (e.g., elevation) of the platform assembly 16. The lower lift arm 32a is configured to hingedly or rotatably couple at an opposite end with the medial lift arm 32b. Likewise, the medial lift arm 32b is configured to hingedly or rotatably couple with the upper lift arm 32c. The upper lift arm 32c can be configured to hingedly interface/couple and/or telescope with an intermediate lift arm 32d. The upper lift arm 32c can be referred to as “the jib” of the lift device 10. The intermediate lift arm 32d may extend into an inner volume of the upper lift arm 32c and extend and/or retract. The lower lift arm 32a and the medial lift arm 32b may be referred to as “the boom” of the overall lift device 10 assembly. The intermediate lift arm 32d can be configured to couple (e.g., rotatably, hingedly, etc.), with the platform assembly 16 to facilitate levelling of the platform assembly 16.

The lift arms 32 are driven to hinge or rotate relative to each other by actuators 34a, 34b, 34c, and 34d (e.g., electric linear actuators, linear electric arm actuators, hydraulic cylinders, etc.). The actuators 34a, 34b, 34c, and 34d can be mounted between adjacent lift arms to drive adjacent lift arms to hinge or pivot (e.g., rotate some angular amount) relative to each other about pivot points 84. The actuators 34a, 34b, 34c, and 34d can be mounted between adjacent lift arms using any of a foot bracket, a flange bracket, a clevis bracket, a trunnion bracket, etc. The actuators 34a, 34b, 34c, and 34d may be configured to extend or retract (e.g., increase in overall length, or decrease in overall length) to facilitate pivoting adjacent lift arms to pivot/hinge relative to each other, thereby articulating the lift arms and raising or lowering the platform assembly 16.

The actuators 34a, 34b, 34c, and 34d can be configured to extend (e.g., increase in length) to increase a value of an angle formed between adjacent lift arms 32. The angle can be defined between centerlines of adjacent lift arms 32 (e.g., centerlines that extend substantially through a center of the lift arms 32). For example, the actuator 34a is configured to extend/retract to increase/decrease the angle 75a defined between a centerline of the lower lift arm 32a and the longitudinal axis 78 (angle 75a can also be defined between the centerline of the lower lift arm 32a and a plane defined by the longitudinal axis 78 and lateral axis 80) and facilitate lifting of the platform assembly 16 (e.g., moving the platform assembly 16 at least partially along the upward direction 46). Likewise, the actuator 34b can be configured to retract to decrease the angle 75a to facilitate lowering of the platform assembly 16 (e.g., moving the platform assembly 16 at least partially along the downward direction 48). Similarly, the actuator 34b is configured to extend to increase the angle 75b defined between centerlines of the lower lift arm 32a and the medial lift arm 32b and facilitate elevating of the platform assembly 16. Similarly, the actuator 34b is configured to retract to decrease the angle 75b to facilitate lowering of the platform assembly 16. The electric actuator 34c is similarly configured to extend/retract to increase/decrease the angle 75c, respectively, to raise/lower the platform assembly 16. The actuators 34 may be hydraulic actuators, electric actuators, pneumatic actuators, etc.

The actuators 34a, 34b, 34c, and 34d can be mounted (e.g., rotatably coupled, pivotally coupled, etc.) to adjacent lift arms at mounts 40 (e.g., mounting members, mounting portions, attachment members, attachment portions, etc.). The mounts 40 can be positioned at any position along a length of each lift arm. For example, the mounts 40 can be positioned at a midpoint of each lift arm, and a lower end of each lift arm.

The intermediate lift arm 32d and the frame 24 are configured to pivotally interface/couple at a platform rotator 30 (e.g., a rotary actuator, a rotational electric actuator, a gear box, etc.). The platform rotator 30 facilitates rotation of the platform assembly 16 about the axis 28 relative to the intermediate lift arm 32d. In some embodiments, the platform rotator 30 is positioned between the frame 24 and the upper lift arm 32c and facilitates pivoting of the platform assembly 16 relative to the upper lift arm 32c. The axis 28 extends through a central pivot point of the platform rotator 30. The intermediate lift arm 32d can also be configured to articulate or bend such that a distal portion of the intermediate lift arm 32d pivots/rotates about the axis 25. The intermediate lift arm 32d can be driven to rotate/pivot about axis 25 by extension and retraction of the actuator 34d.

The intermediate lift arm 32d is also configured to extend/retract (e.g., telescope) along the upper lift arm 32c. In some embodiments, the lift assembly 14 includes a linear actuator (e.g., a hydraulic cylinder, an electric linear actuator, etc.), shown as extension actuator 35, that controls extension and retraction of the intermediate lift arm 32d relative to the upper lift arm 32c. In other embodiments, one more of the other arms of the lift assembly 14 include multiple telescoping sections that are configured to extend/retract relative to one another.

The platform assembly 16 is configured to be driven to pivot about the axis 28 (e.g., rotate about axis 28 in either a clockwise or a counter-clockwise direction) by an electric or hydraulic motor 26 (e.g., a rotary electric actuator, a stepper motor, a platform rotator, a platform electric motor, an electric platform rotator motor, etc.). The motor 26 (e.g., the pivot motor 26) can be configured to drive the frame 24 to pivot about the axis 28 relative to the upper lift arm 32c (or relative to the intermediate lift arm 32d). The motor 26 can be configured to drive a gear train to pivot the platform assembly 16 about the axis 28.

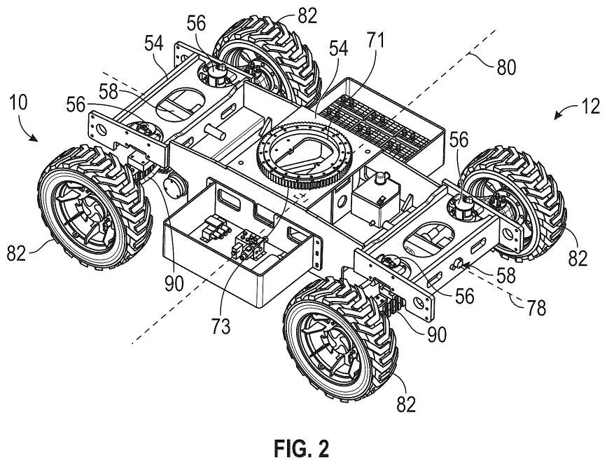

Referring to FIGS. 1 and 2, the lift assembly 14 is configured to pivotally or rotatably couple with the base assembly 12. The base assembly 12 includes a rotatable base member, a rotatable platform member, a fully electric turntable, etc., shown as a turntable 70. The lift assembly 14 is configured to rotatably/pivotally couple with the base assembly 12. The turntable 70 is rotatably coupled with a base, frame, structural support member, carriage, etc., of base assembly 12, shown as base 36. The turntable 70 is configured to rotate or pivot relative to the base 36. The turntable 70 can pivot/rotate about the central axis 42 relative to base 36, about a slew bearing 71 (e.g., the slew bearing 71 pivotally couples the turntable 70 to the base 36). The turntable 70 facilitates accessing various elevated and angularly offset locations at the platform assembly 16. The turntable 70 is configured to be driven to rotate or pivot relative to base 36 and about the slew bearing 71 by an electric motor, an electric turntable motor, an electric rotary actuator, a hydraulic motor, etc., shown as the turntable motor 44. The turntable motor 44 can be configured to drive a geared outer surface 73 of the slew bearing 71 that is rotatably coupled to the base 36 about the slew bearing 71 to rotate the turntable 70 relative to the base 36. The lower lift arm 32a is pivotally coupled with the turntable 70 (or with a turntable member 72 of the turntable 70) such that the lift assembly 14 and the platform assembly 16 rotate as the turntable 70 rotates about the central axis 42. In some embodiments, the turntable 70 is configured to rotate a complete 360 degrees about the central axis 42 relative to the base 36. In other embodiments, the turntable 70 is configured to rotate an angular amount less than 360 degrees about the central axis 42 relative to the base 36 (e.g., 270 degrees, 120 degrees, etc.).

The base assembly 12 includes one or more energy storage devices or power sources (e.g., capacitors, batteries, Lithium-Ion batteries, Nickel Cadmium batteries, fuel tanks, etc.), shown as batteries 64 (e.g. battery packs). The batteries 64 are configured to store energy in a form (e.g., in the form of chemical energy) that can be converted into electrical energy for the various electric motors and actuators of the lift device 10. The batteries 64 can be stored within the base 36. The lift device 10 includes a controller 38 that is configured to operate any of the motors, actuators, etc., of the lift device 10. The controller 38 can be configured to receive sensory input information from various sensors of the lift device 10, user inputs from the user interface 20 (or any other user input device such as a key-start or a push-button start), etc. The controller 38 can be configured to generate control signals for the various motors, actuators, etc., of the lift device 10 to operate any of the motors, actuators, electrically powered movers, etc., of the lift device 10. The batteries 64 are configured to power any of the motors, sensors, actuators, electric linear actuators, electrical devices, electrical movers, stepper motors, etc., of the lift device 10. The base assembly 12 can include a power circuit including any necessary transformers, resistors, transistors, thermistors, capacitors, etc., to provide appropriate power (e.g., electrical energy with appropriate current and/or appropriate voltage) to any of the motors, electric actuators, sensors, electrical devices, etc., of the lift device 10.

The batteries 64 are configured to deliver power to the motors 52 to drive the tractive elements 82. A rear set of tractive elements 82 can be configured to pivot to steer the lift device 10. In other embodiments, a front set of tractive elements 82 are configured to pivot to steer the lift device 10. In still other embodiments, both the front and the rear set of tractive elements 82 are configured to pivot (e.g., independently) to steer the lift device 10. In some examples, the base assembly 12 includes a steering system 150. The steering system 150 is configured to drive tractive elements 82 to pivot for a turn of the lift device 10. The steering system 150 can be configured to pivot the tractive elements 82 in pairs (e.g., to pivot a front pair of tractive elements 82), or can be configured to pivot tractive elements 82 independently (e.g., four-wheel steering for tight-turns).

It should be understood that while the lift device 10 as described herein is described with reference to batteries, electric motors, etc., the lift device 10 can be powered (e.g., for transportation and/or lifting the platform assembly 16) using one or more internal combustion engines, electric motors or actuators, hydraulic motors or actuators, pneumatic actuators, or any combination thereof.

In some embodiments, the base assembly 12 also includes a user interface 21 (e.g., a HMI, a user interface, a user input device, a display screen, etc.). In some embodiments, the user interface 21 is coupled to the base 36. In other embodiments, the user interface 21 is positioned on the turntable 70. The user interface 21 can be positioned on any side or surface of the base assembly 12 (e.g., on the front 62 of the base 36, on the rear 60 of the base 36, etc.).

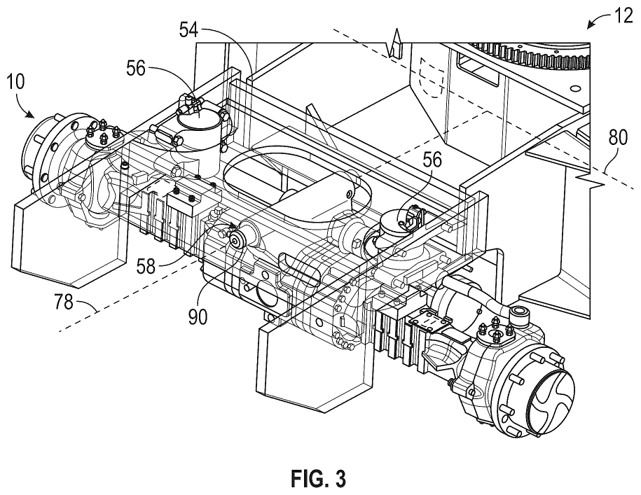

Referring now to FIGS. 2 and 3, the base assembly 12 includes a longitudinally extending frame member 54 (e.g., a rigid member, a structural support member, an axle, a base, a frame, a carriage, a chassis, etc.). The longitudinally extending frame member 54 provides structural support for the turntable 70 as well as the tractive elements 82. The longitudinally extending frame member 54 is pivotally coupled with lateral frame members 110 (e.g., axles, frame members, beams, bars, etc.) at opposite longitudinal ends of the longitudinally extending frame member 54. For example, the lateral frame members 110 may be pivotally coupled with the longitudinally extending frame member 54 at a front end and a rear end of the longitudinally extending frame member 54. The lateral frame members 110 can each be configured to pivot about a pivot joint 58 (e.g., about a longitudinal axis). The pivot joint 58 can include a pin and a receiving portion (e.g., a bore, an aperture, etc.). The pin of the pivot joint 58 is coupled to one of the lateral frame members 110 (e.g., a front lateral frame member 110 or a rear lateral frame member 110) or the longitudinally extending frame member 54 and the receiving portion is coupled to the other of the longitudinally extending frame member 54 and the lateral frame member 110. For example, the pin may be coupled with longitudinally extending frame member 54 and the receiving portion can be coupled with one of the lateral frame members 110 (e.g., integrally formed with the front lateral frame member 110).

In some embodiments, the longitudinally extending frame member 54 and the lateral frame members 110 are integrally formed or coupled (e.g., fastened, welded, riveted, etc.) to define the base 36. In still other embodiments, the base 36 is integrally formed with the longitudinally extending frame member 54 and/or the lateral frame members 110. In still other embodiments, the base 36 is coupled with the longitudinally extending frame member 54 and/or the lateral frame members 110.

The base assembly 12 includes one or more axle actuators 56 (e.g., electric linear actuators, electric axle actuators, electric levelling actuators, hydraulic cylinders, etc.). The axle actuators 56 can be linear actuators configured to receive power from the batteries 64, for example. The axle actuators 56 can be configured to extend or retract to contact a top surface of a corresponding one of the lateral frame members 110. When the axle actuators 56 extend, an end of a rod of the levelling actuators can contact the surface of lateral frame member 110 and prevent relative rotation between lateral frame member 110 and longitudinally extending frame member 54. In this way, the relative rotation/pivoting between the lateral frame member 110 and the longitudinally extending frame member 54 can be locked (e.g., to prevent rolling of the longitudinally extending frame member 54 relative to the lateral frame members 110 during operation of the lift assembly 14). The axle actuators 56 can receive power from the batteries 64, which can allow the axle actuators 56 to extend or retract. The axle actuators 56 receive control signals from controller 38.

### Boom Length Sensing System

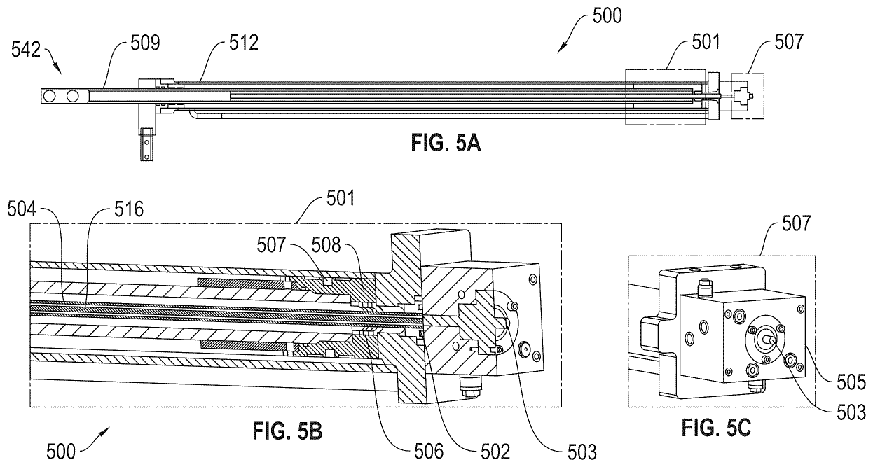

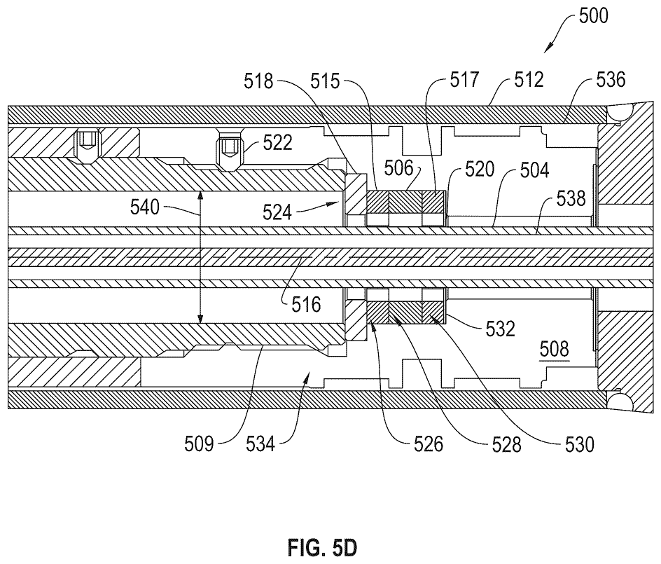

Referring to FIGS. 5A-19, the lift device 10 of FIG. 1 may comprise a position sensor (e.g., position sensor 37 of FIG. 1) disposed on or within the upper lift arm 32c and/or the intermediate lift arm 32d of FIG. 1 to determine the position of the intermediate lift arm 32d with relation to upper lift arm 32c.

Turning to FIG. 5A, a hydraulic assembly 500 is shown. The hydraulic assembly 500 may comprise a piston rod 509 and a cylinder 512, fluidly coupled to one another. Specifically, the piston rod 509 may be received within the cylinder 512. The piston rod 509 may include a seal 507 to separate a first portion of the cylinder 512 from a second portion of the cylinder 512, such that the two portions (e.g., the two inner volumes) are separated by the seal 507 as the piston rod 509 moves. Accordingly, the piston rod 509 may be extended from the cylinder 512 or retracted into the cylinder 512 by adding pressurized fluid (e.g., hydraulic oil) to one of the two inner volumes. The piston rod 509 is positioned within the cylinder 512, and the seal 507 creates a fluid-tight seal with an inner surface of the cylinder 512. The piston rod 509 may also be fixedly coupled to a piston rod 509, the piston rod 509 being coupled to a member of the lift assembly 14 of FIG. 1. In some embodiments, the piston rod 509 is coupled to the upper lift arm 32c and the cylinder 512 is coupled to the intermediate lift arm 32d. In this embodiment, as the piston and cylinder translate into an extended position by hydraulically pressurizing the second portion of the cylinder, the intermediate lift arm 32d moves into an extended position. In some embodiments, the piston rod 509 is coupled to the intermediate lift arm 32d and the cylinder is coupled to the upper lift arm 32c of FIG. 1. In substantially the same manner, the upper lift arm 32c and the intermediate lift arm 32d are adjusted into the extended position as the cylinder 512 and piston rod 509 extend.

The hydraulic assembly 500 may also comprise a position sensor 502. The position sensor 502 may be coupled to a second end of the cylinder 512. FIG. 5C illustrates the position sensor 502. As shown in FIG. 5B, the position sensor 502 may include a sensor element 516 inside a pressure tube 504 (the sensor element 516 being either flexible or rigid), a magnet 506, and a sensing unit 501 or sensor. The sensing unit 501 may be a Hall effect sensor or magnetorestrictive position sensor.

The magnetorestrictive position sensor is a type of sensor used to measure the position, displacement, or level of an object, such as the position of the piston rod 509 in the cylinder 512. The sensing unit 501 utilizes the principle of magnetostriction, which is the property of certain materials to change their shape or dimensions when subjected to a magnetic field. In some embodiments, the position sensor may include an induction pickup coil (e.g., a coil of conductive wire) that senses torsional strain pulses on the sensor element 516).

In a magnetorestrictive position sensor, a sensing element or waveguide (e.g., sensor element 516 inside the pressure tube 504) made of a magnetorestrictive material, such as Terfenol-D, Metglas 2605SC, cobalt ferrite, nickel, or Galfenol, is used. The sensing element may be a thin metal wire or rod (e.g., sensor element 516 inside the pressure tube 504) that is placed in close proximity to a permanent magnet (e.g., magnet 506).

When an electrical current pulse is passed through the sensor element 516 inside the pressure tube 504, it generates a magnetic field that interacts with the permanent magnet 506. This interaction causes the magnetorestrictive material (e.g., the sensor element 516 inside the pressure tube 504) to experience a strain, resulting in a mechanical wave or “strain wave” propagating along the sensor element 516 inside the pressure tube 504.

To determine the position of the piston rod 509 in the cylinder 512 (and by association, the position of the intermediate lift arm 32d in relation to the upper lift arm 32c), a pickup or transducer is placed along the waveguide to detect the strain wave. The transducer converts the mechanical strain into an electrical signal, which is then processed to determine the precise position of the object being measured.

In some embodiments, the position sensor 502 is a Hall effect sensor. The Hall effect sensor may function in the following manner to determine the position of the piston rod 509 in relation to the cylinder 512. The Hall effect sensor may comprise a thin strip or plate of semiconductor material (e.g., sensor element 516 inside the pressure tube 504) with current flowing through it. When a magnetic field is applied perpendicular to the direction of the current, the Lorentz force acts on the charge carriers (electrons or holes) within the material. The Lorentz force causes the charge carriers to be deflected towards one side of the semiconductor material, resulting in an accumulation of charge carriers on one edge and a depletion of charge carriers on the opposite edge. This creates a voltage difference, known as the Hall voltage, across the material. The Hall voltage may be measured using the position sensor's 502 built-in electrodes or contacts placed along the edges of the semiconductor strip. These electrodes pick up the voltage difference created by the Hall effect. The Hall voltage is proportional to the strength of the magnetic field and can be positive or negative depending on the polarity of the magnetic field and the type of charge carriers (electrons or holes) in the material. The output signal from the Hall effect sensor can be analog (continuous voltage) or digital (on/off signal) depending on the sensor's design and application. By measuring the Hall voltage, the Hall effect sensor can determine the presence, strength, and polarity of the magnetic field. It can detect magnetic fields from permanent magnets (e.g., magnet 506), electromagnets, or magnetic field changes induced by moving objects.

In embodiments with the sensor element 516 inside the pressure tube 504 being flexible, serviceability is increased, and the sensor element 516 inside the pressure tube 504 may be extracted from the cylinder 512 without contaminating the system by unscrewing the lid 503 from the sensing unit 501.

In operation of the lift device 10 of FIG. 1, upon the control system receiving a command to extend the intermediate lift arm 32d, the hydraulic assembly 500 pressurizes one of the two chambers of the cylinder 512 created by the piston rod 509 to apply a force upon a piston head 508 of the piston rod 509. This pressure causes the piston rod 509 to move and, by extension, the piston rod 509 to extend from the cylinder 512. As the piston head 508 moves along the cylinder 512, the magnet 506 moves along the sensor element 516 inside the pressure tube 504, which remains stationary during the movement of the piston rod 509. The pressure tube 504 extends through the piston head 508 through a sealed channel which prevents the pressurized fluid from exchanging between the two chambers of the cylinder 512. As the magnet 506 moves along the sensor element 516, the position sensor 502 determines the position of the piston head 508 within the cylinder. This position may be mapped to a position of the intermediate lift arm more generally, and that position may be transmitted to a display of the lift device. By placing the sensor element 516 inside the cylinder, it improves the reliability of the measuring system because it is protected from external damage. A valve block 505 may be used to selectively port pressurized hydraulic fluid to separate chambers within the cylinder 512. The valve block 505 may include a lid 503 that may be used to access the sensor element 516 and remove the sensor element 516 for service and/or replacement. In some embodiments, the hydraulic assembly 500 may include multiple sensor element 516 and/or magnet 506.

Turning now to FIG. 5D, an alternative and/or additional embodiment of the hydraulic assembly 500 is shown. The hydraulic assembly 500 of FIG. 5D may be substantially similar to the hydraulic assembly 500 of FIG. 5A, except as otherwise specified herein. The hydraulic assembly 500 may include a cylinder 512 and a piston rod 509. The cylinder 512 may have an internal cavity formed by an internal surface 536 of the cylinder 512 and may be any suitable shape, such as cylindrical or other prismatic shape. The piston rod 509 may be positioned in part within the cavity of the cylinder 512 and be configured to extend and/or retract within the cavity due to hydraulic pressure differentials between separate internal sections of the hydraulic assembly 500, as separated by the piston head 508. The piston head 508 is coupled to the piston rod 509 at a proximal end 534 of the piston rod 509. In some embodiments, the piston head 508 may be coupled to the piston rod 509 at one or more locations along the piston rod 509 not at the proximal end 534. In an exemplary embodiment, the piston head 508 is coupled to the piston rod 509 by a set screw 522. In other embodiments, the piston head 508 is coupled to the piston rod 509 by threaded connection (e.g., the piston head 508 is threaded onto the piston rod 509 at torque to prevent loosening of the piston head 508 from the piston rod 509). While the set screw 522 is shown in FIG. 5D, it is understood that any manner of connection between the piston head 508 and piston rod 509 may be utilized, such as threaded fastener connection, adhesive, and/or weld. Indeed, the piston head 508 and the piston rod 509 may be a unitary part in some implementations.

The hydraulic assembly 500 may additionally or alternatively include a pressure tube 504 with an interior cavity defined by an interior surface 538. The interior surface 538 may extend some or all of the length of the pressure tube 504 along a longitudinal axis of the pressure tube 504. Within the pressure tube 504 is housed a sensor element 516. The sensor element 516 may be a part of a magnetorestrictive sensor element that responds to magnetic fields (such as produced by the magnet 506) in the form of a mechanical strain pulse. For example, the sensor element 516 may be a flexible magnetorestrictive position sensor or a rigid magnetorestrictive position sensor. A position sensor 502 (as shown in FIG. 5B) may receive an indication of the mechanical strain pulse in the form of electrical signals. The received electrical signals may be filtered or otherwise corrected/adjusted to assign a value to the received signal. The signal may then be transmitted to a processor to determine a position of the magnet 506 (and by association, the piston rod 509) in relation to the sensor element 516.

To simplify assembly and production of the hydraulic assembly 500, the magnet 506 may be positioned between the piston rod 509 and the piston head 508. The magnet 506 may be located between magnet spacer 515, 517. A first face of the magnet spacer 515 may be proximally positioned at surface 526 to a retention plate 518 which has an outer diameter greater than an internal diameter 540 of the piston rod 509 so that the retention plate 518 may be positionally coupled to the piston rod 509 at a proximal face 524 of the 509. While the proximal face 524 is shown as the extreme position of the piston rod 509 at the proximal end 534, it should be understood that the proximal face 524 may be at any location on the piston rod 509. For example, the piston rod 509 may have a secondary internal surface with a diameter greater than the internal diameter 540. The retention plate 518 may be located within the secondary internal surface and the proximal face 524 may be a shoulder surface.

A second face of the one or more magnet spacer 515 may be positioned proximally to a first magnet face of the magnet 506 at the interface 528. A second magnet face of the magnet 506 may be positioned proximally to a third spacer face of the sensor element 516 at the interface 530. A fourth spacer face of the sensor element 516 may be positioned proximally to a washer face of a wave washer 520 (e.g., a compressible element or compressible spacer) or, alternatively, an internal face 532 of the piston head 508. While a wave washer is shown and described, it is understood additional or alternative components may be used such as a crush washer, foam, UHMW, or other crushable material.

In some embodiments, the magnet 506 is a hollow cylinder (e.g., an annular element) that is radially disposed about the pressure tube 504. Because the pressure tube 504 surrounds the sensor element 516 in some embodiments, the magnet 506 may also be radially disposed about the sensor element 516. However, in some embodiments, the magnet 506 may not be radially disposed about the sensor element 516. In such embodiments, the magnet 506 may be positioned proximate (but not necessarily in contact with) the sensor element 516 such that a magnetic field of the magnet 506 may induce a strain pulse through the sensor element 516.

The hydraulic assembly 500 may be used in, for example, a boom assembly that is used for extending and retracting a work platform, such as shown in the lift device 10 of FIG. 1. The boom assembly may include a base member and an extension member, each coupled to either the cylinder 512 or the piston rod 509. In at least one embodiment, the base member is coupled to the cylinder 512 and the extension member is coupled to a distal end (e.g., a distal end 542 as shown in FIG. 5A) of the piston rod 509 such that the extension member extends from within the base member when the piston rod 509 extends from within the cylinder 512. The distal end of the piston rod 509 may include one or more apertures through which the extension member may be rotatably coupled to the piston rod 509. In some embodiments, the base member is the upper lift arm 32c of FIG. 1 and the extension member is the intermediate lift arm 32d of FIG. 1. In some embodiments, the lift device (e.g., lift device 10 of FIG. 1) may include one or more hydraulic assembly 500 of FIG. 5 that are used to extend and/or retract one or more extension members from one or more base members.

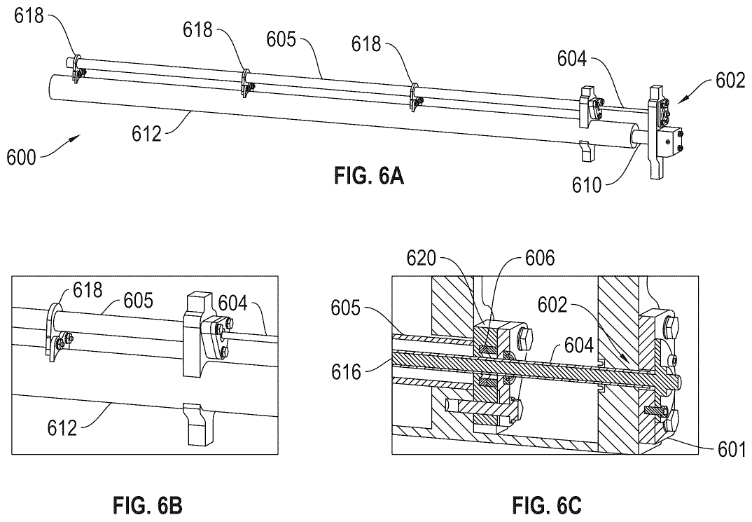

Turning now to FIGS. 6A-6C, various views of an exemplary position sensor 37 of FIG. 1 is shown. In the embodiment illustrated in FIGS. 6A-6C, a position sensor 602 is shown exterior to a hydraulic extender 600. The hydraulic extender 600 may comprise a cylinder 612 and a piston 610. The position sensor 602 may be any number of position sensors, including a magnetorestrictive position sensor or a Hall effect sensor. In an exemplary embodiment, the position sensor 602 is a magnetorestrictive position sensor. The position sensor 602 may include an inner tube 604, a sensing element 616, a sensing unit 601, a magnet 606, and an outer tube 605. In one embodiment (as shown in FIGS. 6A-6C), the outer tube 605 is removeably or fixedly coupled to the cylinder 612 by brackets 618. The sensing unit 601 may be removeably or fixedly coupled to the piston 610. The inner tube 604 is removeably or fixedly coupled to the sensing unit 601 such that as the piston 610 moves within the cylinder 612, the sensing unit 601 and the inner tube 604 move in a corresponding manner. Additionally, in some embodiments, the sensing element 616 is disposed within the inner tube 604 and is removeably coupled to the sensing unit 601 and moves accordingly. The magnet is housed in a magnet housing 620, which may be removeably or fixedly coupled to the cylinder 612. Thus, as the piston 610 moves within the cylinder 612, the sensing element 616 moves in relation to the magnet 606 and sends a signal to the sensing unit 601. This signal may be amplified, filtered, and used to determine a precise position of the piston 610 (and by extension, the intermediate lift arm 32d).

By placing the position sensor external to the cylinder, serviceability is increased. Additional advantages of the exterior placement of the position sensor include allowing alternate cylinder orientation (e.g., rod porting), allowing smaller cylinder sizing, and allowing the use of the position sensor in boom extension systems not using hydraulic cylinders.

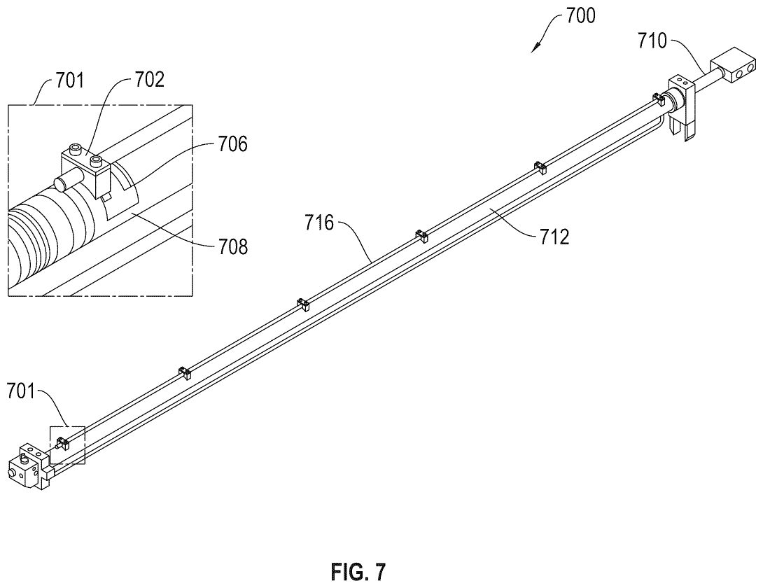

Turning now to FIG. 7, a hydraulic extender 700 is shown with a position sensor externally mounted to the cylinder 712. Unlike FIG. 6A, a magnet 706 is mounted internally in the cylinder 712 in FIG. 7. For example, the magnet 706 may be mounted onto the piston head 708. Alternatively, the magnet 706 may be mounted on a piston rod of the piston 710. Thus, as the piston head 708 (or piston rod) moves within the cylinder 712, the magnet 706 also moves. As the magnet 706 moves with the piston head 708, it moves in relation to the sensing element 716 which is statically coupled to the cylinder 712. The electromagnetic interaction between the sensing element 702 and the magnet 706 is measured by the sensing element 702. The control system of the lift device 10 may have a mapping software to map signals received from the sensing element 702 to a physical position of the piston 710. As with FIG. 5A, the cylinder 712 may be coupled to either the upper lift arm 32c or intermediate lift arm 32d of FIG. 1. The piston 710 may be coupled to the arm that the cylinder 712 is not coupled to. In this way, as the intermediate lift arm 32d extends and retracts with relation to the upper lift arm 32c, the magnet 706 moves in relation to the sensing element 716. A detailed view of section 701 illustrates the interior of the cylinder 712 with a magnet 706 positioned proximate the sensing element 716,

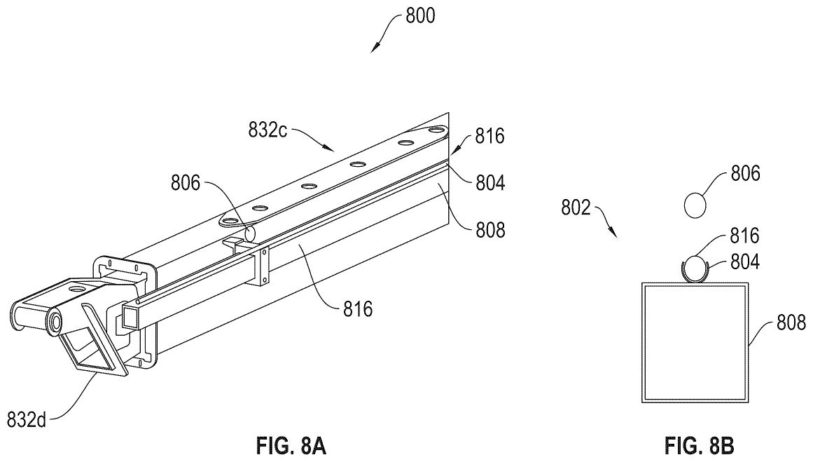

Turning now to FIGS. 8A-8B, a hydraulic extender 800 is shown with an externally mounted position sensor 802. The position sensor 802 may comprise a pushtube extrusion member 808. In some embodiments, this pushtube extrusion member 808 may be used to route hose and cables for the lift device 10 of FIG. 1. On an outer surface of the pushtube extrusion member 808 may be affixed a channel 804 to house the sensing element 816. In some embodiments, the channel 804 is fully enclosed around the sensing element 816. The channel 804 may be welded to the pushtube extrusion member 808 or otherwise affixed thereto (e.g., fastened, welded, riveted, etc.). In some embodiments, the pushtube extrusion member 808 is in unity with the channel 804 (e.g., part of the extrusion).

The pushtube extrusion member 808 is affixed (removeably or fixedly) to an outer surface of the upper lift arm 832c of the lift device 10 of FIG. 1. In an exemplary embodiment, the outer surface is on a lateral side of the upper lift arm 832c (as shown in FIG. 8A). In other embodiments, however, the pushtube extrusion member 808 may be affixed on a top, exterior surface of the upper lift arm 832c or a bottom surface of the upper lift arm 832c.

The sensing element 816 is housed within the channel 804, according to an exemplary embodiment. A magnet 806 is mounted (removeably or fixedly) to the extending intermediate lift arm 832d. Because the intermediate lift arm 832d moves in relation to the upper lift arm 832c, according to an embodiment, the magnet 806 moves in relation to the sensing element that is coupled to the static upper lift arm 832c. This allows a sensing unit (e.g., sensing unit 501 of FIG. 5) to determine a position of the intermediate lift arm 832d as it moves in and out of the upper lift arm 832c.

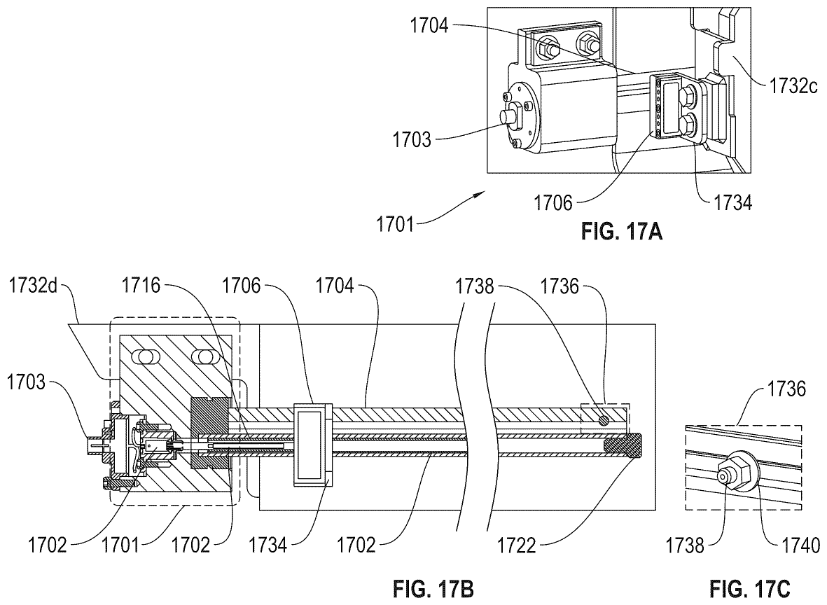

Turning briefly now to FIGS. 17A-17B, a sensing unit 1701 mounted to an exterior of a boom assembly of a lift vehicle is illustrated, according to an embodiment. In some embodiments, the implementation of the sensing unit 1701 of FIGS. 17A-17B may be substantially similar to that of FIGS. 8A-8B. In at least one embodiment, the sensing unit 1701 is mounted onto an arm 1732d of the boom assembly of the vehicle. In some embodiments, the arm 1732d may be substantially similar to one or more of the lower lift arm 32a, 32b, and/or 32c. The sensing unit 1701 may include a position sensor 1702, a lid 1703, a pressure tube 1704, a magnet 1706, and/or a sensing element 1716. The magnet 1706 may be mounted to a boom arm 1732c by mounting plate 1734, such that as the boom arm 1732c moves in relation to arm 1732d (whether the boom arm 1732c is moved or the arm 1732d is moved), the magnet 1706 moves (affixed to the boom arm 1732c) relative to the position sensor 1702 (affixed to the arm 1732d).

The pressure tube 1704 may be a custom extrusion tube, such as a custom aluminum extrusion tube. However, it is understood that the pressure tube 1704 may be any suitable material (e.g., steel, aluminum, magnesium, plastic, glass), shape (e.g., annular, circular, rectangular, prismatic, etc.), and/or orientation, such that the sensing element 1716 may be positioned therein. The pressure tube 1704 is coupled to the arm 1732d. In some embodiments, the pressure tube 1704 is coupled to the arm 1732d by a pressed-in insert 1738 extending from a side surface of the arm 1732d. The pressed-in insert 1738 may be spot welded, threaded, manufactured, adhered, etc. to the arm 1732d such that the pressure tube 1704 may coupled to the arm 1732d by the pressed-in insert 1738. For example, the pressure tube 1704 may have an aperture extending from one face to a second face through which the pressed-in insert 1738 may pass through. The pressed-in insert 1738 may also have a threaded end that may receive a threaded fastener, such as a nut 1740. The nut 1740 may threadedly engage with the pressed-in insert 1738 such that the pressure tube 1704 is fastened to the arm 1732d, as shown in connection portion 1736, and in isometric detail in FIG. 17C. Alternative or additional methods of coupling the pressure tube 1704 to the arm 1732d may include, by way of non-limiting example, adhesive, welding, thru-bolts, etc. It is understood that magnet 1706 and/or the sensing unit 1701 may be coupled to additional and/or alternative elements of the vehicle without digressing from the methods and systems described herein. For example, the magnet 1706 may be coupled to the arm 1732c, and the sensing unit 1701 may be coupled to the boom arm 1732c.

While FIGS. 17A-17C show the sensing unit 1701 coupled to the side of the arm 1732c and/or the 1732d, the sensing unit 1701 and/or the magnet 1706 may be coupled to any side, portion, section, or otherwise of their respective boom elements. For example, the sensing unit 1701 may be coupled to the bottom or top of the arm 1732d. Likewise, the vehicle may comprise multiple magnets 1706 and/or sensing units 1701.

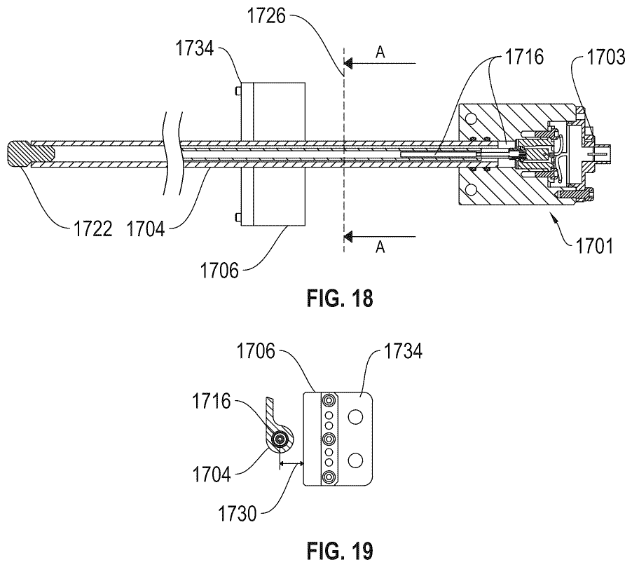

FIGS. 18A-18B illustrate additional embodiments of the sensing unit 1701. FIG. 19 is a section view 1726 of FIG. 18. A magnet distance 1730 is illustrated between the position sensor 1702 and the magnet 1706. The magnet distance 1730 is a distance in which the magnetic field of the magnet 1706 may affect a strain on the sensing element 1716.

The distal end of the pressure tube 1704 may accept a plug 1722, as shown in FIG. 17A. The plug 1722 may be positioned within an interior diameter of the pressure tube 1504 so as to seal the interior of the pressure tube 1704 from contaminants such as debris and/or fluids. The plug 1722 may include one or more male threads to engage with corresponding female threads on the interior surface of the pressure tube 1704. Alternatively or additionally, the plug 1722 may include female threads to threadedly engage with male threads on an exterior of the pressure tube 1704

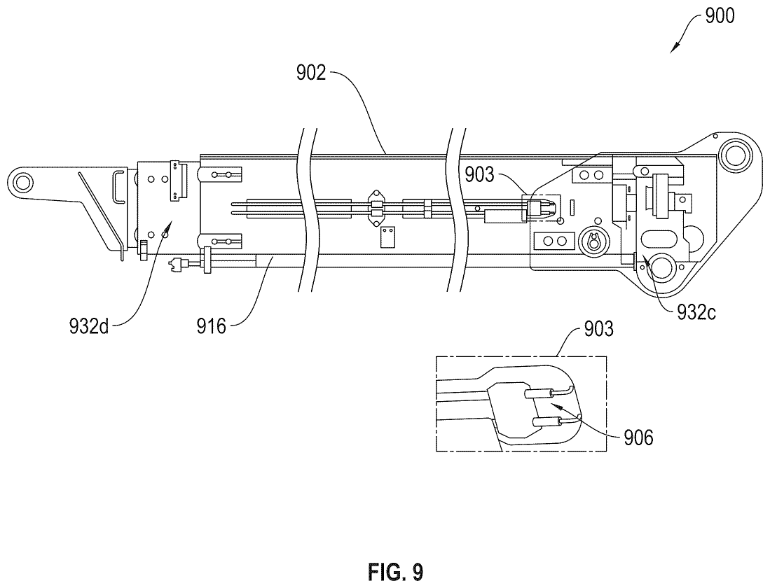

Turning back now to FIG. 9, a lift assembly 900 is shown with a position sensor 902. The position sensor 902 may any embodiment disclosed herein, including Hall effect sensors, magnetorestrictive position sensors, microwave position sensors, etc. In an exemplary embodiment, as shown in FIG. 9, the position sensor 902 is a magnetorestrictive position sensor. According to an embodiment, a sensing element 916 is mounted to an upper lift arm (e.g., upper lift arm 32c of FIG. 1) and configured to stay static in relation to the movement of an intermediate lift arm. As shown in FIG. 9, the upper lift arm is transparent and the intermediate lift arm 932d is shown. The upper lift arm and the intermediate lift arm 932d may be coupled by an extending member (e.g., a hydraulic piston and cylinder, rotating mechanical linkage, gear linkage, etc.). As the extending member moves (e.g., extends and retracts), the intermediate lift arm moves in and out of an internal cavity of the upper lift arm 932c. A magnet 906 is shown coupled (removeably or fixedly) to the intermediate lift arm 932d (as seen in the section 903). In this configuration, as the intermediate lift arm 932d moves in and out of the cavity of the upper lift arm 932c, the magnet 906 moves in relation to the sensing element 916. As the magnet moves along the sensing element 916, a sensing unit (e.g., the sensing unit 501 of FIG. 5) is able to determine the position of the magnet 906 in relation to the sensing element 916 and, by extension, the position of the intermediate lift arm 932d in relation to the upper lift arm.

This embodiment allows for the position sensor 902 to fit between the side sheets on all booms. This allows for better protection of the position sensor 902 because in the retracted position it is hidden from external damage.

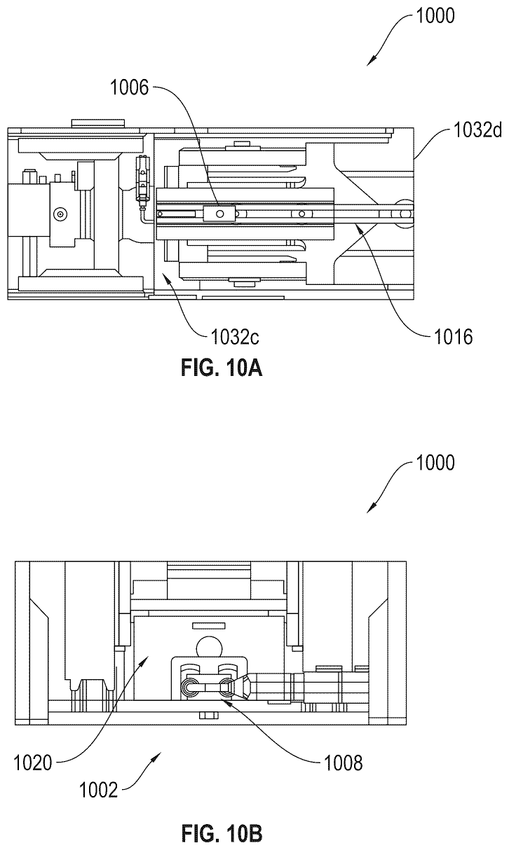

According to another embodiment, FIGS. 10A-10B show a lift assembly 1000 with a position sensor 1002 positioned externally thereon. According to an embodiment, a sensing element 1016 is statically coupled to an upper lift arm 1032c by one or more mounting clips 1008. A magnet 1006 is coupled to an intermediate lift arm 1032d. The intermediate lift arm 1032d is coupled to the upper lift arm 1032c by an extending element (e.g., a hydraulic cylinder and piston). As described here, as the intermediate lift arm 1032d is extended in and out of an inner channel of the upper lift arm 1032c, the magnet 1006 coupled to the intermediate lift arm 1032d moves along the sensing element 1016 without touching it. In some embodiments, a wear pad 1020 houses the magnet 1006. In some embodiments, the wear pad 1020 is positioned between a lower surface of the intermediate lift arm 1032d and a lower inner surface of the upper lift arm 1032c. This wear plate allows the two arms 1032c, 1032d to slide past each other during extension and retraction with minimal friction and wear to the arms 1032c, 1032d. In some embodiments, the sensing element(s) 1016 are disposed in channels in the wear pad 1020.

As discussed herein, the position sensor 37 of FIG. 1 may be a Hall effect sensor or a magnetorestrictive position sensor. However, several other embodiments are disclosed herein. For example, the position sensor 37 of FIG. 1 may also be a laser or LED length sensing sensor, a microwave sensing unit, a rotary encoder, or a potentiometer.

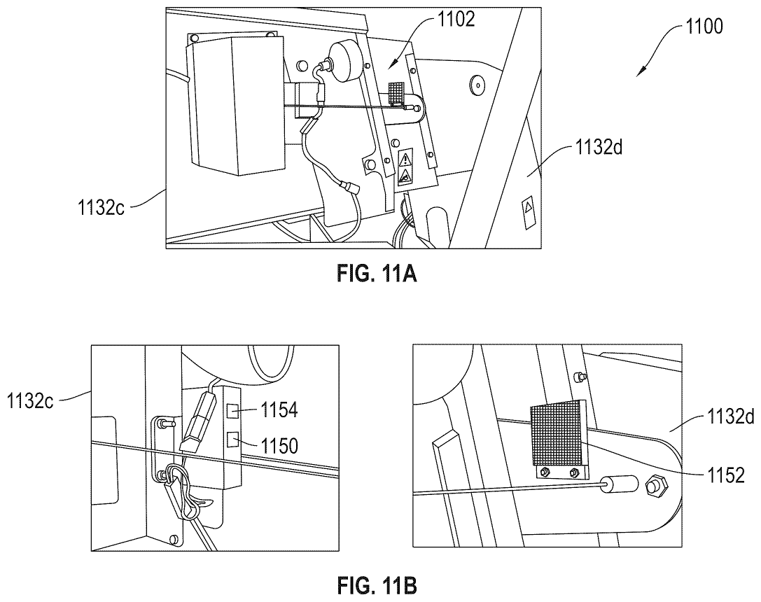

As shown in FIGS. 11A-11B, a laser/LED length sensing unit 1102 is shown on a lift assembly 1100. The lift assembly 1100 may comprise an upper lift arm 1132c and an intermediate lift arm 1132d. Coupled to the upper lift arm 1132c is an emitter 1150. A reflector 1152 is positioned on the intermediate lift arm 1132d. The sensing unit 1102 may be any one of several photoelectric sensor embodiments. For example, the sensing unit 1102 may employ triangulation technology and/or time-of-flight sensing technology.

In a triangulation embodiment, the emitter 1150 emits a beam of light (typically infrared) towards the reflector 1152. When the light beam encounters the reflector 1152, it reflects or scatters the light. A receiver 1154 detects the reflected or scattered light. By measuring the angle or position of the received light, sensing unit 1102 can calculate the distance between the receiver 1154 and the reflector 1152 using triangulation principles. The receiver 1154 typically uses lenses or optics to focus the received light onto a position-sensitive detector (PSD) or an array of photodiodes. Based on the detected position of the light on the PSD or photodiode array, the receiver 1154 can determine the distance to the reflector 1152. Because the reflector 1152 is coupled to the intermediate lift arm 1132d in a known position in relation to the upper lift arm 1132c, the sensing unit 1102 can employ a mapping technique using the known position to determine the position/distance of the intermediate lift arm 1132d with respect to the upper lift arm 1132c or the lift device 10 of FIG. 1, or any known datum.

In a time-of-flight embodiment, time-of-flight sensors (e.g., the sensing unit 1102) use the speed of light to measure distances. The emitter 1150 emits short pulses of light (often laser pulses) towards the reflector 1152. The emitted light reflects off the reflector and returns to a receiver 1154. The receiver 1154 measures the time it takes for the light pulse to travel to the reflector 1152 and back. Since the speed of light is known, the receiver 1154, and the sensing unit generally, can calculate the distance between the reflector 1152 and the receiver 1154. The time-of-flight sensors may use specialized detectors, such as avalanche photodiodes, to detect the returning light pulses accurately.

In some embodiments, the reflector 1152 may be integrated into the intermediate lift arm 1132d and may be any material that reflects light (visible or otherwise). In some embodiments, the reflector 1152 is made of a specific material with high reflectivity, such as metal, plastic, glass, or an optical film.

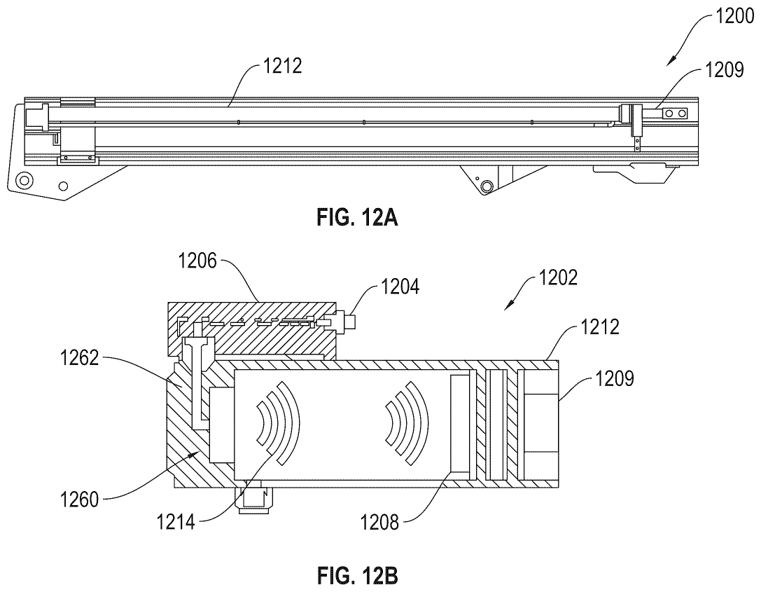

FIGS. 12A-12B illustrate a lift assembly 1200 with an integrated internal position sensor 1202. In an exemplary embodiment, the internal position sensor 1202 is a microwave position sensor integrated into a hydraulic cylinder 1212. The position sensor 1202 may include an antenna 1260, a T Card 1262, a sensor 1206, and a connector 1204.

In an embodiment, the microwave position sensor 1202 functions in the following manner: the antenna 1260 emits short pulses of microwave signals 1214, typically in the gigahertz range. These signals propagate in the cylinder 1212 in a directional beam. When the emitted microwave signals 1214 encounter objects (e.g., a piston head 1208) in their path, a portion of the energy is reflected back towards the sensor antenna 1260. The antenna 1260 has a receiver that captures the reflected microwave signals 1214. The receiver is designed to detect and process these signals 1214, for example, through sensor 1206. By measuring the time it takes for the emitted microwave signals 1214 to travel to the object and back, the sensor can calculate the distance to the piston head 1208 of the piston 1209. The sensor's 1206 electronics analyze the received signals and process the data to extract relevant information. This can involve filtering out noise, performing calculations, and interpreting the signal characteristics. By combining information from multiple reflected signals, the sensor can determine the position or distance of objects within its field of view. This information can be used for various purposes, such as object detection, tracking, or proximity sensing.

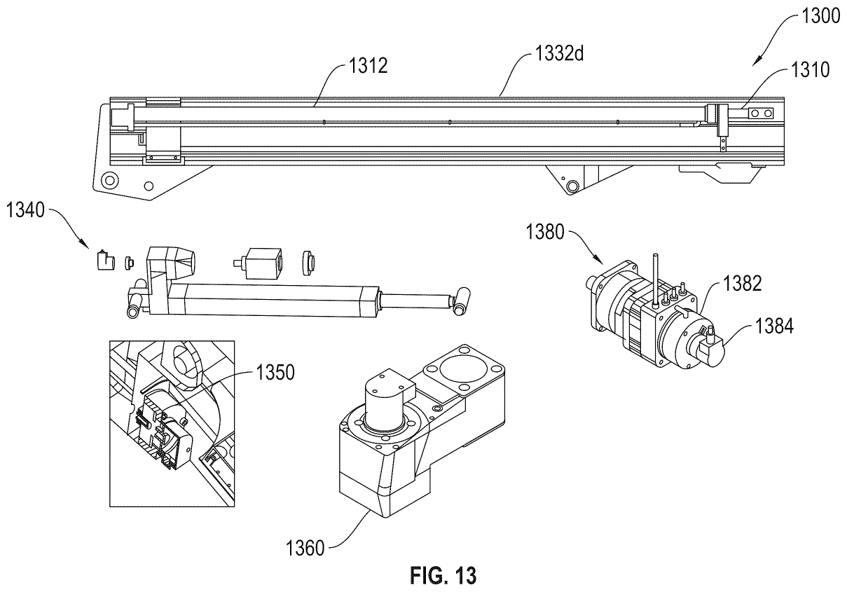

Turning now to FIG. 13, a lift assembly 1300 is shown comprising a cylinder 1312, a piston 1310, an upper lift arm, and an intermediate lift arm 1332d. The cylinder 1312, the piston 1310, the upper lift arm, and the intermediate lift arm 1332d may be of a similar structure as described herein with regard to various other figures. However, in other embodiments, the lift assembly 1300 comprises a linear actuator 1340 which converts rotational movement into linear motion. For example, through the use of a motor and/or gearbox. In one embodiment, a motor 1380 is coupled to a brake 1382. An encoder 1384 is mounted through the brake 1382 and the motor 1380. An example of an encoder is shown as the encoder 1360. An exemplary motor 1350 is shown.

To determine linear position using the encoder 1360, it is mechanically connected to the linear actuator 1340, which may be a lead screw, rack and pinion gear, or belt. As the linear actuator 1340 moves, it causes the attached encoder 1360 to rotate. The encoder consists of a rotating disc or wheel with evenly spaced marks or slots, along with a sensor (optical or magnetic) that detects these marks as the disc rotates.

When the marks pass by a sensor internal to the encoder 1360, it generates electrical signals. The specific pattern and timing of these signals depend on the encoding scheme used by the rotary encoder 1360, which can be incremental or absolute. These signals are then processed by electronic circuitry, which interprets the rotation of the encoder 1360 and converts it into linear displacement based on the known mechanical characteristics of the linear actuator 1340.

For accurate linear position determination, calibration and scaling procedures may be necessary. These procedures establish a precise relationship between the rotation of the encoder 1360 and the corresponding linear position, ensuring reliable and accurate measurements.

By combining the rotational information from the encoder 1360 with the mechanical characteristics of the linear motion mechanism, the system can estimate and track the linear position based on the output of the encoder.

In some embodiments, the linear actuator 1340 is coupled at one to the upper lift arm and coupled to the intermediate lift arm 1332d at another end. In this way, as the linear actuator 1340 is actuated by the motor 1380, the intermediate lift arm 1332d is translated in relation to the upper lift arm 1332d, thus resulting in a telescoping movement.

In FIG. 13, the encoder 1360 is shown mounted to the back of a linear actuator gearbox, however, alternative packaging variations may include mounting the encoder 1384 through the brake and/or mounting through the motor. It should be noted, that the rotary encoder embodiment may be used to measure the linear position of the intermediate lift arm 1332d in any mechanism utilizing rotary motion to cause linear motion. Similar encoder mounting/technology could also be applied to measure machine rotation (i.e., platform or turntable).

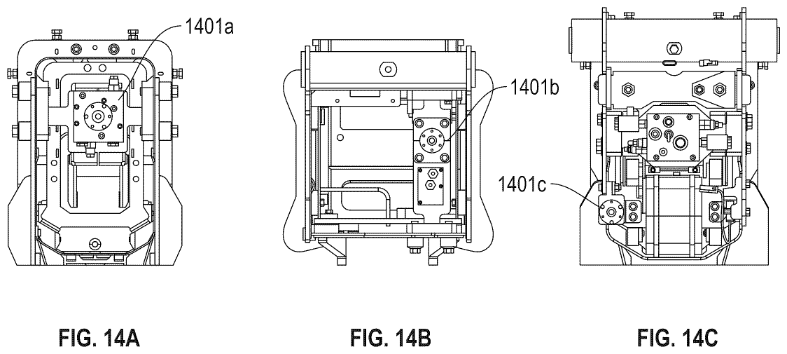

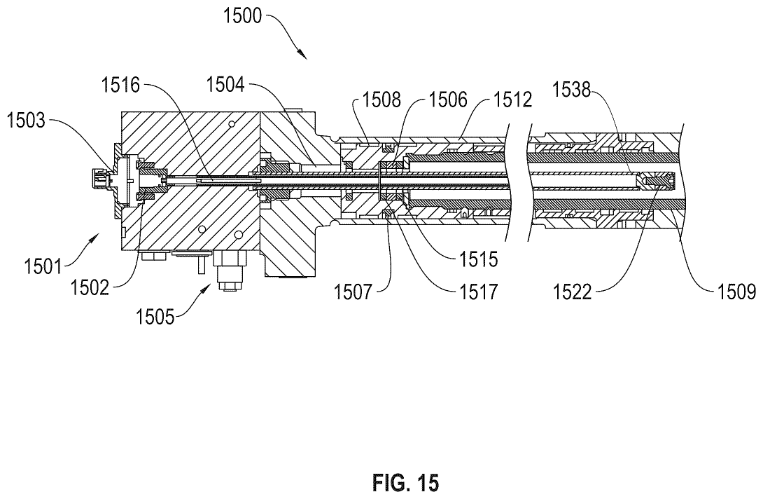

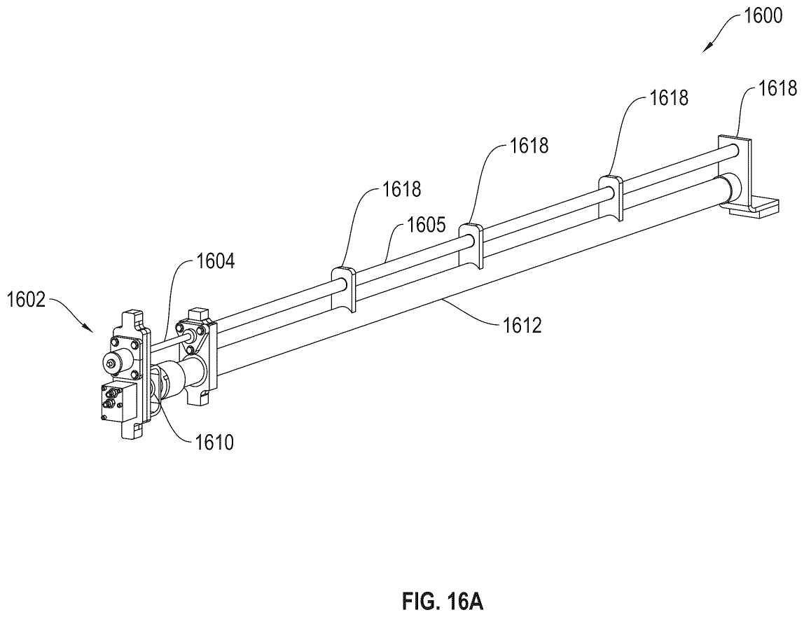

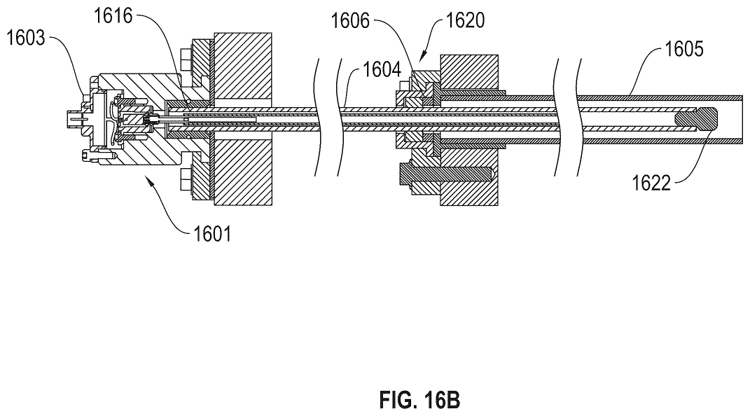

Turning now to FIGS. 14A-16C, various implementations of the methods and systems described herein are illustrated according to an embodiment. FIG. 14A is a rear-view of an in-cylinder sensing unit 1401a with a sensing element (e.g., sensing element 1516 of FIG. 15) mounted within a hydraulic cylinder, according to an embodiment. FIG. 14B is a rear-view of an externally mounted sensing unit 1401b with a sensing element (e.g., sensing element 1616 of FIG. 16B) external to a hydraulic cylinder, according to an embodiment. FIG. 14C is a rear-view of an externally mounted sensing unit 1401c with a sensing element (e.g., sensing element 1716 of FIG. 17) mounted external to a hydraulic cylinder, according to an embodiment.

Turning now to FIG. 15, a sensing unit 1501 implemented in the interior of a hydraulic assembly 1500 is illustrated, according to an embodiment. The hydraulic assembly 1500 may comprise a piston rod 1509 and a cylinder 1512, fluidly coupled to one another. Specifically, the piston rod 1509 may be received within the cylinder 1512. The piston rod 1509 may include a seal 1507 to separate a first portion of the cylinder 1512 from a second portion of the cylinder 1512, such that the two portions (e.g., the two inner volumes) are separated by the seal 1507 as the piston rod 1509 moves within the cylinder 1512. Accordingly, the piston rod 1509 may be extended within the cylinder 1512 to an extended position or retracted into the cylinder 1512 into a retracted position by adding pressurized fluid (e.g., hydraulic oil) to one or more of the two inner volumes. The piston rod 1509 is positioned within the cylinder 1512, and the seal 1507 creates a fluid-tight seal with an inner surface of the cylinder 1512. The piston rod 1509 may also be fixedly coupled to a member of the lift assembly 14 of FIG. 1. In some embodiments, the piston rod 1509 is coupled to the upper lift arm 32c and the cylinder 1512 is coupled to the intermediate lift arm 32d. In this embodiment, as the piston and cylinder translate into an extended position by hydraulically pressurizing the second portion of the cylinder, the intermediate lift arm 32d moves into an extended position. In some embodiments, the piston rod 1509 is coupled to the intermediate lift arm 32d and the cylinder is coupled to the upper lift arm 32c of FIG. 1. In substantially the same manner, the upper lift arm 32c and the intermediate lift arm 32d are adjusted into the extended position as the cylinder 1512 and piston rod 1509 extend.

The hydraulic assembly 1500 may also comprise a position sensor 1502. The position sensor 1502 may be coupled to a second end of the cylinder 1512. As shown in FIG. 15, the position sensor 1502 may include a sensor element 1516 inside a pressure tube 1504 (the sensor element 1516 being either flexible or rigid), a magnet 1506, and a sensing unit 1501 or sensor. The sensing unit 1501 may be a Hall effect sensor or magnetorestrictive position sensor.

The magnetorestrictive position sensor is a type of sensor used to measure the position, displacement, or level of an object, such as the position of the piston rod 1509 in the cylinder 1512. The sensing unit 1501 utilizes the principle of magnetostriction, which is the property of certain materials to change their shape or dimensions when subjected to a magnetic field.

In a magnetorestrictive position sensor, a sensing element or waveguide (e.g., sensor element 1516 inside the pressure tube 1504) made of a magnetorestrictive material, such as Terfenol-D, Metglas 2605SC, cobalt ferrite, nickel, or Galfenol, is used. The sensing element may be a thin metal wire or rod (e.g., sensor element 1516 inside the pressure tube 1504) that is placed in close proximity to a permanent magnet (e.g., magnet 1506).

When an electrical current pulse is passed through the sensor element 1516 inside the pressure tube 1504, it generates a magnetic field that interacts with the permanent magnet 1506. This interaction causes the magnetorestrictive material (e.g., the sensor element 1516 inside the pressure tube 1504) to experience a strain, resulting in a mechanical wave or “strain wave” propagating along the sensor element 1516 inside the pressure tube 1504.

To determine the position of the piston rod 1509 in the cylinder 1512 (and by association, the position of the intermediate lift arm 32d in relation to the upper lift arm 32c), a pickup or transducer (e.g., the position sensor 1502) is placed along the sensing element 1516 to detect the strain wave. The transducer converts the mechanical strain into an electrical signal, which is then processed to determine the precise position of the piston within the cylinder 1512.

In some embodiments, the position sensor 1502 is a Hall effect sensor. The Hall effect sensor may function in the following manner to determine the position of the piston rod 1509 in relation to the cylinder 1512. The Hall effect sensor may comprise a thin strip or plate of semiconductor material (e.g., sensor element 1516 inside the pressure tube 1504) with current flowing through it. When a magnetic field is applied perpendicular to the direction of the current, the Lorentz force acts on the charge carriers (electrons or holes) within the material. The Lorentz force causes the charge carriers to be deflected towards one side of the semiconductor material, resulting in an accumulation of charge carriers on one edge and a depletion of charge carriers on the opposite edge. This creates a voltage difference, known as the Hall voltage, across the material. The Hall voltage may be measured using the position sensor's 1502 built-in electrodes or contacts placed along the edges of the semiconductor strip. These electrodes pick up the voltage difference created by the Hall effect. The Hall voltage is proportional to the strength of the magnetic field and can be positive or negative depending on the polarity of the magnetic field and the type of charge carriers (electrons or holes) in the material. The output signal from the Hall effect sensor can be analog (continuous voltage) or digital (on/off signal) depending on the sensor's design and application. By measuring the Hall voltage, the Hall effect sensor can determine the presence, strength, and polarity of the magnetic field. It can detect magnetic fields from permanent magnets (e.g., magnet 1506), electromagnets, or magnetic field changes induced by moving objects.

In embodiments with the sensor element 1516 inside the pressure tube 1504 being flexible, serviceability is increased, and the sensor element 1516 inside the pressure tube 1504 may be extracted from the cylinder 1512 without contaminating the system by unscrewing the lid 1503 from the sensing unit 1501.

In operation of the lift device 10 of FIG. 1, upon the control system receiving a command to extend the intermediate lift arm 32d, the hydraulic assembly 1500 pressurizes one of the two chambers of the cylinder 1512 created by the piston rod 1509 to apply a force upon a piston head 1508 of the piston rod 1509. This pressure causes the piston rod 1509 to move and, by extension, the piston rod 1509 to extend from the cylinder 1512. As the piston head 1508 moves along the cylinder 1512, the magnet 1506 moves along the sensor element 1516 inside the pressure tube 1504, which remains stationary during the movement of the piston rod 1509. The pressure tube 1504 extends through the piston head 1508 through a sealed channel which prevents the pressurized fluid from exchanging between the two chambers of the cylinder 1512. As the magnet 1506 moves along the sensor element 1516, the position sensor 1502 determines the position of the piston head 1508 within the cylinder. This position may be mapped to a position of the intermediate lift arm more generally, and that position may be transmitted to a display of the lift device. By placing the sensor element 1516 inside the cylinder, it improves the reliability of the measuring system because it is protected from external damage. A valve block 1505 may be used to selectively port pressurized hydraulic fluid to separate chambers within the cylinder 1512. The valve block 1505 may include a lid 1503 that may be used to access the sensor element 1516 and remove the sensor element 1516 for service and/or replacement. In some embodiments, the hydraulic assembly 1500 may include multiple sensor element 1516 and/or magnet 1506.

The hydraulic assembly 1500 may additionally or alternatively include a pressure tube 1504 with an interior cavity defined by an interior surface 1538. The interior surface 1538 may extend some or all of the length of the pressure tube 1504 along a longitudinal axis of the pressure tube 1504. Within the pressure tube 1504 is housed a sensor element 1516. The sensor element 1516 may be a part of a magnetorestrictive sensor element that responds to magnetic fields (such as produced by the magnet 1506) in the form of a mechanical strain pulse. For example, the sensor element 1516 may be a flexible magnetorestrictive position sensor or a rigid magnetorestrictive position sensor. A position sensor 1502 (as shown in FIG. 15B) may receive an indication of the mechanical strain pulse in the form of electrical signals. The received electrical signals may be filtered or otherwise corrected/adjusted to assign a value to the received signal. The signal may then be transmitted to a processor to determine a position of the magnet 1506 (and by association, the piston rod 1509) in relation to the sensor element 1516. To simplify assembly and production of the hydraulic assembly 1500, the magnet 1506 may be positioned between the piston rod 1509 and the piston head 1508. The magnet 1506 may be positioned between a first spacer 1515 and a second spacer 1517, as shown in FIG. 15.

In some embodiments, the magnet 1506 is a hollow cylinder (e.g., an annular element) that is radially disposed about the pressure tube 1504. Because the pressure tube 1504 surrounds the sensor element 1516 in some embodiments, the magnet 1506 may also be radially disposed about/around the sensor element 1516. However, in some embodiments, the magnet 1506 may not be radially disposed about the sensor element 1516. In such embodiments, the magnet 1506 may be positioned proximate (but not necessarily in contact with) the sensor element 1516 such that a magnetic field of the magnet 1506 may induce a strain pulse through the sensor element 1516. The pressure tube 1504 may be open at a distal end. The distal end of the pressure tube 1504 may accept a plug 1522, as shown in FIG. 15. The plug 1522 may be positioned within an interior diameter of the pressure tube 1504 so as to seal the interior of the pressure tube 1504 from contaminants such as debris and/or fluids. The plug 1522 may include one or more male threads to engage with corresponding female threads on the interior surface of the pressure tube 1504. Alternatively or additionally, the plug 1522 may include female threads to threadedly engage with male threads on an exterior of the pressure tube 1504. In some embodiments, the plug 1522 may extend to an interior surface of the piston rod 1509, so as to support the distal end of the pressure tube 1504 from bending away from a longitudinal axis of the piston rod 1509.

The hydraulic assembly 1500 may be used in, for example, a boom assembly that is used for extending and retracting a work platform, such as shown in the lift device 10 of FIG. 1. The boom assembly may include a base member and an extension member, each coupled to either the cylinder 1512 or the piston rod 1509. In at least one embodiment, the base member is coupled to the cylinder 1512 and the extension member is coupled to a distal of the piston rod 1509 such that the extension member extends from within the base member when the piston rod 1509 extends from within the cylinder 1512. The distal end of the piston rod 1509 may include one or more apertures through which the extension member may be rotatably coupled to the piston rod 1509. In some embodiments, the base member is the upper lift arm 32c of FIG. 1 and the extension member is the intermediate lift arm 32d of FIG. 1. In some embodiments, the lift device (e.g., lift device 10 of FIG. 1) may include one or more hydraulic assembly 1500 of FIG. 15 that are used to extend and/or retract one or more extension members from one or more base members.

Turning now to FIGS. 16A-16BC, various views of an exemplary position sensor 37 of FIG. 1 is shown. In the embodiment illustrated in FIGS. 16A-16C, a sensor unit 1601 is shown positioned exterior to a hydraulic extender 1600. The hydraulic extender 1600 may comprise a cylinder 1612 and a piston 1610. The position sensor 1602 may be any number of position sensors, including a magnetorestrictive position sensor or a Hall effect sensor. In an exemplary embodiment, the position sensor 1602 is a magnetorestrictive position sensor. The position sensor 1602 may include an inner tube 1604, a sensing element 1616, a sensing unit 1601, a magnet 1606, and an outer tube 1605. In one embodiment (as shown in FIGS. 16A-6C), the outer tube 1605 is removeably or fixedly coupled to the cylinder 1612 by brackets 1618. The sensing unit 1601 may be removeably or fixedly coupled to the piston 1610. The inner tube 1604 is removeably or fixedly coupled to the sensing unit 1601 such that as the piston 1610 moves within the cylinder 1612, the sensing unit 1601 and the inner tube 1604 move in a corresponding manner. Additionally, in some embodiments, the sensing element 1616 is disposed within the inner tube 1604 and is removeably coupled to the sensing unit 1601 and moves accordingly. The magnet is housed in a magnet housing 1620, which may be removeably or fixedly coupled to the cylinder 1612. Thus, as the piston 1610 moves within the cylinder 1612, the sensing element 1616 moves in relation to the magnet 1606 and sends a signal to the sensing unit 1601. This signal may be amplified, filtered, and used to determine a precise position of the piston 1610 (and by extension, the intermediate lift arm 32d). The sensing element 1616 may be easily removed for replacement or repair by removing a lid 1603.

The distal end of the inner tube 1604 may accept a plug 1622, as shown in FIG. 16B. The plug 1622 may be positioned within an interior diameter of the pressure tube 1604 so as to seal the interior of the inner tube 1604 from contaminants such as debris and/or fluids within the pseudo cylinder (e.g., the outer tube 1605). The plug 1622 may include one or more male threads to engage with corresponding female threads on the interior surface of the inner tube 1604. Alternatively or additionally, the plug 1622 may include female threads to threadedly engage with male threads on an exterior of the pressure tube 1604.

By placing the position sensor external to the cylinder, serviceability is increased. Additional advantages of the exterior placement of the position sensor include allowing alternate cylinder orientation (e.g., rod porting), allowing smaller cylinder sizing, and allowing the use of the position sensor in boom extension systems not using hydraulic cylinders.

It should be understood that the embodiments and descriptions disclosed herein may be coupled together to measure multiple aspects of the lift assembly 14 of FIG. 1. For example, one or more position sensors disclosed herein may be used to measure the distance of multiple booms and telescoping members of the lift device 10.

### Platform Travel Replay

During operation of the lift device 10, the platform assembly 16 may be moved to various locations so that an operator can perform a job at a work site. Moving the platform assembly 16 from an initial position to a work site (e.g., a positioning event) may be facilitated by one or more of the pivot motor 26, the platform rotator 30, the actuators 34a, 34b, 34c, 34d, the extension actuator 35, the turntable motor 44, and/or the electric motors 52. In general, an operator may interface with the user interface 20 to control operation of the pivot motor 26, the platform rotator 30, the actuators 34a, 34b, 34c, 34d, the extension actuator 35, the turntable motor 44, and/or the electric motors 52, which results in movement of the platform assembly 16.

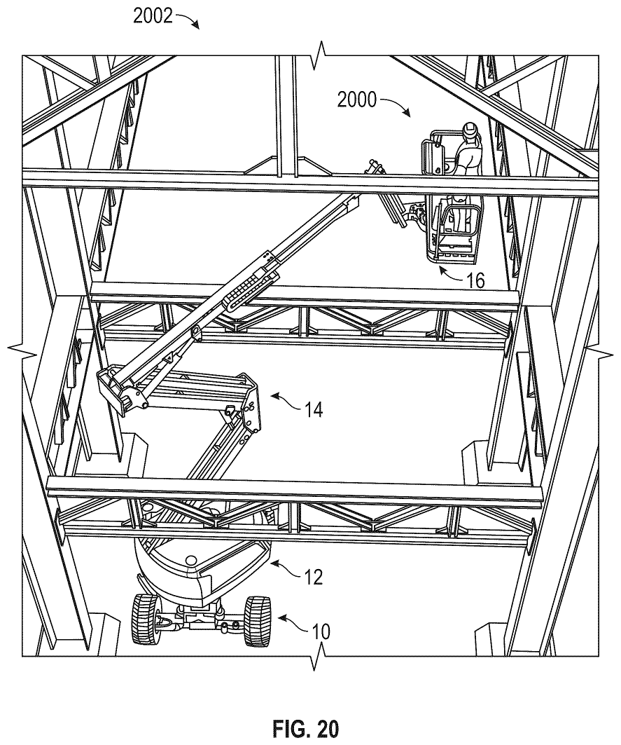

FIG. 20 shows an example of the lift device 10 with the platform assembly 16 at a work site 2000 amongst a steel structure or building frame 2002. In general, moving the platform assembly 16 from an initial position to a work site can be a difficult and time consuming process for an operator to perform manually. For example, a positioning event may include two or more steps, or three or more steps, or five or more steps, or ten or more steps that are input to the user interface 20 and perform the individual movements of the platform assembly 16 that result in travel to a work site 2000.

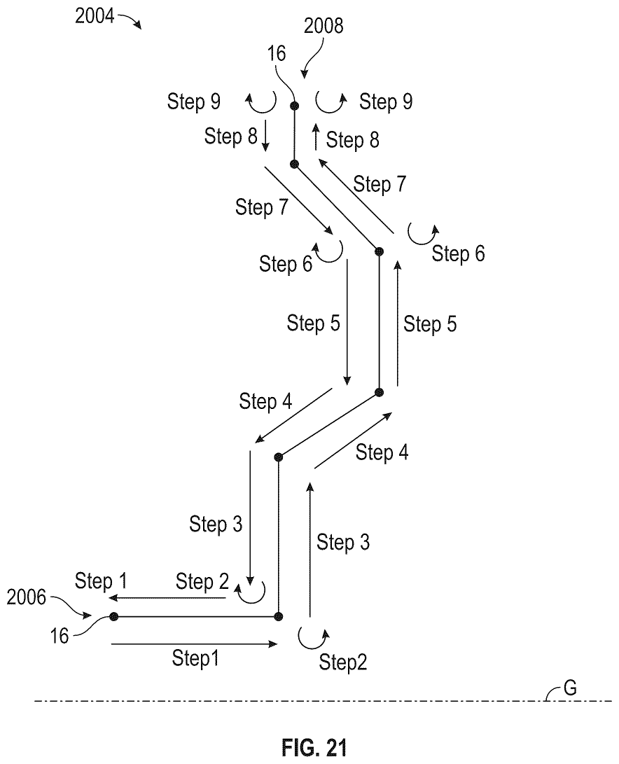

FIG. 21 schematically illustrates a positioning event 2004 for the platform assembly 16, where the platform assembly 16 is moved from an initial position 2006 to a work site 2008 (e.g., the work site 2000 within the building frame 2002). In general, the platform assembly 16 is moved relative to a ground plane G, for example, by an operator interfacing with the user interface 20 or in an automated fashioned by a control system or controller as described herein. In some embodiments, the positioning event 2004 may initiate, at step 1, with the platform assembly 16 being driven to a pre-lift position by the electric motors 52 driving the tractive elements 82, which moves the base assembly 12, and the platform assembly 16 coupled thereto, in a predefined direction (e.g., a first drive direction, the forward direction 50, or the rearward direction 51). At step 2, the turntable motor 44 may rotate the turntable 70 and the platform assembly 16 coupled thereto (e.g., in a first rotation direction). Once the platform assembly 16 is rotated at step 2, the platform assembly 16 is lifted (e.g., in a first lift direction or the upward direction 46), at step 3, by one or more of the actuators 34a, 34b, 34c, 34d. With the platform assembly 16 lifted, the extension actuator 35 may extend the platform assembly 16 at step 4 and the platform assembly 16 may be lifted again by one or more of the actuators 34a, 34b, 34c, 34d at step 5. The turntable motor 44 may again rotate the turntable 70 and the platform assembly 16 coupled thereto at step 6, and the extension actuator 35 may further extend the platform assembly 16 at step 7. One or more of the actuators 34a, 34b, 34c, 34d may again lift the platform assembly at step 8, and the platform assembly 16 may be rotated by the platform rotator 30 or pivoted by the pivot motor 26 at step 9 to reach the work site 2008. It should be appreciated that although the exemplary positioning event 2004 in FIG. 21 includes nine steps, the systems and methods of the present disclosure are applicable to positioning events with more or fewer than nine steps and that include any order or number of positional movements of the platform assembly 16.

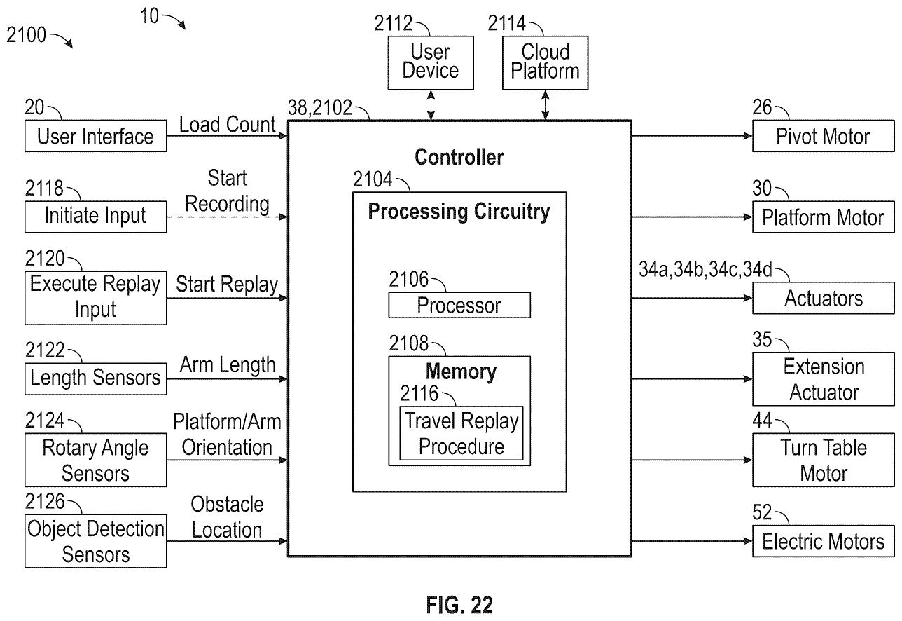

Referring to FIG. 22, the lift device 10 includes a control system 2100 that includes a controller 2102 (e.g., the controller 38). The controller 2102 includes a processing circuitry 2104, a processor 2106, and a memory 2108. Processing circuitry 2104 can be communicably connected to a communications interface such that the processing circuitry 2104 and the various components thereof can send and receive data via the communications interface. The processor 2106 can be implemented as a general purpose processor, an application specific integrated circuit (ASIC), one or more field programmable gate arrays (FPGAs), a group of processing components, or other suitable electronic processing components.

The memory 2108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory 2108 can be or include volatile memory or non-volatile memory. The memory 2108 can include database components, object code components, script components, or any other type of information structure for supporting the various activities and information structures described in the present application. According to some embodiments, the memory 2108 is communicably connected to the processor 2106 via the processing circuitry 2104 and includes computer code for executing (e.g., by the processing circuitry 2104 and/or the processor 2106) one or more processes described herein.

In some embodiments, the controller 2102 is implemented within a single computer (e.g., one server, one housing, etc.). In various other embodiments, the controller 2102 can be distributed across multiple servers or computers (e.g., that can exist in distributed locations).

In the illustrated embodiment, the controller 2102 is in communication with the user interface 20, the pivot motor 26, the platform rotator 30, the actuators 34a, 34b, 34c, 34d, the extension actuator 35, the turntable motor 44, the electric motors 52, and one or more object detection sensors 2126. In some embodiments, the controller 2102 is in communication with a user device 2112 (e.g., a cell phone, a tablet, a computer, etc.). In some embodiments, the controller 2102 is in communication with a cloud platform 2114, for example, via a wireless connection. In the illustrated embodiment, the memory 2108 stores instructions for a travel replay procedure 2116.

In some embodiments, the controller 2102 is in communication with an initiate input 2118 that is configured to trigger the controller 2102 to initiate a recording process in the travel replay procedure 2116. In some embodiments, the initiate input 2118 is on the user interface 20 in the form of a button, a switch, a graphical button, or a soft key on a display. In some embodiments, the initiate input 2118 is in the form of a button or a switch arranged on the platform assembly 16 in a location remote from the user interface 20, which separates the travel replay procedure 2116 from the standard operational controls on the user interface 20. In some embodiments, the initiate input 2118 is in the form of a graphical button, a digital button, or soft key on the user device 2112.

In some embodiments, the controller 2102 is in communication with a replay execute input 2120 that is configured to execute a forward replay or a reverse replay of the travel replay procedure 2116. In some embodiments, the replay execute input 2120 is on the user interface 20 in the form of reverse/forward buttons, reverse/forward switches, reverse/forward graphical/digital buttons, or reverse/forward soft keys on a display. In some embodiments, the initiate input 2118 is in the form of reverse/forward buttons or reverse/forward switches arranged on the platform assembly 16 in a location remote from the user interface 20, which separates the replay execute input 2120 from the standard operational controls on the user interface 20. In some embodiments, the replay execute input 2120 is in the form of reverse/forward soft keys on the user device 2112.

In some embodiments, the controller 2102 is in communication with one or more length sensors 2122, one or more rotary angle sensors 2124, and one or more object detection sensors 2126. The one or more length sensors 2122 may be in the form of ultrasonic, optical (e.g., laser, LIDAR, etc.), or hall effect sensors that are configured to detect an extension or retraction length of each of the lift arms 32a, 32b, 32c, 32d and/or extension or retraction length of each of the actuators 34a, 34b, 34c, 34d and the extension actuator 35. The one or more rotary angle sensors 2124 may be in the form of rotary encoders or a rotary limit switch that measures, for example, the angles 75a, 75b, 75c, the rotation about the axis 28, and/or the pivot about the axis 25. The object detection sensors 2126 may be in the form of radar sensors, scanning laser sensors, light detection and ranging (LIDAR) sensors, and image processing sensors, such as cameras. The object detection sensors 2126 may be mounted to the base assembly 12, the lift arms 32a, 32b, 32c, 32d, and/or the platform assembly 16. In general, the object detection sensors 2126 are configured to detect objects adjacent to the base assembly 12, the lift arms 32a, 32b, 32c, 32d, and/or the platform assembly 16. In response to the object detection sensors 2126 detecting an object within a predefined vicinity (e.g., within a predetermined distance) of the base assembly 12, the lift arms 32a, 32b, 32c, 32d, and/or the platform assembly 16, the controller 2102 is configured to cease or override the travel replay procedure 2116. For example, the object detection sensors 2126 are configured to detect if an object or obstruction is present along the travel path of the platform assembly 16. With several components of the lift device 10 potentially moving as the platform assembly 16 travels to/from a work site, the object detection sensors 2126 may be arranged on each moving component of the lift device 10 and define a field of view that encompasses the entire range of motion defined by each component.

In general, the controller 2102 is configured to record the individual steps during a positioning event, for example, in response to receiving an initiate signal from the initiate input 2118 (e.g., a user interfacing or engaging with the initiate input 2118), or in response to the controller 2102 or the cloud platform 2114 automatically identifying that a positioning event is occurring based on previously stored data that is stored in the cloud platform 2114 and analyzed using a machine learning algorithm. The travel replay procedure 2116 may enable the controller 2102 to automate the recorded positioning event, either in the order it was recorded (e.g., forward) or in reverse, to move the platform assembly 16 without operator interaction.

In some embodiments, in response to receiving the initiate signal (e.g., start recording) from the initiate input 2118 (e.g., when the platform assembly 16 is at an initial position), the controller 2102 begins to record each of the inputs (e.g., steps) to the user interface 20 that result in a movement of the platform assembly 16 (e.g., a positioning event). For example, the controller 2102 may record a plurality of input steps that are applied by an operator to the user interface 20, with each of the input steps resulting in movement of the platform assembly 16 by at least one of the plurality of actuators/motors on the lift device 10 (e.g., the pivot motor 26, the platform rotator 30, the actuators 34a, 34b, 34c, 34d, the extension actuator 35, the turntable motor 44, and/or the electric motors 52). The controller 2102 may record a direction and magnitude (e.g., an extension/retraction distance, degrees of rotation, etc.) for each of the input steps performed during the positioning event. In some embodiments, the controller 2102 and/or the cloud platform 2114 may record the input steps that are applied by the user device 2112, and the user device 2112 may be used to remotely control operation of the lift device 10 and the platform assembly 16. In some embodiments, an operator engages the initiate input 2118 to output the initiate signal to the controller 2102 that triggers the travel replay procedure 2116 to begin recording the steps in a positioning event, and engages the initiate input 2118 again to output a stop signal to the controller 2102 that triggers the controller 2102 to stop recording the steps in the positioning event (e.g., at a work site). In some embodiments, the controller 2102 stops recording the steps in a position event in response to the platform assembly 16 being stationary for a predefined amount of time (e.g., at a work site).

Once the controller 2102 records the steps in a positioning event, the execute replay input 2120 may be activated based on the current position of the platform assembly 16. That is, if the controller 2102 detects that a positioning event finished recording (e.g., either via the subsequent engagement of the initiate input 2118 or the platform assembly 16 being stationary for the predefined amount of time), the controller 2102 may inhibit the forward replay functionality of the execute replay input 2120 in the travel replay procedure 2116. That is, once a position event is recorded by the controller 2102, the controller 2102 only allows the reverse replay to occur in the travel replay procedure 2116. In other words, the execute replay input 2120 is only allowed to output an execute reverse replay signal to the controller 2102 after initially recording the steps in the positioning event, and is prevented from outputting an execute forward replay signal to the controller 2102.

During the reverse replay of the travel replay procedure 2116 (e.g., in response to receiving the execute reverse replay signal from the execute replay input 2120), the controller 2102 is configured to repeat each step in the recorded positioning event in a reverse order in which the events were recorded and with a movement direction and magnitude that is opposite to the direction in which the step was recorded. For example, with reference to the exemplary positioning event in FIG. 21, the platform assembly 16 may be moved at step 1 (e.g., via the actuators 34a, 34b, 34c, 34d, the extension actuator 35, or the electric motors 52) in a first direction. The amount that the platform assembly 16 moves during step 1 may be measured by one or more of the sensors (e.g., the length sensors 2122 and/or the rotary sensors 2124). The platform assembly 16 may then be rotated/pivoted (e.g., via the pivot motor 26, the platform rotator 30, or the turntable motor 44) in a first rotation/pivoting direction at step 2. The rotary/pivotal movement of the platform assembly 16 during step 2 may be measured by the rotary angle sensors 2124.

In an exemplary embodiment where steps 1 and 2 conclude the positioning event, the reverse replay of the travel replay procedure 2116 is configured to initially perform recorded step 2 with the platform assembly 16 rotating/pivoting an amount that is the same that was measured when step 2 was recorded and in a second rotation/pivoting direction opposite to the first rotation/pivoting direction. Then perform recorded step 1 with the platform assembly 16 moving in an amount that is the same that was measured when step 1 was recorded and in a second direction opposite to the first direction. In an exemplary embodiment where a positioning event includes steps 1-9 of FIG. 21, the reverse replay of the travel replay procedure 2116 would perform step 9 through step 1 in reverse order (e.g., recorded in 1 through 9 and replayed in reverse, 9 through 1). With the magnitude of the movements being the same as they were recorded and in an opposite direction to which they were recorded.

Once the travel replay procedure 2116 completes the reverse replay, the platform assembly 16 is returned, without operator input, to the initial position where the travel replay procedure 2116 was instructed to begin recording. The forward replay of the travel replay procedure 2116 may be enabled once the reverse replay of the travel replay procedure 2116 is completed. That is, the execute replay input 2120 is allowed to output the execute forward replay signal to the controller 2102, and prevented from outputting the execute reverse replay signal. The forward replay of the travel replay procedure 2116 is configured to perform the steps of the positioning event in the same order in which they were recorded. For example, if steps 1 and 2 represent a positioning event, steps 1 and 2 may be replayed in the same order and in the same movement direction that they were recorded, which moves the platform assembly 16 from the initial position to the work site without operator input.

If at any point during the travel replay procedure 2116 (e.g., either the forward replay or the reverse replay) the object detection sensors 2126 detect an object within a predefined range or distance of the base assembly 12, the lift arms 32a, 32b, 32c, 32d, and/or the platform assembly 16, the controller 2102 is configured to stop movement of the platform assembly 16 and overrides the travel replay procedure 2116. In some embodiments, the controller 2102 is configured to provide an indication on the user interface 20 or the user device 2112 upon detecting an object with one of the object detection sensors 2126, and an operator is required to address the indication prior to the travel replay procedure 2116 being activated or reenabled. In some embodiments, the controller 2102 may be configured to receive an initial or first indication that an object is detected by one or more of the object detection sensors 2126 and then take read a subsequent or second measurement, at a predetermined time interval after the first indication, from the same of the one or more object detection sensors 2126 to determine if the detected object is moving closer to (e.g., in the travel path) or further away from the corresponding object detection sensor(s) 2126. If the second measurement is less than the value at the first indication, then the controller 2102 may cease or override the travel replay procedure 2116 and stop movement of the lift device 10. In some embodiments, when the controller 2102 overrides the travel replay procedure 2116, the travel replay procedure 2116 becomes inactive and the memory 2108 is cleared of the previously-recorded steps in a positioning event. As such, the travel replay procedure 2116 is not reactivated until a new positioning event is recorded.

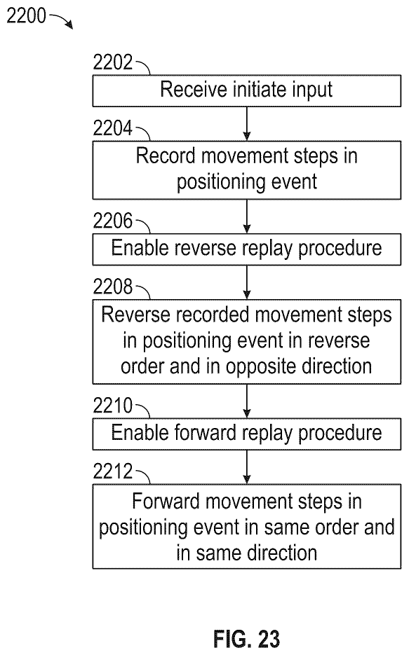

FIG. 23 shows a method 2200 for controlling a platform assembly (e.g., the platform assembly 16) of a lift device (e.g., the lift device 10) and performing the travel replay procedure. In some embodiments, the steps in the method 2200 are carried out by the controller 2102 or another controller in communication with the controller 2102 (e.g., the cloud platform 2114). The method 2200 begins at step 2202 by receiving an initiate input (e.g., the initiate input 2118). Once the initiate input is received at step 2202, a travel replay procedure (e.g., the travel replay procedure 2116) records each step during a positioning event at step 2204. In some embodiments, each step in a positioning event imparts movement on the platform assembly 16, and each movement (e.g., direction and magnitude) is recorded at step 2204. After each step is recorded at step 2204 (e.g., the platform assembly 16 has reached a work site), a reverse replay procedure of the travel replay procedure may be enabled at step 2206. In some embodiments, the reverse replay is not enabled if a weight (e.g., as measured by a weight sensor) on the platform assembly 16 has increased or decreased a predefine amount from a value that was measured at the end of the positioning event.

In response to the reverse replay procedure being enabled at step 2206, the recorded steps in the positioning event may be carried out in a reverse order and in an opposite direction in which they were recorded at step 2208. In other words, the platform assembly 16 is moved from the work site to an initial position by following the recorded steps in a reverse order and in an opposite movement direction.

For example, in the exemplary positioning event of FIG. 21, the controller 2102 may be instructed to record steps 1-9 in the positioning event 2004 and, in response to an instruction to carry out a reverse replay of the travel replay procedure 2116, the controller 2102 may provide instructions to one or more of the pivot motor 26, the platform rotator 30, the actuators 34a, 34b, 34c, 34d, the extension actuator 35, the turntable motor 44, and/or the electric motors 52 to automate the reverse of the positioning event 2004 to move the platform assembly back to the initial position 2006 by performing step 9 to step 1 (i.e., reverse order) with an opposite movement direction. For example, step 9 may be performed first in the reverse replay by rotating/pivoting the platform assembly 16 in a direction opposite to the rotation/pivoting direction that was recorded during the positioning event. Then step 8 may be performed with one or more of the actuators 34a, 34b, 34c, 34d lowering the lift platform 16 (e.g., in the downward direction 48, and then step 7 may be performed with the extension actuator 35 retracting the platform assembly 16, and so on until step 1 is performed in an opposite direction than it was recorded. This brings the platform assembly 16 from the work site to the initial position without the operator input.

With the reverse replay procedure completed at step 2208, the forward replay of the travel replay procedure may be enabled at step 2210. Once the forward replay is enabled at step 2210, the forward steps (i.e., the same steps that were recorded during the positioning event) may be performed to again move the platform assembly 16 from the initial position to the work site, without operator input.

### Hose and Cable Management System

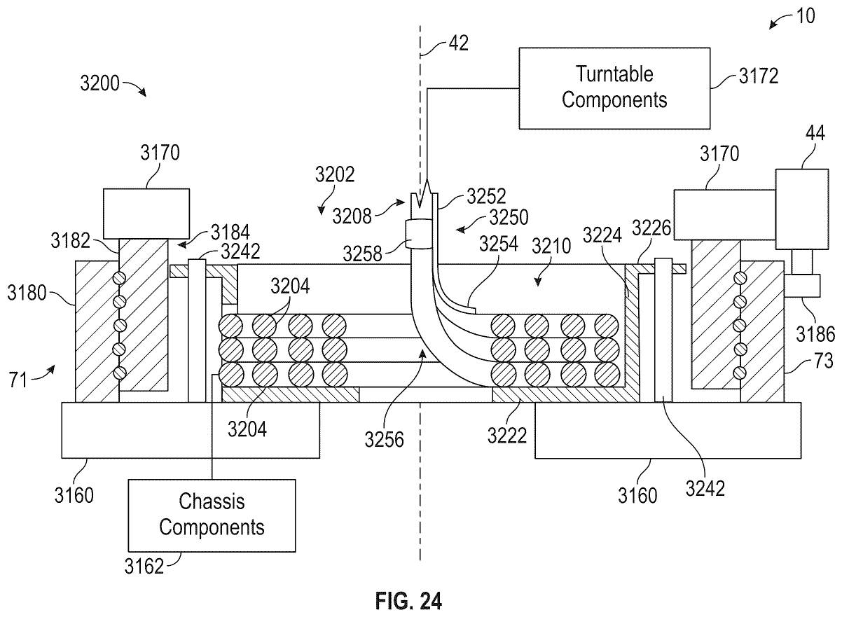

Referring to FIG. 24, a schematic section view of the lift device 10 is shown according to an exemplary embodiment. The lift device 10 includes one or more chassis components 3162 coupled to a base member or chassis 3160 of the lift device 10 and one or more turntable components 3172 coupled to a turntable 3170. The lift device 10 of FIG. 24 may represent the lift device of FIGS. 1-4, another lift device, or another type of vehicle (e.g., a fire truck, a military vehicle, a refuse vehicle, a concrete mixing truck, a crane, another type of vehicle where power transmission between two rotating components is desirable, etc.). The chassis 3160 may represent one or more components of the base assembly 12 (e.g., the frame member 54, the lateral frame members 110, etc.). The turntable 3170 may represent any part of the lift assembly 14 (e.g., the turntable 70, the turntable member 72, etc.).

The chassis components 3162 and the turntable components 3172 may include any components that perform functions within the lift device. The chassis components 3162 and the turntable components 3172 may include electrical components (e.g., batteries, motors, generators, controllers, shore power connectors, solar panels, power converters (e.g., inverters, rectifiers, transformers, DC-DC converters), etc.), hydraulic components (e.g., actuators, motors, pumps, valves, reservoirs, accumulators, etc.), and/or pneumatic components (e.g., actuators, motors, pumps, valves, reservoirs, accumulators, etc.). By way of example, the chassis components 3162 may include the user interface 21, the controller 38, the prime mover 41, the electric motors 52, the axle actuators 56, the steering system 150, and/or other components. The turntable components 3172 may include the user interface 20, the hydraulic motor 26, the actuators 34, the extension actuator 35, the turntable motor 44, and/or other components.

Referring still to FIG. 24, the slewing bearing 71 rotatably couples the chassis 3160 to the turntable 3170, such that the turntable 3170 is rotatable relative to the chassis 3160 about the central axis 42. Accordingly, the slewing bearing 71 may be centered about the central axis 42. The slewing bearing 71 includes a first portion or fixed portion, shown as outer race 3180, that is fixedly coupled to the chassis 3160. The slewing bearing 71 further includes a second portion or rotatable portion, shown as inner race 3182, that is fixedly coupled to the turntable 3170. The inner race 3182 is received within the outer race 3180 and rotatably coupled to the outer race 3180 (e.g., by a series of bearing elements, such as ball bearings or rollers, etc.). The inner race 3182 has an inner surface that defines a substantially cylindrical inner volume, shown as bearing volume 3184.

The outer race 3180 defines a geared outer surface 73 (i.e., a surface including a series of gear teeth). A body of the turntable motor 44 is fixedly coupled to the turntable 3170. An output shaft of the turntable motor 44 is coupled to a pinion gear 3186 that engages the geared outer surface 73 of the outer race 3180. Accordingly, when the turntable motor 44 is operated, the pinion gear 3186 rotates to drive rotation of the inner race 3182 and the turntable 3170 relative to the outer race 3180 and the chassis 3160. In other embodiments, the body of the turntable motor 44 is fixedly coupled to the chassis 3160.

Referring to FIGS. 24-26, the lift device 10 includes a hose and cable management system, rotatable connection, rotatable coupler assembly, or flexible member coiling system, shown as coil management system 3200. The coil management system 3200 includes a flexible member assembly 3202 that includes one or more flexible members (e.g., conduits, hoses, wires, cables, etc.), shown as flexible members 3204, that are fixedly coupled (e.g., bonded) to one another. The flexible members 3204 generally extend parallel to one another (e.g., a section of one flexible member 3204 is parallel to an adjacent section of another flexible member 3204).

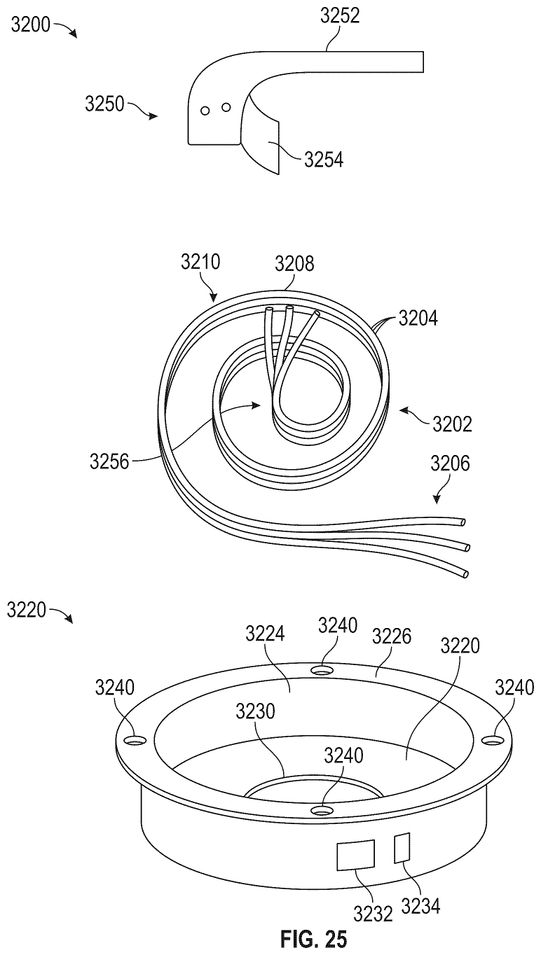

In FIGS. 24 and 25, the flexible member assembly 3202 is shown to include three flexible members 3204. In other embodiments, the flexible member assembly 3202 includes more or fewer flexible members 3204 (e.g., one, two, four, ten, etc.). The number of flexible members 3204 may depend on the number of functions or components that are connected by the flexible member assembly 3202 (e.g., a greater number of connected components may utilize a greater number of flexible members 3204).

The flexible member assembly 3202 may include one or more different types of flexible members 3204 based on the desired type of transfer between the chassis components 3162 and the turntable components 3172. By way of example, the flexible member assembly 3202 may include one or more hoses or fluid conduits to transfer a liquid such as hydraulic oil (e.g., as part of a hydraulic system) or water or a compressed gas (e.g., as part of a pneumatic system). By way of another example, the flexible member assembly 3202 may include one or more wires or cables to transfer electrical energy. By way of another example, the flexible member assembly 3202 may include one or more wires, cables, or optical fibers to transfer data. The flexible member assembly 3202 may include a single type of flexible member 3204 or a combination of one or more different types of flexible members 3204 (e.g., hoses, wires, and optical fibers, etc.).

A first end portion, shown as base end 3206, of the flexible member assembly 3202 is fixedly coupled to the base assembly 12. An opposing second end portion, shown as turntable end 3208, of the flexible member assembly 3202 is fixedly coupled to the turntable 3170. A middle portion or coiled portion, shown as wound portion 3210, is formed from a middle section of the flexible member assembly 3202. The wound portion 3210 is located between the base end 3206 and the turntable end 3208. The wound portion 3210 of the flexible member assembly 3202 is coiled or wound around the central axis 42 into a spiral or clockspring shape that gradually decreases in diameter from the base end 3206 to the turntable end 3208. The wound portion 3210 may form one or more complete wraps, each wrap representing 3360 degrees of rotation around the central axis 42. Increasing the number of wraps may increase the length of the flexible member assembly 3202.

As shown in FIG. 24, the portion of each flexible member 3204 that forms the wound portion 3210 generally occupies a different horizontal plane. The flexible members 3204 are vertically offset from one another, such that the flexible members stack atop of one another. Each flexible member 3204 may be fixedly coupled (e.g., adhered, bonded, etc.) to the adjacent flexible members 3204 to form the flexible member assembly 3202. Because the flexible members 3204 occupy different planes, additional flexible members 3204 can be stacked without interfering with the coiling of one another. Advantageously, the number of flexible members 3204 can be scaled in this way to suit the desired application of the coil management system 3200 (e.g., for a particular vehicle).

The flexible member assembly 3202 is supported by a hose and cable tray or hose management tray, shown as tray 3220. The tray 3220 includes a bottom wall, shown as support wall 3222, a cylindrical wall or upright wall, shown as sidewall 3224, and a top portion or flange, shown as mounting flange 3226. In some embodiments, the support wall 3222, the sidewall 3224, and the mounting flange 3226 are fixedly coupled to one another and formed as a single continuous piece.

The support wall 3222 generally extends within a horizontal plane below the flexible member assembly 3202, such that the flexible member assembly 3202 rests atop the support wall 3222. Accordingly, the support wall 3222 limits downward movement of the flexible member assembly 3202. In some embodiments, the support wall 3222 and/or the flexible member assembly 3202 are configured (e.g., coated in a lubricant) to facilitate relative sliding motion between the support wall 3222 and the flexible member assembly 3202. The support wall 3222 is circular and substantially centered about the central axis 42. In some embodiments, the support wall 3222 defines a central aperture 3230 that facilitates access through the tray 3220 (e.g., for maintenance, to provide clearance for components, etc.).

The sidewall 3224 extends upward from an outer circumference of the support wall 3222. The sidewall 3224 is generally annular and cylindrical. In some embodiments, the sidewall 3224 is substantially centered about the central axis 42. The sidewall 3224 limits outward radial movement of the flexible member assembly 3202. Accordingly, the wound portion 3210 of the flexible member assembly 3202 is contained within a volume at least partially defined by the sidewall 3224 and the support wall 3222.

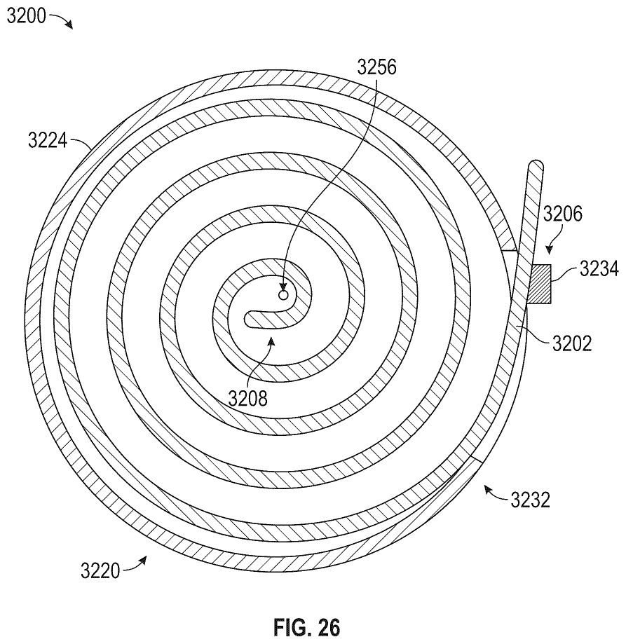

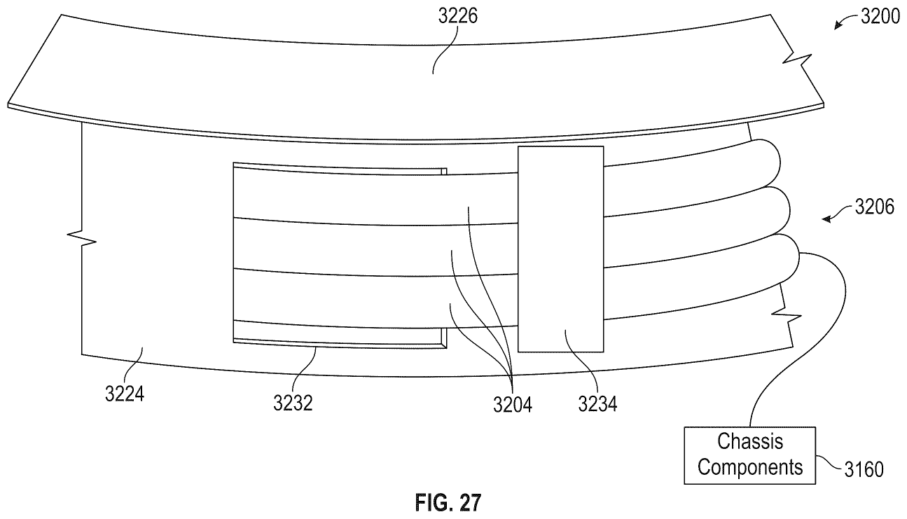

As shown in FIGS. 26 and 27, the sidewall 3224 defines a passthrough aperture, shown as sidewall aperture 3232. The sidewall aperture 3232 extends radially through the sidewall 3224. The base end 3206 of the flexible member assembly 3202 passes through the sidewall aperture 3232, permitting the base end 3206 to exit the tray 3220. A mount, shown as clamp 3234, is coupled to the sidewall 3224. As the base end 3206 passes out of the sidewall aperture 3232, the base end 3206 extends generally tangent to an outer surface of the sidewall 3224. The base end 3206 of the flexible member assembly 3202 is received between the clamp 3234 and the sidewall 3224, and the clamp 3234 is tightened to fixedly couple the base end 3206 to an outer surface of the sidewall 3224. Accordingly, the tray 3220 fixes the base end 3206 in place.

Referring to FIGS. 24 and 25, the mounting flange 3226 generally extends in a horizontal plane above the support wall 3222 and extends radially outward from the sidewall 3224. The mounting flange 3226 defines a series of apertures, shown as mounting holes 3240, extending vertically through the mounting flange 3226. A series of fasteners, shown as standoffs 3242, extend through the mounting holes 3240 and fixedly couple the mounting flange 3226 to the chassis 3160.

Accordingly, the tray 3220 fixedly couples the base end 3206 of the flexible member assembly 3202 to the chassis components 3162. With the base end 3206 fixed in place, the flexible members 3204 may be coupled to the chassis components 3162. Due to the position of the clamp 3234, the wound portion 3210 and the turntable end 3208 can move freely relative to the tray 3220 without the movement disturbing (e.g., applying stresses to) the connection between the base end 3206 and the chassis components 3162.

The coil management system 3200 further includes a turntable mounting bracket or hose management arm, shown as coil management arm 3250, that guides the turntable end 3208 of the flexible member assembly 3202. The coil management arm is 3250 is fixedly coupled to the turntable 3170, such that the coil management arm 3250 rotates relative to the tray 3220 and the chassis 3160. The coil management arm 3250 extends radially inward from the turntable 3170 toward the central axis 42 to engage the turntable end 3208. The coil management arm 3250 holds the turntable end 3208 vertically along the central axis 42, such that the tray 3220 and the wound portion 3210 rotate about the turntable end 3208.

The coil management arm 3250 includes a first portion, shown as flat portion 3252, and a second portion, shown curved portion 3254. The turntable end 3208 of the flexible member assembly 3202 extends along one or more surfaces of the flat portion 3252 and the curved portion 3254, such that the coil management arm 3250 helps to shape the flexible member assembly 3202. The flexible member assembly 3202 has an upward bend 3256, at which the flexible members 3204 transition from extending within a horizontal plane to extending vertically. The upward bend 3256 engages the curved portion 3254, and the shape of the curved portion 3254 forms the upward bend 3256. After completing the upward bend 3256, the flexible member assembly 3202 extends vertically along the flat portion 3252.

In some embodiments, the flexible member assembly 3202 includes a thermally-sensitive material, such as a thermoplastic, that can be temporarily made more flexible by applying thermal energy to the material. In such an embodiment, the shape of the upward bend 3256 may be formed by applying thermal energy to the flexible member assembly 3202 and placing the flexible member assembly 3202 in a fixture corresponding to the predetermined, desired shape of the upward bend 3256. After the flexible member assembly 3202 is allowed to cool, the flexible member assembly 3202 may be removed from the fixture and coupled to the coil management arm 3250. In this way, both the coil management arm 3250 and the heat forming of the thermoplastic help to retain the desired shape of the upward bend 3256.

The coil management arm 3250 further includes a mount, shown as clamp 3258, that is coupled to the flat portion 3252. As the turntable end 3208 extends above the upward bend 3256, the turntable end 3208 extends generally vertically along the flat portion 3252. The turntable end 3208 of the flexible member assembly 3202 is received between the clamp 3258 and the flat portion 3252, and the clamp 3258 is tightened to fixedly couple the turntable end 3208 to the coil management arm 3250. Accordingly, the coil management arm 3250 fixes the turntable end 3208 in place. With the turntable end 3208 fixed in place, the flexible members 3204 may be coupled to the turntable components 3172. Due to the position of the clamp 3258, the wound portion 3210 and the base end 3206 can move freely relative to the coil management arm 3250 without the movement disturbing (e.g., applying stresses to) the connection between the turntable end 3208 and the turntable components 3172.

During operation, the turntable 3170 rotates relative to the chassis 3160 (e.g., under power of the turntable motor 44). This relative rotation causes the base end 3206 to move relative to the turntable end 3208 in a circular path centered about the central axis 42. Because the base end 3206 and the turntable end 3208 are fixed, this motion causes the wound portion 3210 to twist. As the wound portion 3210 twists, the wraps of the wound portion 3210 tighten or loosen based on the direction of rotation of the turntable 3170. By way of example, in the arrangement shown in FIG. 26, rotating the turntable 3170 clockwise causes the wound portion 3210 to tighten (i.e., the wraps within the wound portion 3210 move closer together), and rotating the turntable 3170 counterclockwise causes the wound portion 3210 to loosen (i.e., the wraps within the wound portion 3210 move farther apart).

The coil management system 3200 provides various advantages over other systems for connecting turntable and chassis components. By way of example, the coil management system 3200 may provide a larger range of motion for the turntable 3170 than other systems. By way of another example, the coil management system 3200 may reduce component wear.

Due to the spiral arrangement of the wound portion 3210, this twisting movement causes the flexible members 3204 to bend around the central axis 42. Advantageously, this bending is experienced by the entirety of the wound portion 3210 simultaneously, spreading the strain imparted on the flexible members 3204 along the entire length of the flexible member assembly 3202 and minimizing the stress experienced by the flexible members 3204. Because of this, the turntable 3170 can rotate through a large range of motion (e.g., 360 degrees, 720 degrees, 1080 degrees, etc.) before the stresses experienced by the flexible member assembly 3202 cause damage to the flexible members 3204.

Each of the flexible members 3204 may have a minimum allowable bend radius to prevent damage. By way of example, a hose may have a minimum allowable bend radius that is required to prevent the hose kinking and limiting flow. By way of another example, a cable may have a minimum allowable bend radius required to prevent breaking of wires within the cable. This spiral arrangement of the wound portion 3210 causes the entire wound portion 3210 to bend simultaneously, maximizing the bend radius of each flexible member 3204 and thereby maximizing the range of motion before the minimum bend radius is experienced.

In some embodiments, the flexible members 3204 are bonded to one another, limiting (e.g., preventing) relative movement of the flexible members 3204 in a given cross section of the flexible member assembly 3202. By bonding the flexible members 3204 together, the flexible members 3204 are held in the stacked coil arrangement shown in FIG. 24. Without the bonding, the flexible members 3204 could move relative to one another and interfere with the spiral coiling action of the wound portion 3210. Additionally, the stacked arrangement of the flexible members 3204 ensures that only the bottommost flexible member 3204 contacts the support wall 3222, preventing frictional wear on the other flexible members 3204.

Because the flexible member assembly 3202 is contained within the tray 3220, the flexible members 3204 are protected from contacting sharp edges or other abrasive materials that would cause wear on the flexible members 3204. Instead, the flexible member assembly 3202 slides across the flat surface of the support wall 3222. Accordingly, the arrangement of the tray 3220 limits wear on the coil management system 3200 and improves system longevity.

Some lift devices form a connection between a turntable component and a chassis component by directly connecting a flexible member (e.g., a hose or cable) between a chassis and a turntable without the coiled arrangement of the coil management system 3200. In such a configuration, relative rotation between the base and the turntable twists the flexible member along its length instead of bending the flexible member. This twisting configuration may impart larger stresses on the flexible member than the coiled arrangement of the coil management system 3200. Accordingly, the coil management system 3200 may improve the durability and the range of motion of a turntable system.

In other lift devices, slip rings, rotary unions, rotary joints, or other rotational connectors are used to permit relative rotation of two or more wires or hoses. These rotational connectors permit unlimited rotation of the turntable relative to the base. However, such rotational connectors can be expensive, difficult to install, and prone to failure. In contrast, the coil management system 3200 utilizes hoses and/or cables, which is more cost-effective and robust than a rotational connector arrangement.

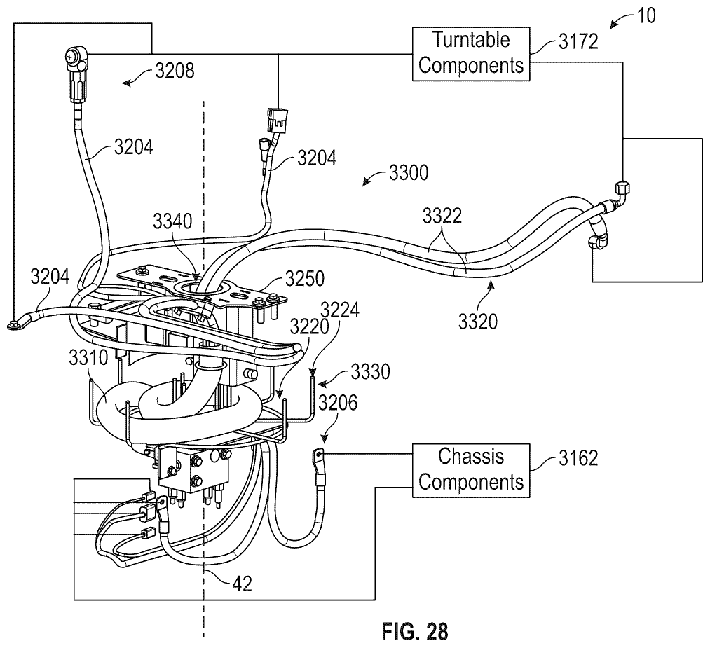

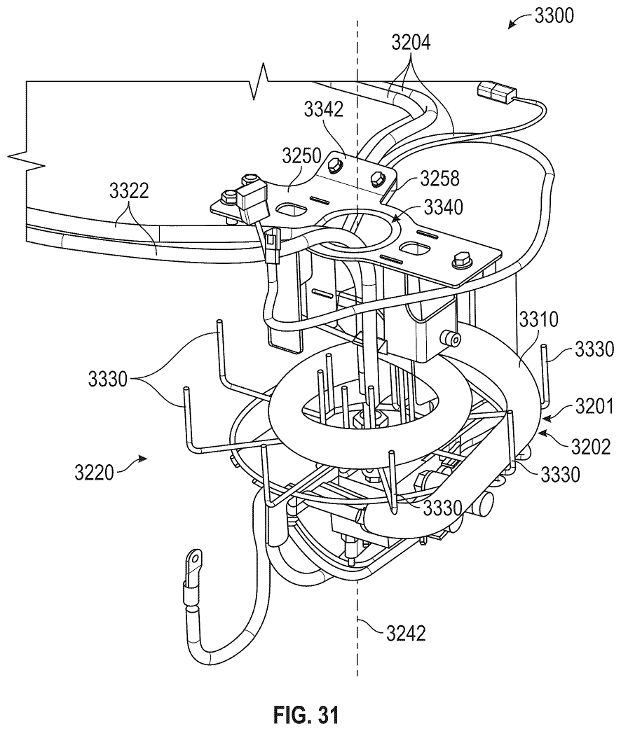

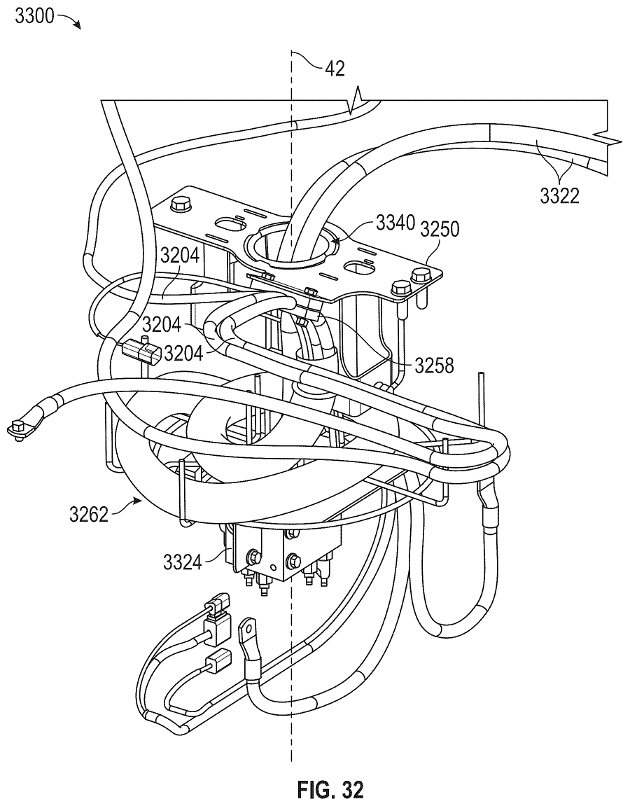

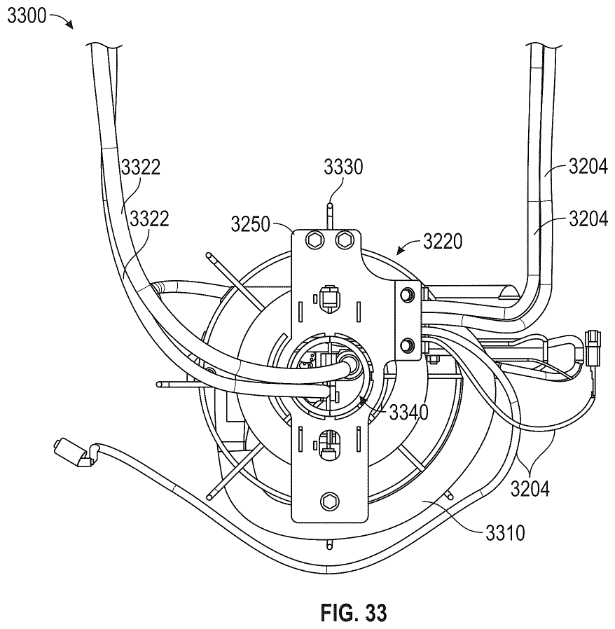

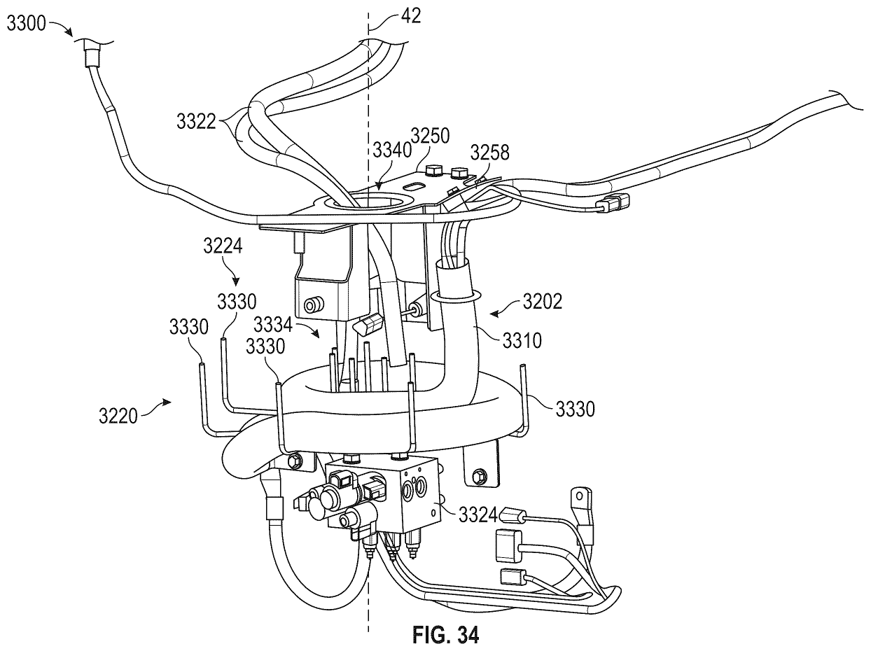

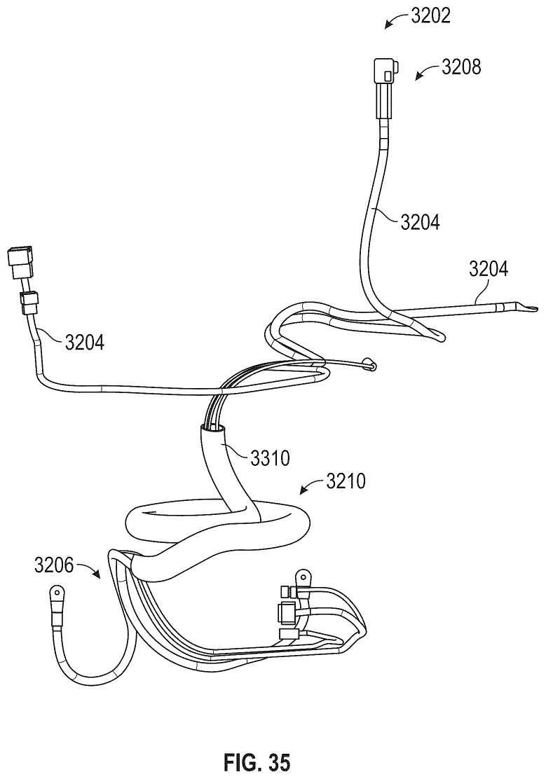

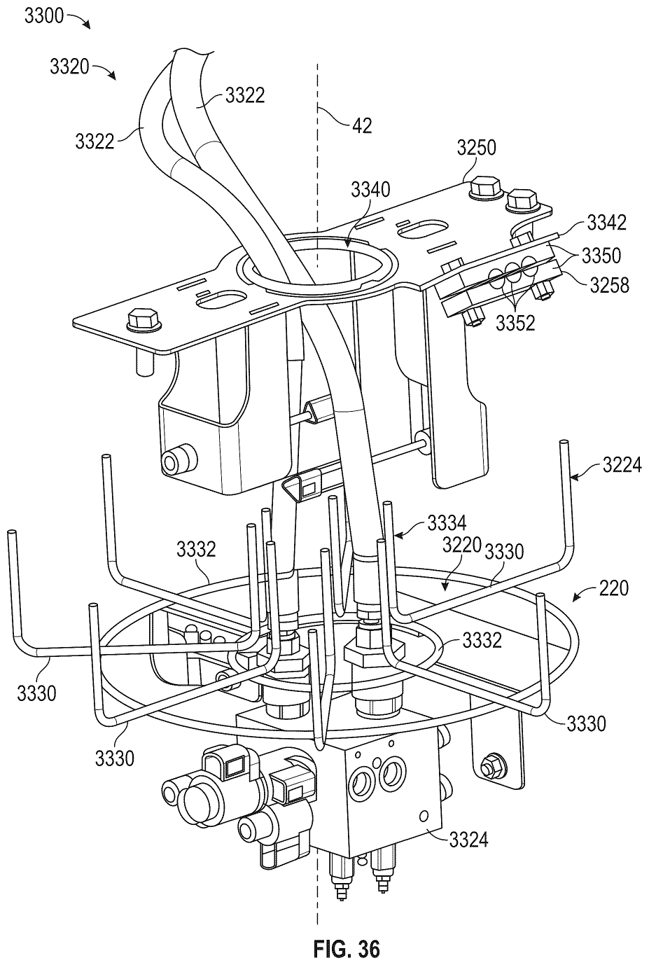

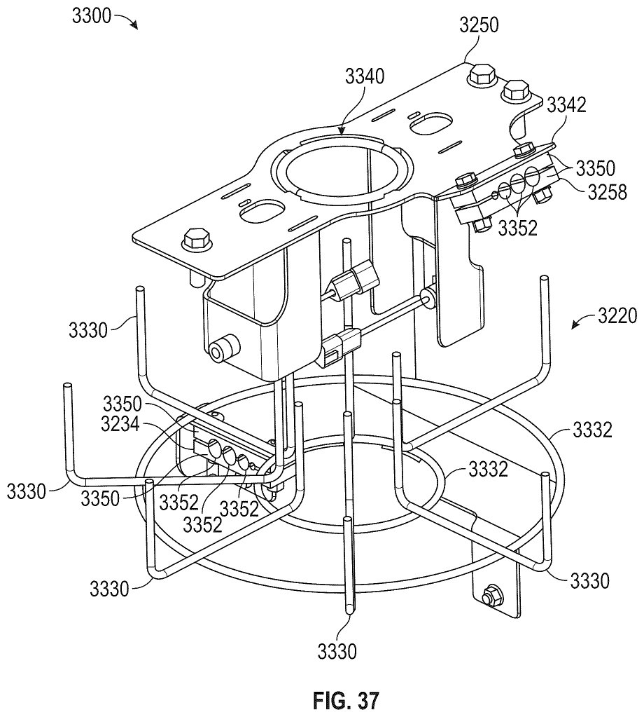

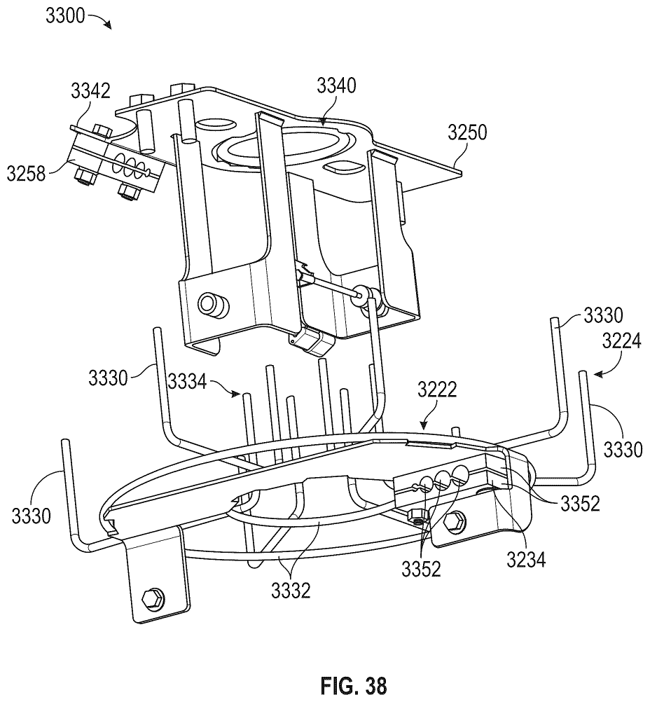

Referring to FIGS. 28-38, a hose and cable management system, rotatable connection, rotatable coupler assembly, or flexible member coiling system is shown as coil management system 3300 according to an exemplary embodiment. The coil management system 3300 is an alternative configuration of the coil management system 3200. Accordingly, the coil management system 3300 may be substantially similar to the coil management system 3200 except as otherwise specified herein.

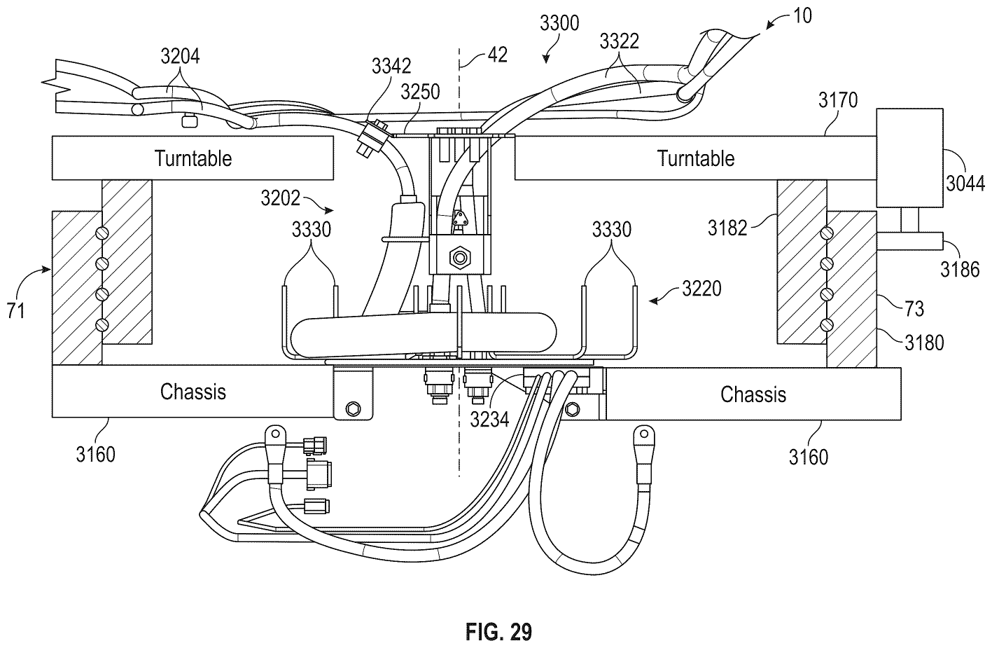

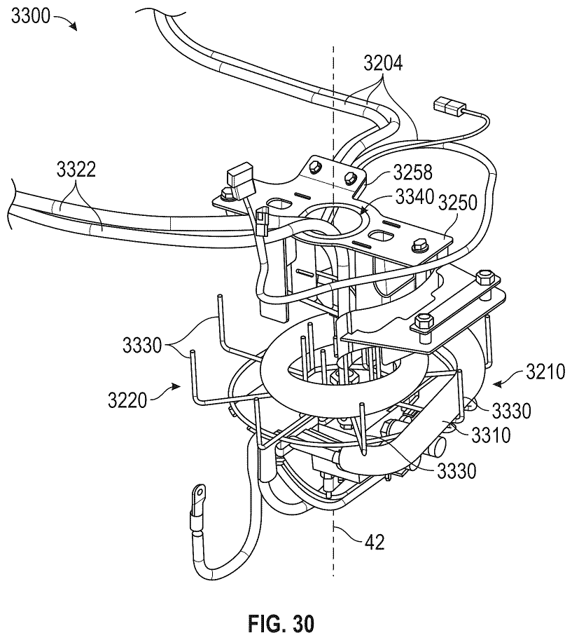

FIGS. 28 and 29 illustrate the coil management system 3300 installed within the lift device 10. Specifically, FIG. 28 illustrates the coil management system 3300 operatively coupling the chassis components 3162 and the turntable components 3172 of the lift device 10. FIG. 29 illustrates the coil management system 3300 coupled to the chassis 3160 and the turntable 3170 of the lift device 10 and extending within the slewing bearing 71 of the lift device 10. FIGS. 30-38 illustrate the coil management system 3300 separate from the lift device 10.

Referring to FIGS. 28-35, the coil management system 3300 includes a flexible member assembly 3202, which may be substantially similar to the flexible member assembly 3202 of the coil management system 3200 except as otherwise specified herein. The flexible member assembly 3202 includes a series of flexible members 3204. As shown, the flexible members 3204 are each configured as cables that transfer electrical energy and/or signals (e.g., data) between the chassis components 3162 and the turntable components 3172. In other embodiments, the flexible members 3204 include one or more hoses. By way of example, the flexible members 3204 may include only hoses, or the flexible members 3204 may include a mixture of hoses and cables. As shown, the wound portion 3210 of the flexible member assembly 3202 forms one complete wrap around the central axis 42.

The flexible member assembly 3202 further includes a guard, shield, protector, or wear portion, shown as sleeve 3310. The sleeve 3310 is a tubular member that receives the flexible members 3204 therethrough. Specifically, the sleeve 3310 has a first end portion and a second end portion each defining a corresponding aperture. The flexible members 3204 enter the sleeve 3310 through the aperture of the first end portion and exit the sleeve 3310 through the aperture of the second end portion. Accordingly, the sleeve 3310 extends along and covers the wound portion 3210 of the flexible member assembly 3202.

The sleeve 3310 surrounds the flexible members 3204, providing a barrier to protect the flexible members 3204 from wear that might otherwise occur from friction during repeated movement (e.g., winding and winding of the flexible member assembly 3202) or potential punctures from contact with debris. The sleeve 3310 also bundles the flexible members 3204, applying an inward radial force to compress the flexible members 3204 together. In some embodiments, the sleeve 3310 fixedly couples the flexible members 3204 to one another. To facilitate bending of the flexible members 3204, the sleeve 3310 may be constructed from a flexible material (e.g., rubber, plastic, a woven material such as fabric, etc.).

Referring to FIGS. 28-34 and 36, the coil management system 3300 further includes a secondary flexible member assembly, shown as flexible member assembly 3320. The flexible member assembly 3320 includes a series of flexible members 3322 (e.g., hoses, cables, etc.). As shown, the flexible members 3322 are each configured as hoses that transfer fluid between the chassis components 3162 and the turntable components 3172. The flexible members 3322 are fluidly coupled to a flow control component, manifold, or valve element, shown as valve block 3324, that is fixedly coupled to the chassis 3160. In other embodiments, the flexible members 3322 include one or more cables.

The flexible members 3322 extend upward from the valve block 3324 along the central axis 42. The wound portion 3210 of the flexible member assembly 3202 is wound around the flexible members 3322, such that the flexible members 3322 extend through an aperture formed by winding the flexible members 3204. In some embodiments, the flexible members 3322 and the flexible members 3204 are separately coupled to the turntable 3170, such that rotation of the turntable 3170 causes the flexible members 3204 to move relative to the flexible members 3322 (e.g., winding or winding the flexible members 3204 around the flexible members 3322). In some such embodiments, the flexible members 3322 remain stationary relative to the chassis 3160 when the turntable 3170 rotates.

Referring to FIGS. 28-34 and 36-38, the coil management system 3300 includes a hose and cable tray or hose management tray, shown as tray 3220, which may be substantially similar to the tray 3220 of the coil management system 3200 except as otherwise specified herein. The tray 3220 is fixedly coupled to the chassis 3160. The tray 3220 is formed from a series of spokes, tines, ribs, members, or bars, shown as upright bars 3330 and annular bars 3332. The annular bars 3332 extend within a substantially horizontal plane and are substantially concentric with one another (e.g., centered about the central axis 42). The upright bars 3330 are fixedly coupled (e.g., welded) to the annular bars 3332 and extend upward from the annular bars 3332. Each upright bar 3330 is u-shaped and includes a horizontal portion and a pair of vertical portions extending upward from the horizontal portion.

The upright bars 3330 form a bottom wall, shown as support wall 3222, an outer cylindrical wall or upright wall, shown as sidewall 3224, and an inner cylindrical wall or upright wall, shown as sidewall 3334. Specifically, the horizontal portions of the upright bars 3330 extend generally within a horizontal plane below the flexible member assembly 3202 to form the support wall 3222. The first vertical portions of the upright bars 3330 are spaced a first distance from the central axis 42 to form the sidewall 3224. The second vertical portions of the upright bars 3330 are spaced a second distance from the central axis 42 to form the sidewall 3334. The second distance is less than the first distance, such that the sidewall 3334 is the closest wall to the central axis 42. By forming the tray 3220 using a series of bars, a series of apertures are formed between the bars (e.g., between the upright bars 3330 and the annular bars 3332, between adjacent upright bars 3330, etc.). The upright bars 3330 of the tray 3220 support and contain the flexible member assembly 3202, while the apertures between the bars permit debris (e.g., plant matter, construction debris, rocks, etc.) to exit the tray 3220 instead of being captured within the tray 3220.

During operation, the flexible member assembly 3202 rests atop the support wall 3222, and the support wall 3222 limits downward movement of the flexible member assembly 3202. The flexible member assembly 3202 may be held in place against the support wall 3222 by the force of gravity acting on the flexible member assembly 3202. The sidewall 3224 limits outward radial movement of the flexible member assembly 3202. The sidewall 3334 limits inward radial movement of the flexible member assembly 3202. Accordingly, the wound portion 3210 of the flexible member assembly 3202 is contained within a volume at least partially defined by the sidewall 3224, the sidewall 3334, and the support wall 3222. If the wound portion 3210 increases or decreases in diameter as the turntable 3170 rotates, the sidewall 3224 and the sidewall 3334 prevent the wound portion 3210 from falling off of the support wall 3222.

As shown in FIGS. 30-38, the base end 3206 of the flexible member assembly 3202 exits the tray 3220 through the sidewall 3224 by passing between a pair of the upright bars 3330 that are adjacent to one another. A clamp 3234 is positioned along an underside of the tray 3220 and fixedly coupled to the tray 3220 such that the clamp 3234 is oriented substantially horizontally. The clamp 3234 is radially offset from the central axis 42 to facilitate the clamp 3234 aligning with the base end 3206 immediately after the base end 3206 separates from the wound portion 3210. A portion of the base end 3206 that passes between the upright bars 3330 is covered by the sleeve 3310 (e.g., to protect the flexible members 3204 from wearing as the flexible member assembly 3202 rubs against the tray 3220). The base end 3206 then exits the sleeve 3310, and the individual flexible members 3204 pass beneath the support wall 3222 of the tray 3220 and are received within the clamp 3234. The clamp 3234 is tightened to fixedly couple the base end 3206 to the tray 3220 and the chassis 3160.

The coil management system 3300 further includes a turntable mounting bracket or hose management arm, shown as coil management arm 3250, which may be substantially similar to the coil management arm 3250 of the coil management system 3200 except as otherwise specified herein. The coil management arm 3250 guides the turntable end 3208 of the flexible member assembly 3202. The coil management arm is 3250 is fixedly coupled to the turntable 3170, such that the coil management arm 3250 rotates relative to the tray 3220 and the chassis 3160. The coil management arm 3250 is substantially centered about the central axis 42.

The coil management arm 3250 includes a first portion, shown as flat portion 3252, that defines a passage shown as passthrough aperture 3340, and a second portion (e.g., a tab, plate, or protrusion), shown as clamp plate 3342. The flat portion 3252 extends substantially horizontally. The clamp plate 3342 extends upward and outward (i.e., is inclined) relative to the flat portion 3252. In some embodiments, the flat portion 3252 and the clamp plate 3342 are integrally formed as a single, continuous piece (e.g., from a piece of bent sheet metal).

As shown in FIGS. 36-38, the passthrough aperture 3340 extends vertically through the flat portion 3252 and is substantially centered about the central axis 42. The passthrough aperture 3340 is surrounded by a bearing member, shown as ring 3344. The flexible members 3322 extend through the passthrough aperture 3340, permitting the flexible members 3322 to reach the turntable 3170. In embodiments where the turntable 3170 rotates relative to the flexible members 3322, the ring 3344 may provide a smooth surface for the flexible members 3322 to rest against, avoiding wear caused by the relative motion of the coil management arm 3250 and the flexible members 3322.

The coil management system 3300 further includes a mount, shown as clamp 3258, that is coupled to an underside of the clamp plate 3342. The turntable end 3208 of the flexible member assembly 3202 is received by the clamp 3258, and the clamp 3258 is tightened to fixedly couple the turntable end 3208 to the coil management arm 3250. Accordingly, the coil management arm 3250 fixes the turntable end 3208 to the turntable 3170. With the turntable end 3208 fixed in place, the flexible members 3204 may be coupled to the turntable components 3172. The clamp 3258 is radially offset from the central axis 42 to facilitate the clamp 3258 aligning with the turntable end 3208 immediately after the turntable end 3208 separates from the wound portion 3210. As shown in FIGS. 29-34, the inclined orientation of the clamp plate 3342 causes the flexible members 3204 to be directed upward and laterally outward from the coil management arm 3250.

The clamp 3234 and clamp 3258 of the coil management system 3300 each include a pair of clamping bodies or plates, shown as clamp bodies 3350, that are selectively forced toward one another by a pair of fasteners. Each of the clamp bodies 3350 defines series of hemicylindrical recesses, and the recesses of both clamp bodies 3350 align with one another to form a series of flexible member passages 3352. Each of the flexible member passages 3352 receives one of the flexible members 3204, and the fasteners may be tightened to fixedly couple the flexible members 3204 to the clamp bodies 3350 and hold the flexible members 3204 in place.

During operation, the turntable 3170 rotates relative to the chassis 3160 (e.g., under power of the turntable motor 44). This relative rotation causes the base end 3206 to move relative to the turntable end 3208 in a circular path centered about the central axis 42. Because the base end 3206 and the turntable end 3208 are fixed, this motion causes the wound portion 3210 to twist and tighten or loosen based on the direction of rotation of the turntable 3170. In some embodiments, the coil management system 3300 permits at least 3360 degrees of rotation of the turntable 3170. In some such embodiments, the coil management system 3300 permits at least 3400 degrees of rotation of the turntable 3170.

### Follow Surface System

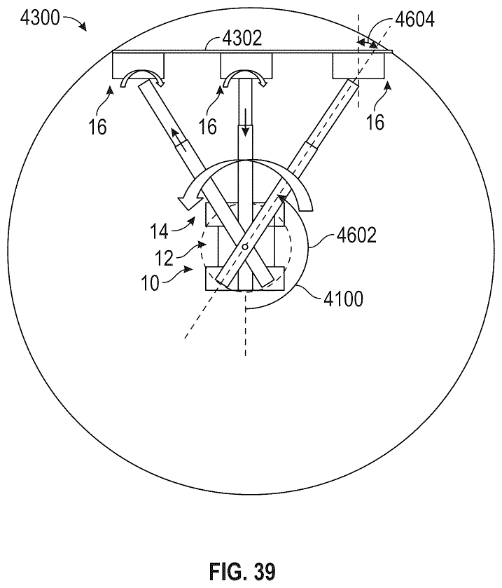

Referring to FIGS. 39-46, the lift device 10 can include a detection and control system 4100 that is configured to facilitate maintaining a desired or required distance between the platform assembly 16 and a wall surface (e.g., a flat wall surface, a concave wall surface, a convex wall surface, etc.). In some embodiments, the detection and control system 4100 is configured to operate various controllable elements of the lift assembly 14, the base assembly 12, and the platform assembly 16 based on a user input (e.g., to raise or lower the platform assembly 16) while maintaining a desired or required distance between the platform assembly 16 and the wall surface, and while maintaining a desired or threshold orientation of the platform assembly 16. Some systems require the operator to manually control an angle 4602 of the turntable 70, manually control the actuators 34 to adjust angle 75a, angle 75b, and angle 75c, and manually control the extension actuator 35 to increase or decrease a distance 4610 of the upper lift arm 32c and the intermediate lift arm 32d. The detection and control system 4100 can be configured to automatically determine controls for the turntable 70, the actuators 34, the extension actuator 35, and/or the motor 26 such that the platform assembly 16 is constrained to move in a plane or moves to maintain a certain distance from a wall surface. In this way, the operator may provide control inputs such as up, down, left right, closer or further to the wall, and the control system 4100 automatically operates the lift device 10 to appropriately control the turntable 70, the actuators 34, and the motor 26.

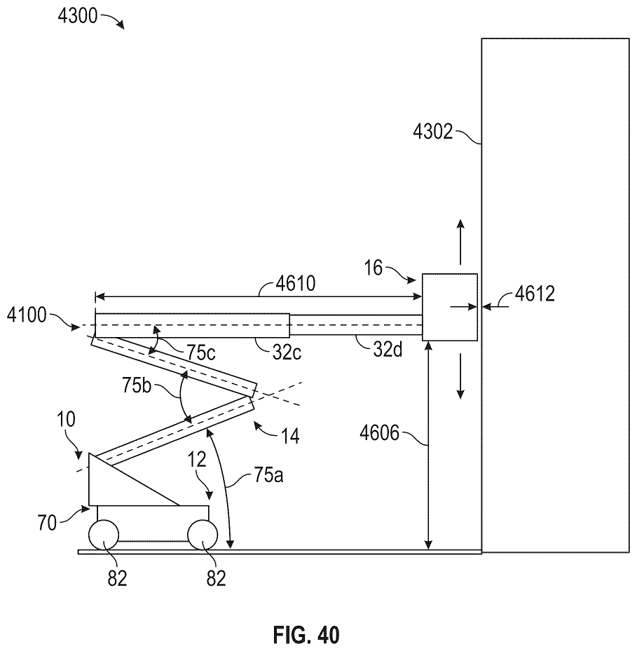

Referring to FIGS. 39 and 40, a diagram 4300 illustrates the lift device 10 servicing a flat surface 4302 (e.g., a flat wall, a flat surface, a side of a building, etc.) is shown. In some embodiments, the lift assembly 14 is configured to raise or lower the platform assembly 16 so that the platform assembly 16 is a distance 4606 above a ground surface in order to reach an elevated location (e.g., so that an operator that is standing on the platform assembly 16 can service a portion of the wall 4302). The detection and control system 4100 can be transitioned into either a fixed plane mode such that the control system 4100 automatically controls the turntable 70 and the lift assembly 14 responsive to control requests from the user (e.g., request to move up the wall, request to move down the wall, request to move to the left or the right on the wall, request to move closer or farther away from the wall, etc.) or into a distance-mode so that the control system 4100 automatically controls the turntable 70 and the lift assembly 14 to maintain a specific distance 4612 between the platform assembly 16 and the wall 4302. In this way, the control system 4100 can receive control requests from the user to adjust positioning of the platform assembly 16 relative to the wall surface 4302 (e.g., upwards, downwards, left, right, closer, further away, etc.) and can determine appropriate control for the turntable 70 and the lift assembly 14 (e.g., actuators and/or motors thereof) in order to achieve the requested adjustment in position of the platform assembly 16 relative to the wall surface 4302. In some embodiments, the control system 4100 is also configured to determine controls for the tractive elements 82 in order to achieve the control request (e.g., transport closer to the wall 4302 or further away from the wall 4302 as necessary to achieve the control request). The fixed plane mode can be useful for flat walls such as for painting work, window cleaning work, masonry, etc.

In some embodiments, FIGS. 39 and 40 illustrate control and operation of the lift device 10 when operating according to a fixed plane mode of operation. For example, the operator may control or operate the lift device 10 until achieving a desired distance between the wall 4302 and the platform assembly 16 (e.g., by operating the actuators 34, the rotator 30, the motor 26, the motors 52, the turntable motor 44, the extension actuator 35, etc.), then transitioning the lift device 10 into the fixed plane mode of operation. In some embodiments, in the fixed plane mode of operation, the operator can provide user inputs or control requests to move the platform assembly 16 relative to the wall 4302 (e.g., along a fixed plane). In this way, the operator can provide relative inputs (e.g., move up, move down, move left, move right, etc. relative to the wall 4302, increase distance 4606, decrease distance 4606, etc.) instead of absolute inputs (e.g., extend the extension actuator 35, retract the actuator 34a, etc.). The fixed plane mode of operation provides an intuitive control of the lift device 10. In some embodiments, the lift device 10 uses sensor feedback from the platform assembly 16 indicating the distance 4612 in order to control operation of the turntable 70, the lift assembly 14, etc.

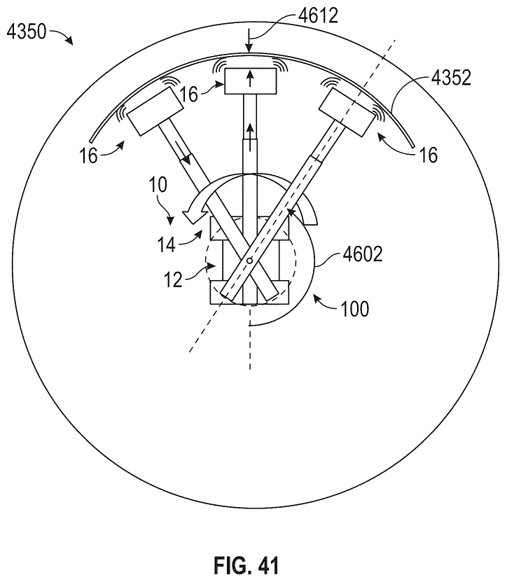

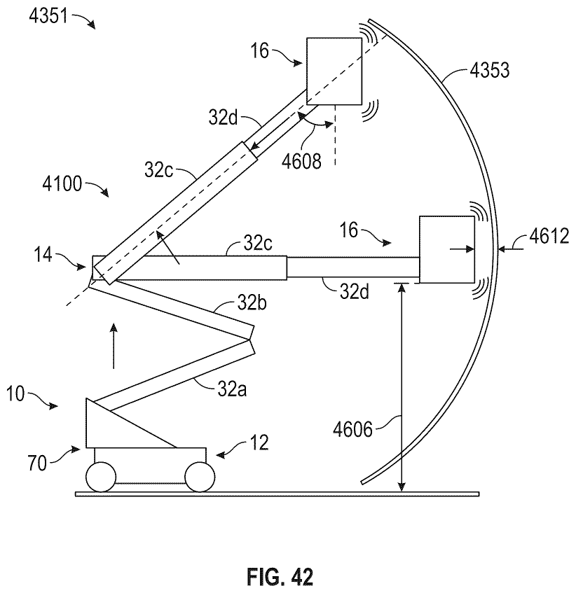

Referring to FIG. 41, a diagram 4350 illustrates a top view showing the lift device 10 servicing a vertically concave wall 4352, according to some embodiments. FIG. 42 similarly shows a diagram 4351 of the lift device 10 servicing a horizontally concave wall 4353. In some embodiments, the lift device 10 is equipped with a full suite of sensors on the platform assembly 16 so that the detection and control system 4100 can obtain a field of view of the vertically concave wall 4352 or the horizontally concave wall 4353 and operate to maintain the platform assembly 16 a desired distance from the wall while operating so that the platform assembly 16 provides access to different parts of the vertically concave wall 4352 or the horizontally concave wall 4353. In some embodiments, the control system 4100 uses real-time feedback from the sensors of the platform assembly 16 to determine the distance 4612 between the platform assembly 16 and the vertically concave wall 4352 or the horizontally concave wall 4353. In some embodiments, the control system 4100 is configured to receive control inputs from the operator (e.g., via a joystick) and operate the turntable 70, the lift assembly 14, etc., to achieve the control inputs. The control inputs may be requests for movement of the platform assembly 16 relative to the wall 4353 or the wall 4352 (e.g., move up the wall, move left or right on the wall, etc.) as opposed to absolute commands to adjust a specific actuator of the lift assembly 14. The concave wall 4352 or 4353 may be a boiler interior, an architectural dome, etc.

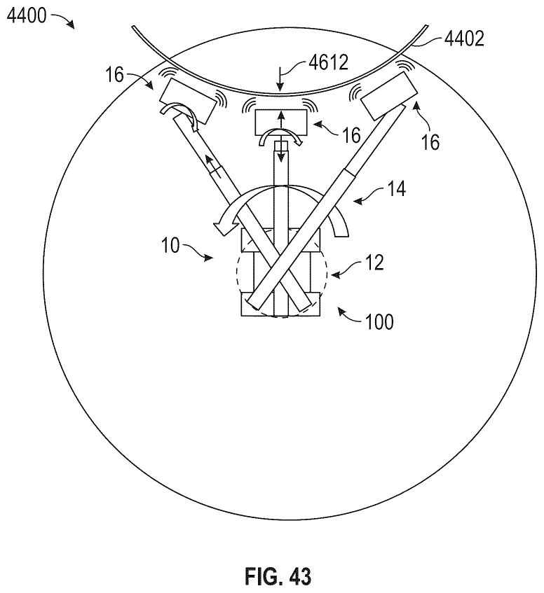

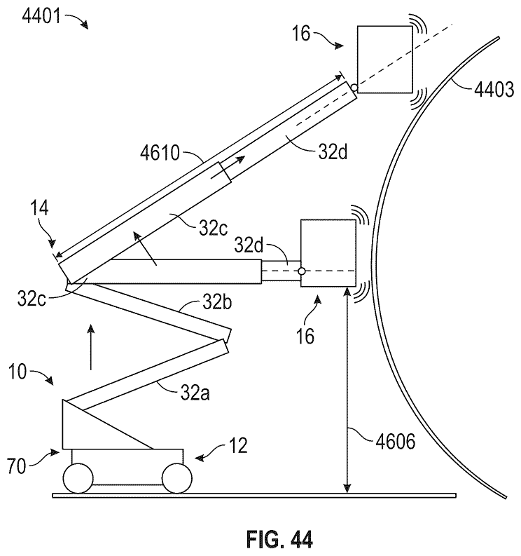

Referring to FIG. 43, a diagram 4400 illustrates a top view showing the lift device 10 servicing a vertically convex wall 4402, according to some embodiments. FIG. 44 illustrates a side view showing the lift device 10 servicing a horizontally convex wall 4403, according to some embodiments. In some embodiments, the platform assembly 16 includes the full suite of sensors and is configured to be operated similarly as described in greater detail above with reference to FIGS. 41 and 42. The convex wall 4402 or 4403 may be a silo, a chemical tank, etc.

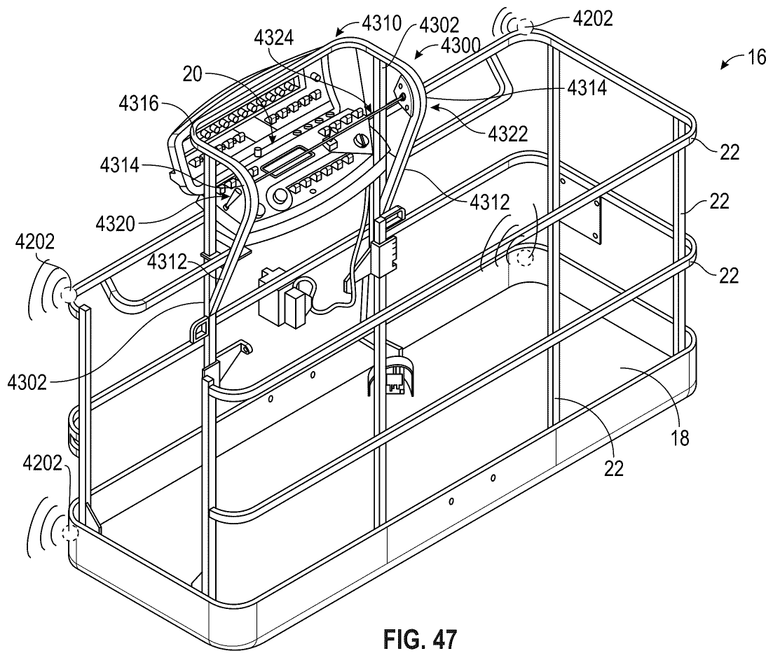

Referring to FIG. 47, the platform assembly 16 may be equipped with one or more sensors 4202 (e.g., lidar sensors, ultrasonic sensors, infrared sensors, cameras, imaging devices, etc.) that are configured to obtain sensor data that is indicative of a surrounding area of the platform assembly 16. In some embodiments, the sensors 4202 are positioned on the deck 18 or on one or more rails 22 of the platform assembly 16. The sensors 4202 are configured to obtain sensor data indicating a relative distance between the platform assembly 16 and a wall surface (e.g., the flat surface 4302, the wall 4352, the wall 4353, the wall 4402, the wall 4403, etc.). In some embodiments, the sensors 4202 can provide information that is used to detect if the wall surface is flat, concave, convex, irregularly shaped, etc., and to determine a map (e.g., a surface map, a graphical representation, etc.) of the wall surface. In some embodiments, the sensors 4202 are configured to provide their information to a controller (e.g., controller 4102) of the control system 4100 so that the control system 4100 can be configured to appropriately adjust the position of the platform assembly 16 as requested by the operator.

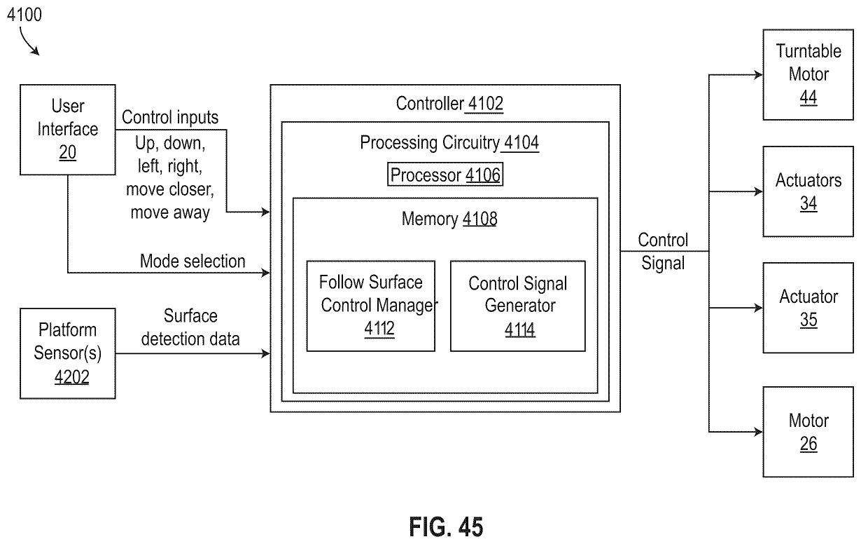

Referring to FIG. 45, the detection and control system 4100 for the lift device 10 includes a controller 4102, the user interface 20, the platform sensors 4202, the turntable motor 44 (e.g., an electric motor, a hydraulic motor, etc.), the actuators 34 (e.g., the actuators 34a, 34b, 34c, and 34d), and the extension actuator 35. The controller 4102 may receive inputs from the user interface 20 and sensor data (e.g., surface detection data) from the platform sensors 4202. The user interface 20 can include one or more joysticks that the operator may operate to provide relative control inputs (e.g., inputs indicating a desired movement or motion of the platform assembly 16 relative to the wall surface) for the platform assembly 16. The controller 4102 may receive the control inputs (move up relative to the wall, move down relative to the wall, move left along the wall, move right along the wall, move closer to the wall, move away from the wall, etc.) and determine controls for each of the turntable motor 44, the actuators 34, the actuator 35, and the motor 26 to achieve the control input provided by the user interface 20. In some embodiments, the user interface 20 also includes one or more buttons, switches, dials, etc., to transition the control system 4100 between different modes of operation (e.g., a follow surface mode, a fixed plane mode, a manual control mode, etc.). In some embodiments, transitioning the control system 4100 between the different modes causes the controller 4102 to interpret control inputs from the user interface 20 different (e.g., so that the joysticks result in different controls of the lift device 10).

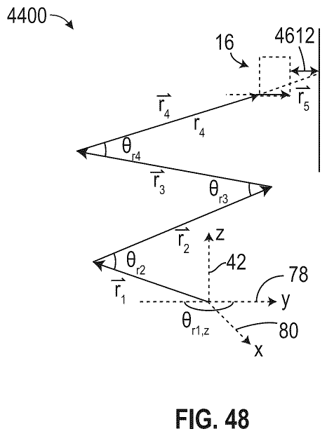

Referring particularly to FIGS. 45 and 48, the controller 4102 can be configured to construct and solve a vector analysis problem in order to determine required changes for the turntable 70, the lift arm 32a, the lift arm 32b, the lift arm 32c, the lift arm 32d, and the platform assembly 16. FIG. 48 illustrates a constructed vector problem in a Cartesian coordinate system. It should be understood that the vector problem may similarly be constructed by the controller 4102 in a spherical coordinate system, a cylindrical coordinate system, a polar coordinate system, etc. The vectors shown in FIG. 48 are illustrative only to demonstrate one way that the controller 4102 may construct the vector problem to determine specific control inputs for each of the actuators 34, the actuator 35, the motor 26, the turntable motor 44, etc. In some embodiments, the controller 4102 does not construct and solve a vector problem and instead uses a predetermined set of instructions or processes to determine controls for the turntable motor 44, the actuators 34, the actuator 35, and the motor 26. In some embodiments, the controller 4102 is configured to use real-time feedback from the platform sensors 4202 in a closed loop control scheme to determine controls for the turntable motor 44, the actuators 34, the actuator 35, and the motor 26.

Referring to FIG. 48, a vector diagram 5400 includes a first vector \vec{r}₁ that extends from the location at which the turntable 70 rotates about the central axis 42 to a pivot point between the lift arm 32a and the turntable 70, a second vector \vec{r}₂ that corresponds to the lift arm 32a, extending from the pivot point between the lift arm 32a and the turntable 70 to a pivot point between the lift arm 32a and the lift arm 32b, a third vector \vec{r}₃ that corresponds to the lift arm 32b and extends from the pivot point between the lift arm 32a and a pivot point between the lift arm 32c and the lift arm 32b, a fourth vector \vec{r}₄ that corresponds to the lift arm 32c that extends between the pivot point between the lift arm 32b and the lift arm 32c to a pivot point between the lift arm 32c and the platform assembly 16. In some embodiments, the controller 4102 can determine controls for the turntable motor 44 to change a value of the angle 4602 as measured about the central axis 42, illustrated as θ_{r1,z} in FIG. 48. In some embodiments, the first vector F, is a fixed length vector that can only rotate about the central axis 42 (e.g., the z-axis). The controller 4102 can also determine controls for the lift actuator 34a to adjust an angle θᵣ₂ between the first vector and the second vector (e.g., between the turntable 70 and the lift arm 32a) or to adjust the angle 75a between the lift arm 32a and the longitudinal axis 78. The controller 4102 can also determine controls for the lift actuator 34b to adjust an angle θᵣ₃ between the second vector and the third vector (e.g., the angle 75b illustrated in FIG. 1). The controller 4102 can also determine controls for the lift actuator 34c to adjust an angle θᵣ₄ between the third vector and the fourth vector (e.g., the angle 75c as illustrated in FIG. 1). The controller 4102 can also determine controls for the extension actuator 35 to increase or decrease a length of the fourth vector (e.g., to drive the intermediate lift arm 32d to extend or retract relative to the lift arm 32c). The controller 4102 can also determine controls for the actuator 34d and the motor 26 to thereby change orientation of the platform assembly 16 relative to the intermediate lift arm 32d about the axis 25 and the axis 28 (e.g., illustrated by the fifth vector \vec{r}₅).

Referring again to FIG. 45, the controller 4102 includes processing circuitry 4104, a processor 4106, and memory 4108. Processing circuitry 4104 can be communicably connected to a communications interface such that processing circuitry 4104 and the various components thereof can send and receive data via the communications interface. Processor 4106 can be implemented as a general purpose processor, an application specific integrated circuit (ASIC), one or more field programmable gate arrays (FPGAs), a group of processing components, or other suitable electronic processing components.

Memory 4108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 4108 can be or include volatile memory or non-volatile memory. Memory 4108 can include database components, object code components, script components, or any other type of information structure for supporting the various activities and information structures described in the present application. According to some embodiments, memory 4108 is communicably connected to processor 4106 via processing circuitry 4104 and includes computer code for executing (e.g., by processing circuitry 4104 and/or processor 4106) one or more processes described herein.

In some embodiments, controller 4102 is implemented within a single computer (e.g., one server, one housing, etc.). In various other embodiments controller 4102 can be distributed across multiple servers or computers (e.g., that can exist in distributed locations).

Referring still to FIG. 45, the controller 4102 includes a follow surface control manager 4112 that is configured to determine appropriate controls or required relative orientations of various arms or components of the lift device 10 based on the control inputs, and a control signal generator 4114 that is configured to generate and provide control signals to the turntable motor 44, the actuators 34, the extension actuator 35, and the motor 26. The follow surface control manager 4112 may be configured to operate according to different modes (e.g., the fixed plane mode, the follow surface mode, etc.) to determine appropriate orientations or controls of the lift device 10 (e.g., values of the angle of the turntable 70, values of the angles between the vectors as determined by the actuators 34, values of the required length for the fourth vector as determined by the extension actuator 35, etc.). The control signal generator 4114 is configured to use the determined angles for the turntable 70, the lift arms 32, etc., or time rate of change of the various angles (e.g., as represented in FIG. 48) and generate and provide control signals for the turntable motor 44, the actuators 34, the actuator 35, and the motor 26 so that the turntable motor 44, the actuators 34, the actuator 35, and the motor 26 operate to achieve the requested function provided by the user interface 20.

Referring again to FIGS. 45 and 48, when the controller 4102 is in the fixed plane mode and receives a control input to move the platform assembly 16 upwards along the wall, downwards along the wall, left or right along the wall, etc., the follow surface control manager 4112 may determine changes for the angle θ_{r1,z} of the turntable 70, the angle θᵣ₂ or the angle 75a, the angle 75b, the angle 75c, the length 4610, the angle of the platform assembly 16 relative to the intermediate lift arm 32d about the axis 28 (e.g., an angle 4604 shown in FIG. 39), the angle of the platform assembly 16 relative to the intermediate lift arm 32d about the axis 25 (e.g., an angle 4608 as shown in FIG. 42), etc., to achieve movement of the platform assembly 16 in the requested direction (or combination of directions) in the fixed plane. The follow surface control manager 4112 may then provide the determined changes for the various angles of the lift device 10 to the control signal generator 4114 which uses the changes or new values to generate control signals for the turntable motor 44, the actuators 34, the actuator 35, and the motor 26 to achieve the requested movement of the platform assembly 16 along the fixed plane. The follow surface control manager 4112 may construct and solve a vector problem as shown in FIG. 48 in order to determine new values of angles or lengths, changes to the angles or lengths, or rate of change for the angles and lengths in order to achieve the requested movement of the platform assembly 16 along the fixed plane.

Referring still to FIGS. 45 and 48, the follow surface control manager 4112 can also use the surface detection data provided by the platform sensors 4202 to determine adjustments or new values for the turntable 70, the angle of the lift arm 32a, the angle of the lift arm 32b, the angle of the lift arm 32c, the extension or retraction of the intermediate lift arm 32d relative to the lift arm 32c, the angle of the platform assembly 16 relative to the intermediate lift arm 32d about the axis 28 (e.g., shown as angle 4604, controlled by motor 26), the angle of the platform assembly 16 relative to the intermediate lift arm 32d about the axis 25 (shown as angle 4608, controlled by actuator 34d) in order to follow a surface (e.g., wall 4352, wall 4353, wall 4402, wall 4403, etc.) at a desired distance. In some embodiments, the follow surface control manager 4112 uses the surface detection data to generate a mapping of the surface, and determines appropriate orientations of the various members of the lift device 10 to move along the mapped surface. In some embodiments, the follow surface control manager 4112 is configured to use the surface detection data as feedback while providing adjusted or new values of angles and extension of the lift arms of the lift device 10 in order to move the platform assembly 16 along the surface while maintaining a specific distance. The follow surface control manager 4112 provides the adjustments or new values for the turntable 70, the angle of the lift arm 32a, the angle of the lift arm 32b, the angle of the lift arm 32c, the extension or retraction of the intermediate lift arm 32d relative to the lift arm 32c, the angle of the platform assembly 16 relative to the intermediate lift arm 32d about the axis 28 (e.g., shown as angle 4604, controlled by motor 26), the angle of the platform assembly 16 relative to the intermediate lift arm 32d about the axis 25 to the control signal generator 4114 for use in generating and providing control signals to the turntable motor 44, the actuators 34, the actuator 35, the motor 26, etc., while receiving the surface detection data from the platform sensors 4202 as feedback.

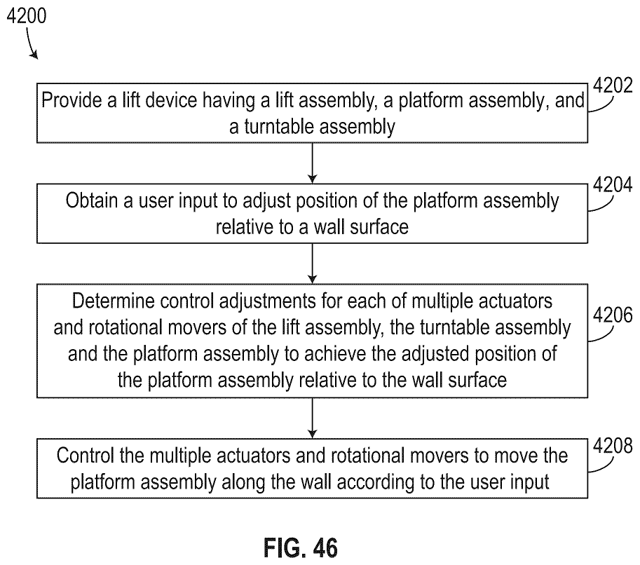

Referring to FIG. 46, a flow diagram of a process 5200 for operating a lift device according to relative control inputs (e.g., relative to a surface) includes steps 5202-5208, according to some embodiments. The process 5200 or portions thereof may be performed by the detection and control system 4100 according to a follow surface mode of operation in which sensor feedback is used to adjust movement of the platform assembly 16 relative to a surface (e.g., following a curved surface) or according to a fixed plane mode of operation to adjust movement of the platform assembly 16 according to a fixed plane (e.g., a fixed coordinate system).

The process 5200 includes providing a lift device having a lift assembly, a platform assembly, and a turntable assembly (step 5202), according to some embodiments. In some embodiments, the lift device is the lift device 10. In some embodiments, one or more of the lift assembly, the platform assembly, and the turntable assembly are controlled by electric actuators, electric motors, hydraulic actuators, hydraulic rotary motors, etc. In some embodiments, the platform assembly is coupled with the lift assembly such that the platform assembly can be raised or lowered and rotated about multiple axes to facilitate reaching elevated locations. In some embodiments, the lift assembly is coupled with the turntable assembly and supported by the turntable assembly. The turntable assembly may operate to rotate about a base of the lift device to thereby adjust an overall orientation of the lift assembly.

The process 5200 also include obtaining a user input to adjust a position of the platform assembly relative to a wall surface (step 5204), according to some embodiments. In some embodiments, the user input is provided via the user interface 20 or a human machine interface (HMI) at the platform assembly 16 (or at the base assembly). The user input is a requested movement of the platform assembly 16 relative to a wall which the lift device is servicing. For example, the user input may include a request to move the platform assembly upwards along the wall, downwards along the wall, left or right along the wall, or closer or further from the wall. Instead of being an input to absolutely move the platform assembly up or down, or to directly control the turntable assembly, the user input is provided and used as a request to move the platform assembly relative to the wall surface. The wall surface may be a planar surface, a concave surface, a convex surface, or an irregularly shaped surface.

The process 5200 includes determining control adjustments for each of multiple actuators and rotational movers of the lift assembly, the turntable assembly, and the platform assembly to achieve the adjusted position (or the requested continual movement) of the platform assembly relative to the wall surface (step 5206), according to some embodiments. In some embodiments, step 5206 includes determining rate of change, adjustments, or new values for any of the angle θ_{r1,z}, the angle 75a, the angle 75b, the angle 75c, the length of the lift arm 32c and the lift arm 32d, the angle 4608 of the platform assembly 16 relative to the intermediate lift arm 32d about the axis 25, and the angle 4604 of the platform assembly 16 relative to the intermediate lift arm 32d about the axis 28. Step 5206 can be performed in order to achieve a position of the platform assembly that is in a fixed plane, or to maintain a distance along a curved wall surface (e.g., a concave or a convex wall) using feedback from position sensors on the platform assembly. Step 5206 may be performed by the follow surface control manager 4112.

The process 5200 includes controlling the multiple actuators and rotational movers to move the platform assembly along the wall surface according to the user input (step 5208), according to some embodiments. In some embodiments, step 5208 is performed by generating control signals and providing the control signals to the actuators and rotational movers of the lift device (e.g., turntable motor 44, actuators 34, actuator 35, motor 26, etc.). In some embodiments, step 5208 is performed based on the results of step 5206. In some embodiments, step 5208 is performed by the control signal generator 4114.

### Power Connector Interlock System

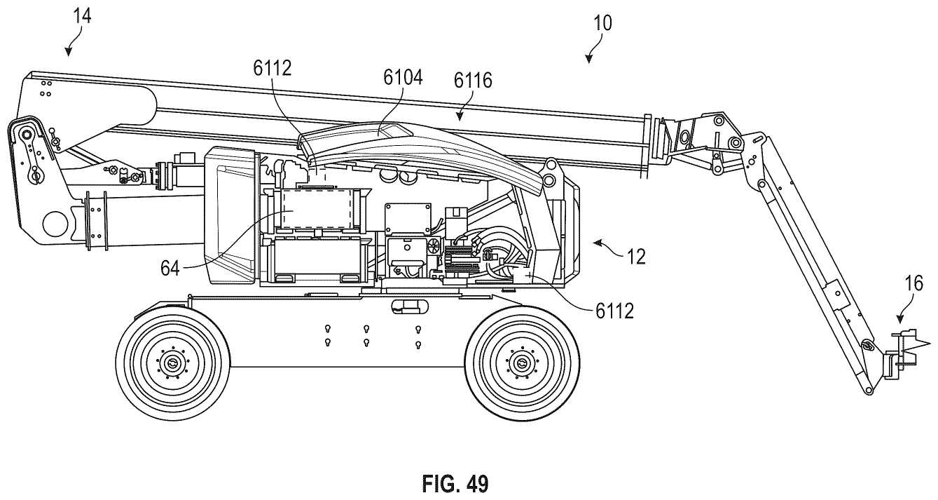

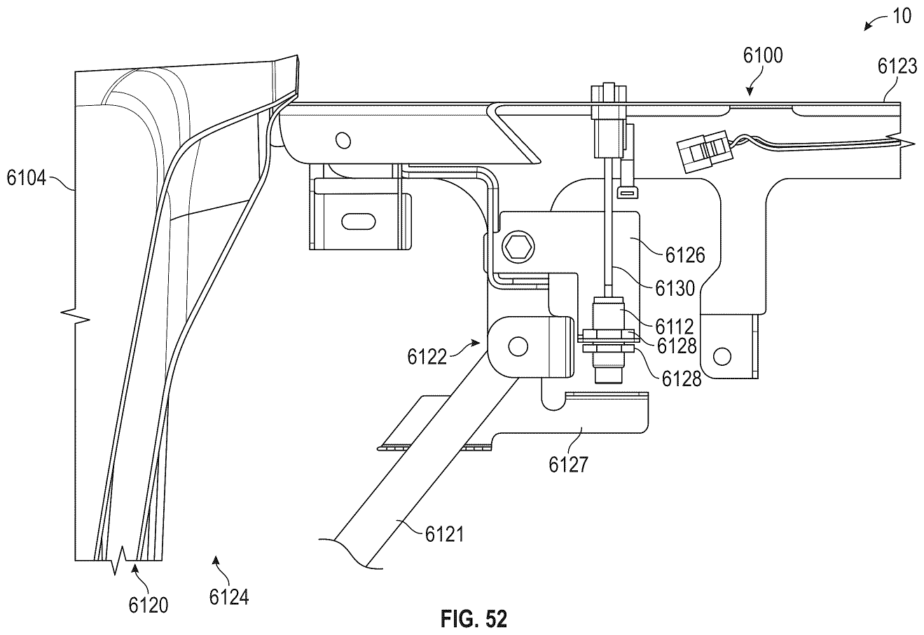

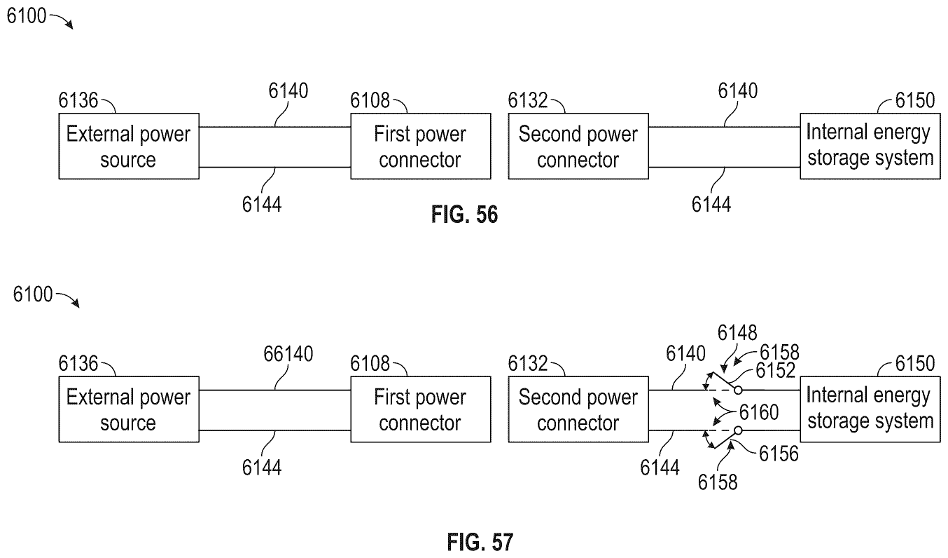

As shown in FIGS. 49-57, the lift device 10 includes a charging system, power transfer system, power connector interlock system, etc., shown as system 6100. In some embodiments, the system 6100 is incorporated into a vehicle, such as a lifting apparatus, lift device, MEWP (e.g., a telehandler, an electric boom lift, a towable boom lift, a lift device, a fully electric boom lift, a scissor lift, etc.), a forestry vehicle, a passenger vehicle (e.g., a bus), a boat, a refuse vehicle, an emergency response vehicle (e.g., a firetruck), a military vehicle, a mixer, or another type of vehicle. As shown in FIGS. 49-57, the system 6100 includes a door 6104 (e.g., switch, activator, hood, etc.), a first power connector 6108 (e.g., an external power connector, contact plate, charging plate/pad, male connector, female connector, plug, terminal, etc.), a sensor 6112 (e.g., proximity sensor, proximity switch, contact sensor, position sensor, etc.), a second power connector 132 (e.g., an onboard power connector, contact plate, charging plate/pad, female connector, male connector, plug, terminal, etc.) configured to electrically couple with the first power connector 6108 to facilitate charging the lift device 10 (e.g., charging the batteries 64 thereof), and an energy storage and power source system (e.g., batteries, capacitors, etc.), shown as internal energy storage system 6150, configured to store energy and provide power to one or more components of the lift device 10. In some embodiments, the system 6100 includes the controller 38. The system 6100 generally facilitates power communication between an external power source (e.g., external power source 136) and the internal energy storage system 6150 (e.g., batteries 64) of the lift device 10 and/or any of the motors, sensors, actuators, electric linear actuators, electrical devices, electrical movers, stepper motors, etc., of the lift device 10. The system 6100 is configured to control (e.g., permit, prevent, limit, etc.) power flow through the first power connector 6108 from the external power source 136 to the internal energy storage system 6150 (e.g., based on a position of the door 6104). The sensor 6112 is configured to detect a presence of (e.g., proximity of, contact with, position of, etc.) the door 6104 and provide a signal (e.g., raw sensor data, varying voltage levels, varying current levels, digital signal, etc.) that may be associated with or include an indication of a state (e.g., condition, mode, position) of the door 6104.

As shown in FIGS. 49, 51, 52, 54, and 55 the door 6104 is positioned along an exterior surface or side of the lift device 10. In some embodiments, the door 6104 is positioned on any side or surface of the lift device 10 (e.g., on the base assembly 12, on the lift assembly 14, on the platform assembly 16, etc.). As shown in FIGS. 49, 51, 52, 54, and 55, the door 6104 is pivotably coupled to the lift device 10 such that the door 6104 pivots (e.g., moves, actuates) between an open position 6116 and a closed position 6120. Similarly, the door 6104 is pivotable between the closed position 6120 and the open position 6116. In some embodiments, the door 6104 opens and closes by way of a different mechanism (e.g., slides open and closed). The door 6104 is configured to provide selective access to the second power connector 132, the prime mover 41, the electric motor 52, the batteries 64, and/or one or more other components of the lift device 10 (e.g., the data cable 130, the first power cable 140, the second power cable 144, one or more other components housed within the base assembly 12, one or more components used to charge the lift device 10, etc.).

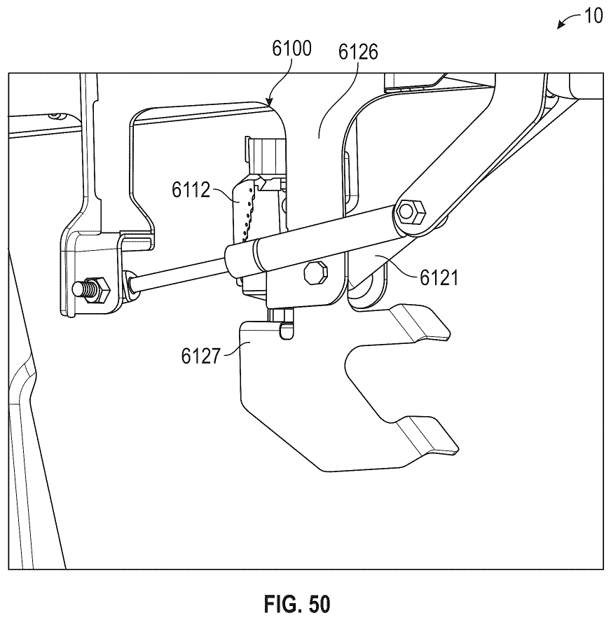

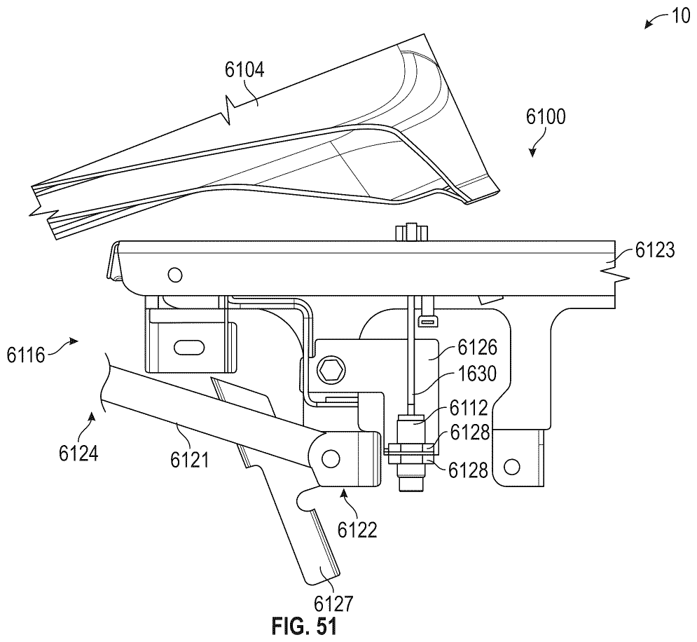

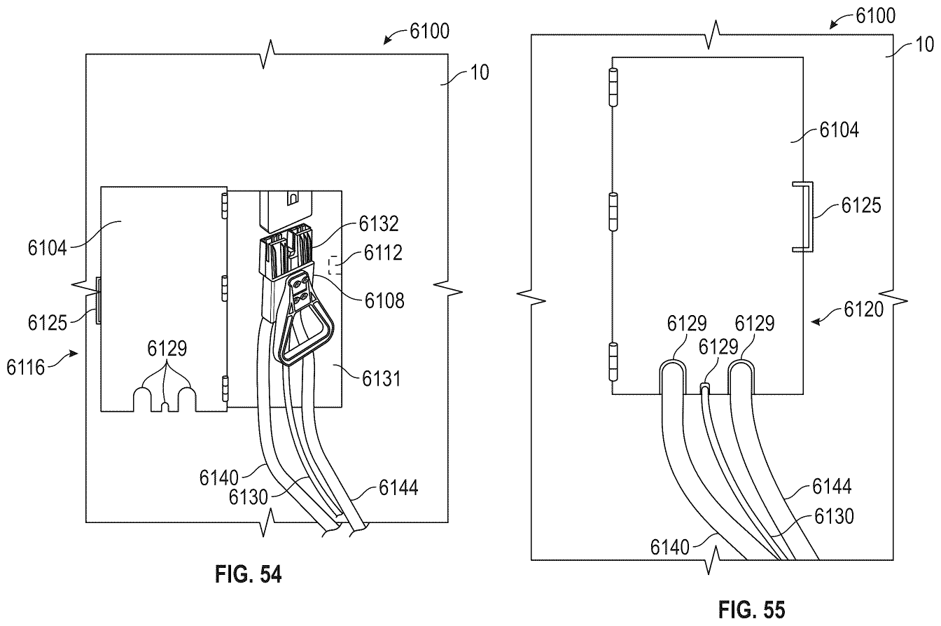

As shown in FIGS. 50-52, the door 6104 is pivotably coupled to the lift device 10 by way of a support structure (e.g., arm, actuator), shown as arm 121. The arm 121 defines a first end 6122 pivotably coupled to a frame member 123 (e.g., rigid member, structural support member, axle, base, frame, carriage, chassis, the base 36, the frame member 54, etc.) of the lift device 10, and a second end 6124 opposite the first end 6122 that couples the door 6104 to the arm 121. As the door 6104 is moved from the open position 6116 to the closed position 6120, or from the closed position 6120 to the open position 6116, (e.g., collectively, between the open position 6116 and the closed position 6120) the arm 121 pivots about the first end 6122 coupled to the frame member 123 and repositions the door 6104 relative to the lift device 10. In some embodiments, the door 6104 is coupled to the lift device 10 by way of a different mechanism (e.g., hinges) configured to reposition the door 6104 relative to the lift device 10. In some embodiments, the door 6104 includes a handle 125 for an operator to grasp and move the door 6104 between the open position 6116 and the closed position 6120. As shown in FIGS. 54 and 55, the door 6104 defines a plurality of cutouts 129 (e.g., apertures, openings, etc.) through which cables (e.g., the data cable 130, the first power cable 140, the second power cable 144, etc.) may feed (e.g., pass) through when the door 6104 is in the closed position 6120 (and the first power connector 6108 is coupled with the second power connector 132). When the first power connector 6108 is coupled with the second power connector 132 and the door 6104 is in the closed position 6120, the door 6104 inhibits access to the first power connector 6108. In other words, in the closed position 6120, the door 6104 inhibits the operator from connecting/disconnecting the first power connector 6108 with/from the second power connector 132, and, in the open position 6116, the door 6104 permits the operator to connect/disconnect the first power connector 6108 with/from the second power connector 132.

As shown in FIGS. 50-52, the system 6100 includes a bracket assembly including a first bracket 6126 (e.g., linkage, support member, sensor support, etc.) and a second bracket 127 (e.g., interference member, linkage, flange, sensor block, etc.). The first bracket 6126 is coupled to the frame member 123 and is configured to couple the sensor 6112 to the lift device 10. The first bracket 6126 defines an aperture through which the sensor 6112 is threaded (e.g., slotted, placed, positioned). The sensor 6112 is threaded through the aperture and selectively tightened into place by a set of nuts 128. The nuts 128 may be tightened to prevent or inhibit the sensor 6112 from unintentionally loosening or repositioning (e.g., during operation of the lift device 10), which may adversely affect the performance of the intended function of the sensor 6112. Before tightening the nuts 128, the sensor 6112 may be threaded through the aperture of the first bracket 6126 and through the nuts 128 to position the sensor 6112 at a desired position (e.g., to optimize the performance of the intended function of the sensor 6112, such that the sensor 6112 is positioned to detect a state of the door 6104, etc.). In some embodiments, the sensor 6112 is otherwise coupled to the lift device 10, or any other component thereof (e.g., dedicated slots, hooks, tabs, pockets, clips, without using the nuts 128 and threaded aperture, etc.).

As shown in FIGS. 49, 51, 52, and 54, the sensor 6112 is coupled to the lift device 10 proximate the door 6104. The sensor 6112 is positioned and configured to detect the state (e.g., position, location, proximity, etc.) of the door 6104 relative to the lift device 10. As shown in FIGS. 50-52, the second bracket 127 is coupled to the arm 121 such that when the door 6104 opens and closes, the second bracket 127 moves with the arm 121 and the door 6104 relative to the lift device 10 (e.g., a position of the second bracket 127 is fixed relative to the arm 121 and the door 6104). The second bracket 127 extends from the arm 121 such that, when the door 6104 is in the closed position 6120, the sensor 6112 detects the second bracket 127. In the open position 6116, the second bracket 127 is coupled to and positioned relative to the arm 121 and the door 6104 such that the sensor 6112 does not detect the presence of the second bracket 127. In the absence of a detection of the second bracket 127 (e.g., indicative of the door 6104 being in the open position 6116, indicative of the door 6104 not being in the closed position 6120), the sensor 6112 may transmit a signal associated with an indication of the state of the door 6104 in the open position 6116. In some embodiments, the sensor 6112 may not detect the presence of the second bracket 127 until the door 6104 is in the closed position 6120 (e.g., a fully closed position). In other words, the sensor 6112 may transmit a signal associated with an indication that the door 6104 is in the open position 6116 unless the door 6104 is in the closed position 6120. In the closed position 6120, the second bracket 127 is coupled to and positioned relative to the arm 121 and the door 6104 such that the sensor 6112 detects the presence of the second bracket 127. Responsive to a detection of the second bracket 127 (e.g., when the door 6104 is in the closed position 6120) by the sensor 6112, the sensor 6112 transmits a signal associated with an indication of the state of the door 6104 in the closed position 6120. In some embodiments, the sensor 6112 includes an infrared switch that transmits infrared light and includes a photodetector configured to detect any reflections of the infrared light to detect the presence or absence of the second bracket 127. In some embodiments, the sensor 6112 includes an inductive switch configured to detect a distance the sensor 6112 is from the second bracket 127 by generating magnetic fields and detecting a change in current.

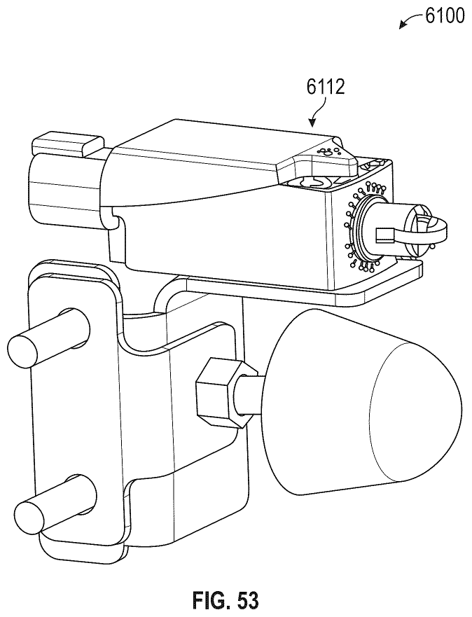

As shown in FIG. 53, the sensor 6112 includes a limit switch (e.g., a position sensor, a mechanical switch, etc.) configured to detect a position of the door 6104. The sensor 6112 may be positioned along the lift device 10 such that the door 6104 (or a portion thereof) is configured to contact (e.g., engage with, press, etc.) the sensor 6112 in the closed position 6120. By way of example, when the door 6104 (e.g., a portion thereof) or another component of the lift device 10 comes into contact with the sensor 6112, a determination may be made that the door 6104 is in the closed position 6120.

In some embodiments, the sensor 6112 is positioned or mounted directly or indirectly to the lift device 10 in any conventional manner, provided the sensor 6112 can detect the state of the door 6104. In some embodiments, the system 6100 includes more than one sensor 6112 that collectively operate to detect the state of the door 6104. The sensor 6112 may be and/or include a motion sensor, a proximity sensor, a position sensor, and/or other possible sensors and/or other devices. For example, the sensor 6112 may be positioned on the lift device 10 to detect whether the door 6104 is in the open position 6116, the closed position 6120, and/or any position therebetween relative to the lift device 10. In another example, when the door 6104 is in the open position 6116, the sensor 6112 detects an absence of the door 6104, and when the door 6104 is in the closed position 6120, the sensor 6112 detects the presence of the door 6104. In yet another example, the sensor 6112 monitors a distance the door 6104 is relative to the lift device 10, and transmits a signal associated with the distance to the controller 38 to determine whether the door 6104 is in the open position 6116 or the closed position 6120. Responsive to detecting the state of the door 6104, the sensor 6112 provides (e.g., transmits) a signal (e.g., raw sensor data, varying voltage levels, varying current levels, digital signal, etc.) that may be associated with or include an indication of the state of the door 6104. For example, the signal may be based on or indicate that the door 6104 is in the open position 6116, the closed position 6120, and/or any position therebetween relative to the lift device 10. The sensor 6112 may transmit the signal associated with the indication of the state of the door 6104 through a wired connection, shown as data cable 130, or a wireless connection to the controller 38. When the door 6104 is in the closed position 6120, the data cable 130 may feed through one of the cutouts 129 of the door 6104.

Referring to FIG. 54, the system 6100 includes a power connector housing, cable housing, etc., shown as housing 131. The housing 131 defines an interior chamber in which the second power connector 132 is disposed. In some embodiments, the second power connector 132 is positioned proximate the batteries 64 to reduce power losses during charging operations (e.g., by reducing electrical resistance that increases with a distance between the second power connector 132 and the batteries 64) and therefore improve overall charging efficiency. As shown in FIG. 54, the first power connector 6108 is configured to electrically connect with (e.g., plug into, fit into, receive, interface with, etc.) the second power connector 132 such that the first power connector 6108 provides power communication between an external power source 136 and the second power connector 132. By way of example, the first power connector 6108 may be manipulated and repositioned by an operator to couple the first power connector 6108 with the second power connector 132. The external power source 136 may be a power grid, generator, external battery, or any other source of power. In some embodiments, the external power source 136 may be coupled to a source of power, such as a power grid, generator, or battery. In some embodiments, the external power source 136 is communicably coupled to the controller 38 to facilitate wireless communication between the lift device 10 and the external power source 136. For example, the wireless communication may include any combination of a wireless network transceiver (e.g., Bluetooth® transceiver, cellular modem, a Wi-Fi® transceiver) and/or wired network transceiver (e.g., an Ethernet transceiver). In some embodiments, the lift device 10 includes hardware and machine-readable media structured to support communication over multiple channels of data communication (e.g., wireless, Bluetooth®, near-field communication, etc.) to facilitate wireless communication. In yet other embodiments, the lift device 10 includes one or more cryptography modules to establish a secure communication session (e.g., using the IPSec protocol or similar) in which data communicated over the session is encrypted and securely transmitted.

Responsive to the second power connector 132 and the first power connector 6108 being coupled together, the external power source 136 and the internal energy storage system 6150 (e.g., batteries 64) of the lift device 10 may be in power communication with each other (e.g., the external power source 136 can provide energy to the internal energy storage system 6150). In some embodiments, the second power connector 132 is configured to facilitate delivering power directly to any of the motors, sensors, actuators, electric linear actuators, electrical devices, electrical movers, stepper motors, etc., of the lift device 10 (e.g., via the first power cable 140 and the second power cable 144). The batteries 64 are configured to charge (e.g., fast charge) by receiving electrical energy (e.g., DC-DC charging power) from the external power source 136.

As shown in FIGS. 54-57, the first power connector 6108 and the second power connector 132 include a wired cable assembly, shown as first power cable 140 and second power cable 144. The first and second power cables 140, 144 are configured to transfer the electrical energy from the external power source 136 to the lift device 10. The first power cable 140 may be a positive terminal (e.g., a first conductor, DC fast charging B+ cable) and the second power cable 144 may be a negative terminal (e.g., a second conductor, DC fast charging B− cable). Placing the first power connector 6108 in electrical communication with the second power connector 132 facilitates electrical communication between the external power source 136 and the internal energy storage system 6150 (e.g., through an inverter or other power converter that converts electrical energy between alternating current and direct current). Accordingly, current generated can be transmitted to the batteries 64 to charge the batteries 64. In some embodiments, a single cable is used instead of the first and second power cables 140, 144 to transfer the electrical energy from the external power source 136 to the lift device 10 or any one or more components of the lift device 10 (e.g., motors, sensors, actuators, electric linear actuators, electrical devices, electrical movers, stepper motors, etc.).

An operator may access the second power connector 132 when the door 6104 is in the open position 6116, or partially open, to electrically connect the first power connector 6108 to the second power connector 132. In some embodiments, the first power connector 6108 is disposed (e.g., housed) within a handle (e.g., plug) to aid the operator in electrically connecting the first power connector 6108 to the second power connector 132. The handle may be ergonomically shaped for the operator to hold in their hand. The handle may be manufactured from a durable high-strength plastic (e.g., polycarbonate, acrylonitrile butadiene styrene, polyphenylene ether, etc.) and may include an insulation member (e.g., coating) to protect the operator during charging operations. In some embodiments, the handle is manufactured from any other suitable material. When the door 6104 is in the closed position 6120, the first and second power cables 140, 144 may feed through one or more of the cutouts 129 defined by the door 6104.

In some embodiments, the external power source 136 is configured to selectively prevent and permit power transfer to the internal energy storage system 6150 (e.g., prevent or permit charging the batteries 64). The sensor 6112 is configured to transmit the signal associated with the indication of the state of the door 6104 through a wired connection (e.g., via the data cable 130) or a wireless connection to the controller 38. In some embodiments, responsive to receiving the signal from the sensor 6112, the controller 38 determines whether the door 6104 is in the open position 6116, the closed position 6120, and/or any position therebetween. By way of example, the controller 38 is configured to use information from the sensor 6112 to determine the state of the door 6104. Responsive to a determination from the sensor 6112 or the controller 38 that the door 6104 is in the open position 6116, the sensor 6112 or the controller 38 automatically provides a signal, through wired or wireless communication, commanding the external power source 136 to prevent power transfer to the internal energy storage system 6150. By way of example, when (i) the door 6104 is in the open position 6116 and (ii) when the first power connector 6108 is (a) in electrical communication with the second power connector 132 or (b) not in electrical communication with the second power connector 132, the transfer of electrical energy from the external power source 136 to the internal energy storage system 6150 is prevented (e.g., charging operations are stopped). In other words, regardless of whether or not the first power connector 6108 is in electrical communication with the second power connector 132, the transfer of electrical energy from the external power source 136 to the internal energy storage system 6150 is prevented when the door 6104 is in the open position 6116. Responsive to a determination from the sensor 6112 or the controller 38 that the door 6104 is in the closed position 6120, the sensor 6112 or the controller 38 automatically provides a signal, through wired or wireless communication, commanding the external power source 136 to permit power transfer to the internal energy storage system 6150. By way of example, when (i) the door 6104 is in the closed position 6120, and (ii) when the first power connector 6108 is in electrical communication with the second power connector 132, the transfer of electrical energy from the external power source 136 to the internal energy storage system 6150 is permitted (e.g., charging operations may commence). To disconnect the first power connector 6108 from the second power connector 132 while charging operations are in progress, the operator may first move the door 6104 to the open position 6116, which stops the charging operations, then the operator may disconnect the first power connector 6108 from the second power connector 132.

In some embodiments, the controller 38 is configured to detect whether the first power connector 6108 is in electrical communication and/or in contact with the second power connector 132. By way of example, the controller 38 may receive a signal (e.g., varying voltage levels, varying current levels, etc.) in response to the first power connector 6108 contacting the second power connector 132.

The sensor 6112 or the controller 38 may provide the signal associated with the indication of the state of the door 6104 for the user interface 20 and/or the user interface 21 to display. By way of example, the operator may utilize the displayed signal to determine the state of the door 6104. By way of another example, the controller 38 may analyze the signal and autonomously notify the operator (through the user interface 20 or the user interface 21) of (i) the state of the door 6104 and/or (ii) a status of charging operations (e.g., whether the transfer of electrical energy from the external power source 136 to the internal energy storage system 6150 is prevented or permitted).

According to an exemplary embodiment shown in FIG. 57, a relay system 148 may be positioned between the second power connector 132 and the internal energy storage system 6150 (e.g., batteries 64) of the lift device 10 and may be configured to selectively prevent and permit power transfer between the second power connector 132 and the internal energy storage system 6150 (e.g., prevent or permit charging the batteries 64). The relay system 148 includes a first relay 6152 (e.g., switch, pin, etc.) provided along the first power cable 140 between the second power connector 132 and the internal energy storage system 6150. The relay system 148 further includes a second relay 6156 (e.g., switch, pin, etc.) provided along the second power cable 144 between the second power connector 132 and the internal energy storage system 6150. The first relay 6152 and/or the second relay 6156 may be or include an electromechanical relay, a solid-state relay, a reed relay, a polarized relay, or any other relay configured to selectively prevent power transfer between the second power connector 132 and the internal energy storage system 6150. The first and second relays 6152, 6156 are configured to pivot between an open position 6158 to open a power circuit (e.g., prevent current flow) and a closed position 6160 to close the power circuit (e.g., permit current flow). In the open position 6158, the first and second relays 6152, 6156 prevent the transfer of power between the second power connector 132 and the internal energy storage system 6150. In the closed position 6160, the first and second relays 6152, 6156 permit the transfer of power between the second power connector 132 and the internal energy storage system 6150. In some embodiments, the relay system 148 includes one relay that pivots to open or close the power circuit and prevent or permit, respectively, the power transfer between the second power connector 132 and the internal energy storage system 6150. Similarly, when the first power connector 6108 and the second power connector 132 are electrically connected, the relay system 148 is configured to prevent and permit the transfer of electrical energy from the external power source 136 to the internal energy storage system 6150 (e.g., prevent and permit charging the batteries 64). In some embodiments, the relay system 148 is positioned between the external power source 136 and the first power connector 6108. In some embodiments, the system 6100 utilizes systems or components other than the relay system 148 to prevent or permit the transfer of electrical energy from the external power source 136 to the internal energy storage system 6150. For example, the system 6100 may utilize any one or more of a switch, an actuator, a contactor, etc. to manually or automatically open or close the power circuit to prevent or permit the transfer of electrical energy from the external power source 136 to the internal energy storage system 6150. In some embodiments, the system 6100 does not include the relay system 148.

According to an exemplary embodiment, responsive to a determination from the sensor 6112 or the controller 38 that the door 6104 is in the open position 6116, the sensor 6112 or the controller 38 automatically provides a signal commanding the relay system 148 to move the first relay 6152 and/or the second relay 6156 to the open position 6158. By way of example, when (i) the door 6104 is in the open position 6116 and (ii) when the first power connector 6108 is (a) in electrical communication with the second power connector 132 or (b) not in electrical communication with the second power connector 132, the transfer of electrical energy from the external power source 136 to the internal energy storage system 6150 is prevented (e.g., charging operations are stopped). Responsive to a determination from the sensor 6112 or the controller 38 that the door 6104 is in the closed position 6120, the sensor 6112 or the controller 38 automatically provides a signal commanding the relay system 148 to move the first relay 6152 and/or the second relay 6156 to the closed position 6160. By way of example, when (i) the door 6104 is in the closed position 6120 and (ii) when the first power connector 6108 is in electrical communication with the second power connector 132, the transfer of electrical energy from the external power source 136 to the internal energy storage system 6150 is permitted (e.g., charging operations may commence).

The system 6100 of the present disclosure provides various advantages over other charging systems. Electrical arcing can occur in other charging systems when a voltage across a gap (e.g., across an electrical connection between two power connectors) becomes high enough and a surrounding area (e.g., air, gas, etc.) ionizes. The ionized area permits electric current to flow across the gap which creates an electric arc that produces heat, shocks, fires, etc. that may damage the charging system and/or pose a risk to operator safety. By preventing the transfer of electrical energy from the external power source 136 to the internal energy storage system 6150 when the door 6104 is in the open position 6116, the system 6100 protects the lift device 10 against electrical arcing. Protecting the lift device 10 against electrical arcing prolongs the life of the lift device 10 and the system 6100. Other charging systems require the use of a 2-stage charging system that requires a shutdown of electrical energy transfer before opening a door and disconnecting the two power connectors. Further, other charging systems require current snubbing (e.g., providing a path for transient current flow). Further, other charging systems have a limited selection of solutions for disconnecting the two power connectors and are more expensive to install, maintain, and service. Limitations of other charging systems requiring a 2-stage operation diminish the performance of the charging operations. The system 6100 of the present disclosure maintains the lift device 10 and other machines charged and fully functional by providing operators and service personnel a fast and convenient method to charge the lift device 10. Further, the system 6100 facilitates minimizing downtime and repairs that would otherwise arise from electrical arcing.

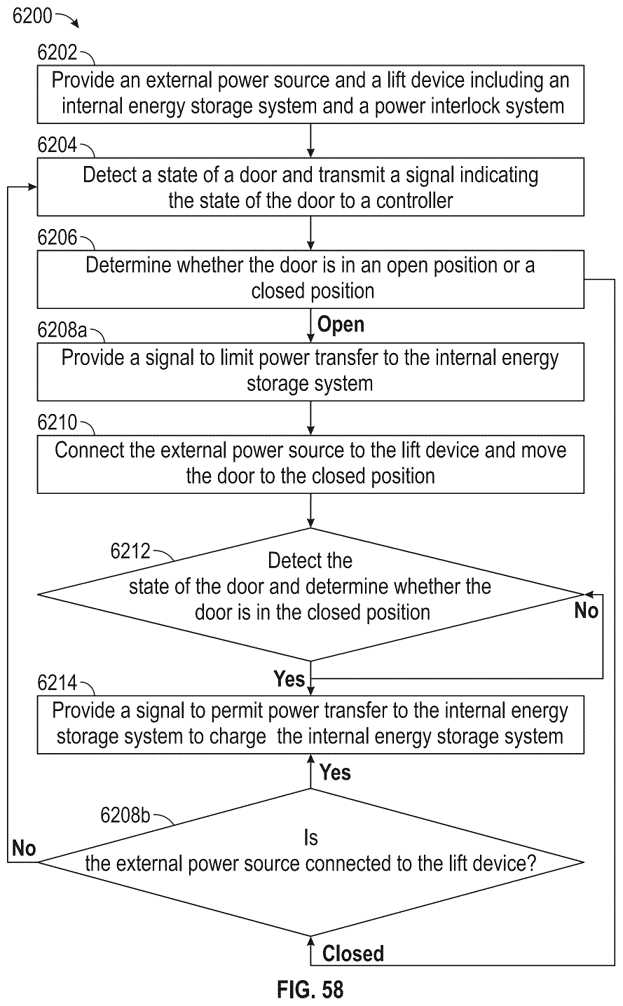

Referring to FIG. 58, a flow diagram of a process 6200 for charging or otherwise providing electrical energy from an external power source to a lift device (e.g., lift device 10) includes steps 6202-6212, according to some embodiments. The process 6200 or portions thereof may be performed by the controller 38 according to feedback from the sensor 6112 (e.g., the signal from the sensor 6112) to determine the state of the door 6104 and automatically prevent or permit the transfer of electrical energy from the external power source 136 to the internal energy storage system 6150.

At step 6202, a lift device including an internal energy storage system (e.g., internal energy storage system 6150) and a power connector interlock system (e.g., system 6100) is provided and an external power source (e.g., external power source 136) is provided, according to some embodiments. At step 6204, a sensor (e.g., sensor 6112) detects a state (e.g., position, location, proximity, etc.) of a door (e.g., door 6104) and transmits a signal that may be associated with or include an indication of the state of the door to a controller (e.g., controller 38). At step 6206, the controller determines whether the door is in an open position (e.g., open position 6116) or a closed position (e.g., closed position 6120). Responsive to a determination that the door is in the open position, at step 6208a, the controller provides a signal to the external power source commanding the external power source to prevent power transfer to the internal energy storage system. Responsive to a determination that the door is in the closed position, at step 6208b, a determination is made of whether the external power source is connected to the lift device. At step 6208b, if a determination is made that the external power source is connected to the lift device, steps 6210 and 6212 are skipped and the process 6200 continues to step 6214. At step 6208b, if a determination is made that that the door is in the closed position and the external power source is not connected to the lift device, the process 6200 returns to step 6204. At step 6210, an operator connects the external power source to the lift device and moves the door to the closed position. At step 6212, the sensor detects the state of the door and transmits the signal to the controller that determines whether the door is in the closed position. Responsive to a determination that the door is not in the closed position, step 6212 is repeated. Responsive to a determination that the door is in the closed position, at step 6214, the controller provides a signal to the external power source commanding the external power source to permit power transfer to the internal energy storage system to charge the internal energy storage system. After step 6214, the process 6200 may return to step 6204.

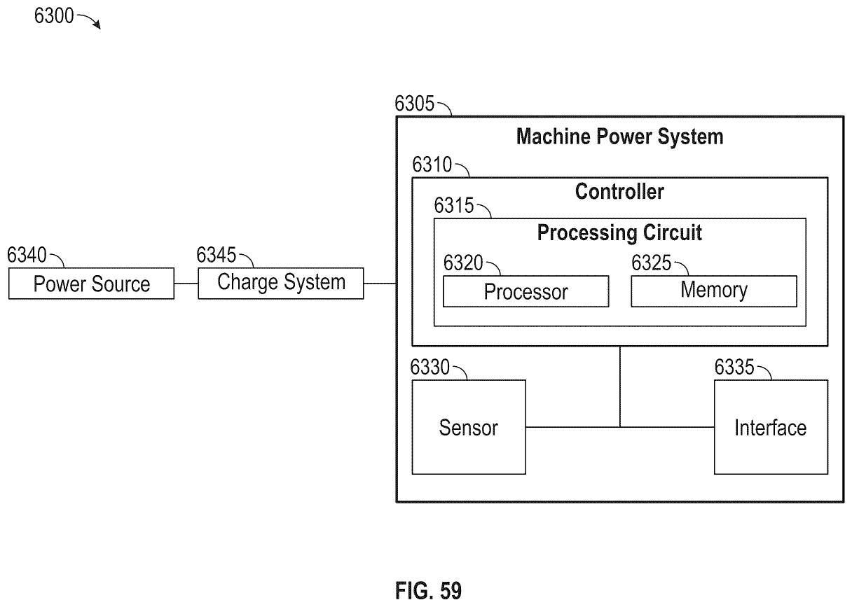

FIG. 59 depicts a block diagram of a system 6300 to control charging of a battery, according to some embodiments. In some embodiments, the system 6300 may control charging of the batteries 64. Each system, device, and/or component of the system 6300 may include one or more processors, memory, network interfaces, communication interfaces, and/or user interfaces. In some embodiments, the memory may store programming logic that, when executed by the processors, controls the operation of the corresponding system, device, and/or component. Memory can store data in databases. The network interfaces may allow the systems and/or components of the system 6300 to communication with one another wirelessly.

The communication interfaces may include wired and/or wireless communication interfaces and the systems and/or components of the system 6300 may be connected via the communication interfaces. The various components of the system 6300 may include implementations via hardware (e.g., circuitry), software (e.g., executable code), or any combination thereof. Systems, devices, and/or components of the system 6300 may be added, removed, modified, separated, combined, rearranged, deleted, integrated, and/or adjusted. For example, a first device that is shown to include a first component and a second component may be modified so that the first component and the second component are provided as a single component. As another example, a device that is shown to be included within a first system may also be added to a second system.

In some embodiments, the system 6300 may include at least one machine power system 6305, at least one power source 6340, and at least one charge system 6345. In some embodiments, the system 6300 and/or one or more systems, devices, and/or components thereof may include at least one of the various systems, devices, and/or components described herein. For example, the machine power system 6305 may include the controller 38. As another example, the system 6300 may include one or more systems, devices, and/or components of the system 6100. In some embodiments, the system 6300 and/or one or more systems, devices, and/or components thereof may perform similar operations to at least one of the systems, devices, and/or components described herein. For example, the machine power system 6305 may facilitate charging of the batteries 64.

In some embodiments, the system 6300 and/or one or more systems, devices, and/or components may be included in at least one of the various machines and/or vehicles described herein. For example, the machine power system 6305 may be included in the lift device 10. In some embodiments, the system 6300 and/or one or more systems, devices, and/or components thereof may be remote and/or external to at least one of the various machines and/or vehicles described herein. For example, the machine power system 6305 may be distributed across one or more servers and the machine power system 6305 may communicate and/or interface with the lift device 10 via a network. In some embodiments, the lift device 10 may include a computing system and/or one or more processing circuits (e.g., the controller 38) that may implement and/or perform operations similar to that of the machine power system 6305.

In some embodiments, systems, devices, and/or components of the system 6300 may communicate with one another via one or more networks. For example, the charge system 6345 and the machine power system 6305 may communicate with one another via at least one of wired and/or wireless telecommunications. As another example, the charge system 6345 and the machine power system 6305 may communicate with one another via at least of Wide-Area Networks (WANs), Local Area Networks (LANs), and/or a Controller Area Network (CAN). In some embodiments, the systems, devices, and/or components of the system 6300 may communicate via at least one of the various types of communication described herein.

In some embodiments, the charge system 6345 may include at least one of the various connectors, connections, and/or cables described herein. For example, the charge system 6345 may include the first power connector 6108. In some embodiments, the charge system 6345 may be in communication with the power source 6340. For example, the charge system 6345 may be electrically coupled with the power source 6340. In some embodiments, the charge system 6345 may control, adjust, and/or otherwise modify an amount of power that is provided by the power source 6340. For example, the charge system 6345 may include a battery module and/or a power module to control an amount of voltage and/or current that is provided by the power source 6340. In some embodiments, the charge system 6345 may communicate with the machine power system 6305 to determine given amounts of power, voltage, and/or current to provide, from the power source 6340, to lift device 10 to charge the batteries 64. For example, the first power connector 6108 and the second power connector 132 may establish communication between the charge system 6345 and the machine power system 6305. In some embodiments, the charge system 6345 may electrically couple, via the first power connector 6108, the machine power system 6305 with the power source 6340.

In some embodiments, the machine power system 6305 may include at least one controller 6310, at least one sensor 6330, and at least one interface 6335. In some embodiments, the controller 6310 may perform operations similar to at least one of the various controllers, computing systems, and/or processing circuits described herein. For example, the controller 6310 may perform operations similar to that of the controller 38. In some embodiments, the sensors 330 may include at least one of the various sensors and/or sensor types described herein. For example, the sensors 330 may include the sensors 6112. In some embodiments, the sensors 330 may detect, collect, and/or otherwise obtain at least one of the various types of measurements, statuses, and/or vehicle information described herein. For example, the sensors 330 may detect a State of Charge (SoC) of the batteries 64. As another example, the sensors 330 may detect that the door 6104 has been opened and/or closed.

In some embodiments, the interface 6335 may include at least one of network communication devices, network interfaces, and/or other possible communication interfaces. The interface 6335 may include wired or wireless communications interfaces (e.g., jacks, antennas, transmitters, receivers, transceivers, wire terminals, etc.) for conducting data communications with various systems, devices, and/or components described herein. In some embodiments, the interface 6335 may include direct (e.g., local wired or wireless communications) and/or via a communications network. For example, the interface 6335 includes an Ethernet card and port for sending and receiving data via an Ethernet-based communications link or network. In some embodiments, the interface 6335 may include a Wi-Fi transceiver for communicating via a wireless communications network. In some embodiments, the interface 6335 includes a power line communications interface. In some embodiments, the interface 6335 may include an Ethernet interface, a Universal Serial Bus (USB) interface, a serial communications interface, and/or a parallel communications interface. In some embodiments, the interface 6335 connects and/or integrates the machine power system 6305 with the charge system 6345.

In some embodiments, the interface 6335 may include one or more systems, devices, and/or components of the system 6100. For example, the interface 6335 may include the second power connector 132. As another example, the interface 6335 may be integrated with and/or included in one or more systems, devices, and/or components of the system 6100. In some embodiments, the interface 6335 may establish communication between the machine power system 6305 and the charge system 6345. For example, the controller 6310 may provide, via the interface 6335, one or more signals to the charge system 6345. As another example, the charge system 6345 may include the first power connector 6108 and the interface 6335 may include the second power connector 132.

In some embodiments, the controller 6310 may include at least one processing circuit 6315. The processing circuit 6315 may refer to and/or include at least one of the various processing circuits, circuits, and/or circuitry described herein. In some embodiments, the processing circuit 6315 includes at least one processor 6320 and memory 6325. Memory 6325 may include includes one or more devices (e.g., Random Access Memory (RAM), Read Only Memory (ROM), Flash memory, hard disk storage) for storing data and/or computer code for completing and/or facilitating the various processes described herein. Memory 6325 may include non-transient volatile memory, non-volatile memory, and non-transitory computer storage media. Memory 6325 may include database components, object code components, script components, or any other type of information structure for supporting the various activities and information structures described herein. Memory 6325 may be communicably coupled to the processors 6320 and memory 6325 may include computer code or instructions (e.g., firmware or software) for executing one or more processes described herein.

In some embodiments, the processors 6320 may be implemented as at least one of one or more application specific integrated circuits (ASICs), field programmable gate arrays (FPGAs), a group of processing components, or other suitable electronic processing components. In some embodiments, memory 6325 may store one or more instructions that, when executed by the processors 6320, cause the processors 6320 to perform one or more of the various operations described herein. In some embodiments, memory 6325 may store, keep, and/or maintain at least one of records, tables, databases, data structures, and/or collections of information.

In some embodiments, the processing circuit 6315 may determine that a machine is electrically coupled with a power source. For example, the processing circuit 6315 may determine that the lift device 10 is electrically coupled with the power source 6340. In some embodiments, the processing circuit 6315 may determine that the lift device 10 is electrically coupled with the power source 6340 responsive to detecting that the first power connector 6108 and the second power connector 132 (e.g., the interface 6335) have been coupled with one another. For example, the lift device 10 and the power source 6340 may be electrically coupled with one another via the first power connector 6108 and the second power connector 132, and the processing circuit 6315 may detect the electrical coupling between the lift device 10 and the power source 6340 responsive to detecting the first power connector 6108.

In some embodiments, the processing circuit 6315 may receive one or more signals. For example, the processing circuit 6315 may receive one or more signals from the charge system 6345. In some embodiments, the processing circuit 6315 may receive, via the interface 6335, the signals from the charge system 6345. For example, the charge system 6345 may provide one or more signals to the interface 6335 and the interface 6335 may provide the signals to the processing circuit 6315. In some embodiments, the processing circuit 6315 may receive signals to initiate charging of a battery. For example, the processing circuit 6315 may receive signals to initiate charging of the batteries 64. In some embodiments, the processing circuit 6315 may receive a signal to indicate that the charge system 6345 and the machine power system 6305 have established communication with one another.

In some embodiments, the processing circuit 6315 may transmit one or more signals. For example, the processing circuit 6315 may transmit a first signal and a second signal to the charge system 6345. In some embodiments, the processing circuit 6315 may transmit signals having one or more parameters. For example, the processing circuit 6315 may transmit signals to indicate an amount of voltage and/or an amount of current to receive from the power source 6340. In some embodiments, the processing circuit 6315 may transmit signals to define an amount of power that is received from the power source 6340. For example, the processing circuit 6315 may transmit, via the interface 6335, one or more signals including parameters to indicate an amount of voltage and an amount of current to define an amount of power.

In some embodiments, the processing circuit 6315 may electrically couple the batteries 64 with the power source 6340. For example, the processing circuit 6315 may open and/or close one or more switches (e.g., relays 6152 and 6156) to connect the batteries 64 with the power source 6340. In some embodiments, the processing circuit 6315 may electrically couple the batteries 64 with the power source 6340 to charge the batteries 64.

In some embodiments, the processing circuit 6315 may detect that one or more components have moved and/or charged positions. For example, the processing circuit 6315 may detect that the door 6104 has moved from an open position (e.g., a first position) to a closed position (e.g., a second position). In some embodiments, the processing circuit 6315 may detect that the door 6104 has moved to the closed position based on one or more signals provided by the sensors 330.

In some embodiments, the processing circuit 6315 may transmit one or more subsequent signals. For example, the processing circuit 6315 may continuously and/or semi-continuously transmit signals to the charge system 6345 to adjust, control, and/or modify an amount of power that is provided to the batteries 64. For example, the processing circuit 6315 may determine that the door 6104 is open and when the door 6104 is open the processing circuit 6315 may transmits signals, to the charge system 6345, to receive a first amount of power from the power source 6340. As another example, the processing circuit 6315 may determine that the door 6104 is closed and the processing circuit 6315 may transmits signals, to the charge system 6345, to receive a second amount of power from the power source 6340.

In some embodiments, the processing circuit 6315 may identify one or more aspects of the lift device 10 to determine parameters to define an amount of power. For example, the processing circuit 6315 may determine an SoC of the batteries 64 and the processing circuit 6315 may use the SoC of the batteries 64 to determine an amount of power to use in charging the batteries. In some embodiments, the batteries 64 may include one or more SoC ranges and the processing circuit 6315 may use a given SoC range to determine parameters to define one or more amounts of power. In some embodiments, the processing circuit 6315 may determine one or more additional and/or subsequent aspects of the batteries 64. For example, the sensor 6330 may collect temperature information associated with the batteries 64 and the processing circuit 6315 may use the temperature information to determine a temperature of the batteries 64. As another example, the batteries 64 may include multiple batteries and the processing circuit 6315 may determine, based on a number of batteries included in the batteries 64, one or more amounts of power to use when charging the batteries 64.

In some embodiments, the position and/or placement of the door 6104 may dictate and/or define one or more amounts of power. For example, the processing circuit 6315 may provide a first amount of power to the batteries 64 when the door 6104 is in an open position. As another, the processing circuit 6315 may provide a second amount of power when the door 6104 is a closed position. In some embodiments, the amount of power provided to the batteries 64 may include characteristics associated with and/or corresponding to fast charging. For example, the amount of power provided to the batteries 64 may include an amperage (e.g., current) amount of 200 amps. As another example, the amount of power provided to the batteries 64 may include a voltage amount of 200 volts.

In some embodiments, the position and/or placement of the door 6104 may define and/or dictate when the batteries 64 are charged using amounts of powers that correspond to fast charging. For example, when the door 6104 is in a closed position, the processing circuit 6315 may communicate with the charge system 6345 to receive, from the power source 6340, an amount of power that corresponds to fast charging. As another example, when the door 6104 is in an open position, the processing circuit 6315 may communicate with the charge system 6345 to receive, from the power source 6340, an amount of power that corresponds to low voltage charging.

In some embodiments, the processing circuit 6315 may monitor the batteries 64. For example, the processing circuit 6315 may monitor the batteries to detect a change in a SoC to the batteries 64. As another example, the processing circuit 6315 may monitor the batteries 64 to detect a change from a first status to a second status. To continue this example, the first status may refer to and/or include a first SoC and the second status may include a second SoC. In some embodiments, the processing circuit 6315 may use information provided by the sensors 330 to monitor the batteries 64.

In some embodiments, the processing circuits 315 may provide one or more signals responsive to monitoring the batteries. For example, the processing circuits 315 may detect that the batteries 64 have reached a SoC of a given amount. To continue this example, the processing circuit 6315 may transmit, via the interface 6335, one or more signals to the charge system 6345 to adjust an amount of power provided to the batteries 64. In some embodiments, the processing circuit 6315 may detect one or more amounts of power. For example, the processing circuit 6315 may detect amounts of power provided by the power source 6340. In some embodiments, the processing circuit 6315 may electrically decouple the power source 6340 from the batteries 64. For example, the processing circuit 6315 may transmits a signal to define an amount of power having zero amps and the processing circuit 6315 may electrically decouple the batteries 64 from the power source 6340 responsive to detecting an amount of power having zero amps.

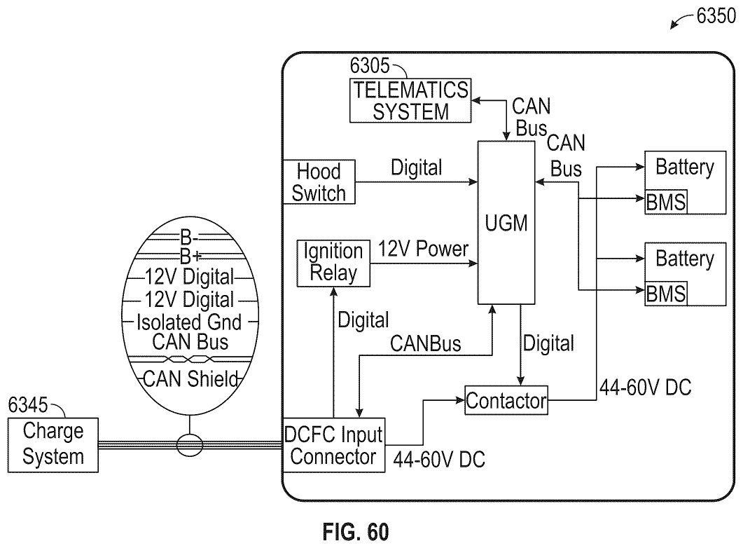

FIG. 60 depicts a block diagram including a schematic block diagram 350 of one or more components of the machine power system 6305, according to some embodiments. As shown in FIG. 60, the machine power system 6305 includes a hood switch, an ignition relay, a DCFC input connector, a contactor, one or more batteries, and a UGM (e.g., a controller). In some embodiments, the DCFC connector may refer to and/or include the interface 6335 and/or the second connector 132. In some embodiments, the contactor may include at least one of the switches 6152 and 6156. In some embodiments, the UGM may refer to and/or include the controller 6310. In some embodiments, the hood switch may provide one or more signals to indicate an opening and/or closing of a hood of the lift device 10. In some embodiments, the ignition relay may provide one or more signals to indicate an activation and/or deactivation of an ignition of the lift device 10.

FIG. 60 depicts an example of one or more signals that may be communicated between the machine power system 6305 and the charge system 6345. In some embodiments, the signals illustrated in FIG. 60 may be communicated via the first power connector 6108 and/or the second power connector 132. As shown in FIG. 60, the signals may include a positive power signal (e.g., B+) and a negative power signal (B−). The B+ signal and the B− signal may refer to the various amounts of power described herein. The signals communicated between the machine power system 6305 and the charge system 6345 may include CANBUS signals, digital signals, and a ground signal. In some embodiments, the various types of parameters described herein may be provided by the CANBUS.

As shown in FIG. 60, the batteries includes one or more Battery Management Systems (BMSs). In some embodiments, the BMSs may provide one or more signals to the processing circuit 6315. For example, the BMSs may provide one or more signals to indicate a status of the batteries 64. In some embodiments, the processing circuit 6315 may determine one or more parameters based on the signals provided by the BMSs. For example, the processing circuit 6315 may determine an amount of voltage (e.g., a parameter) to use when charging the batteries 64 based on the signals provided by the BMSs.

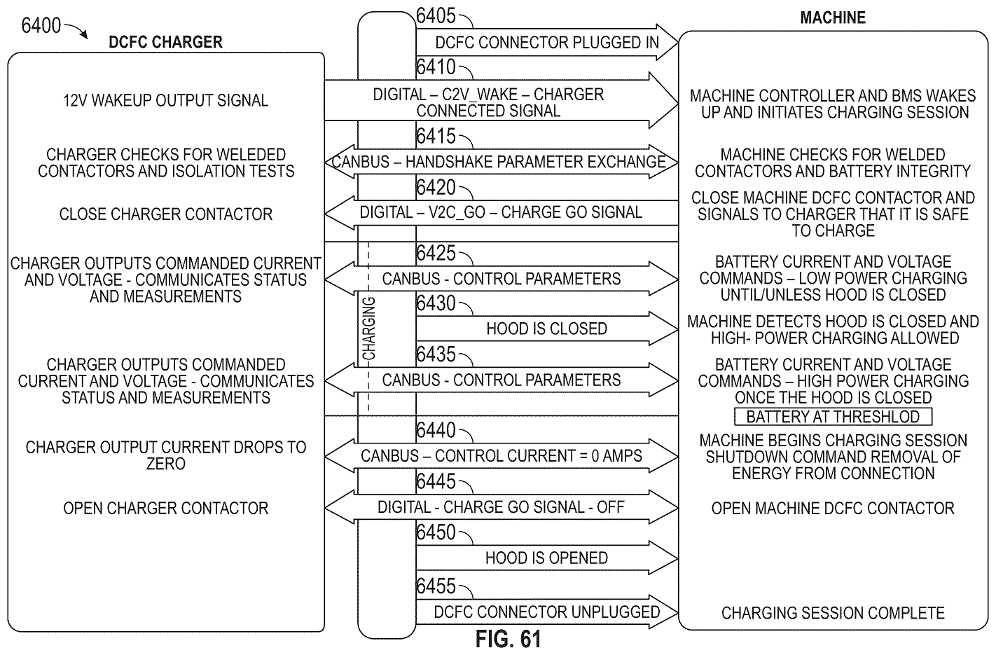

FIG. 61 depicts a sequence diagram of a process 6400 to control charging of a battery for a machine, according to some embodiments. In some embodiments, one or more steps of the process 6400 may be implemented to control charging of the batteries 64. At least one of the various systems, devices, and/or components described herein may perform at least one step of the process 6400. For example, the processing circuit 6315 may perform at least one step of the process 6400. As another example, the charge system 6345 may perform at least one step of the process 6400. In some embodiments, at least one of the various computing systems, circuits, circuitry, and/or processing circuits described herein may be coupled with memory storing executable code that cause a corresponding system to perform at least one step of the process 6400. For example, the controller 38 may include executable code to cause the controller 38 to perform at least one step of the process 6400. In some embodiments, the steps of the process 6400 may occur concurrently, sequentially, consecutively, simultaneously, in order, continuously, and/or semi-continuously. For example, a first step and a second step of the process 6400 may occur at the same time. As another example, a first step of the process 6400 may be followed by a second step of the process 6400.

In some embodiments, step 6405 may include determining that a connector is plugged in. For example, the processing circuit 6315 may determine that the first power connector 6108 is plugged into the second power connector 132. As another example, the processing circuit 6315 may determine that the machine power system 6305 is connected with the charge system 6345. In some embodiments, the processing circuit 6315 may determine that the DCFC connector is plugged in. For example, the processing circuit 6315 may determine that the DCFC connector is plugged into to the charge system 6345.

In some embodiments, step 6410 may include transmitting one or more Charge to Vehicle (C2V) signals. For example, the charge system 6345 may transmit the C2V signal to the machine power system 6305. In some embodiments, the C2V signal may include parameters to indicate that the lift device 10 is electrically coupled with the power source 6340. For example, the C2V signal may indicate that the charge system 6345 detected a connection between the lift device 10 and the charge system 6345. As another example, the C2V signal may include a voltage level that activates (e.g., wakes up) one or more components of the machine power system 6305.

In some embodiments, step 6415 may include transmitting one or more parameters. For example, the interface 6335 may provide, via one or more signals, connection parameters to the charge system 6345. In some embodiments, the connection parameters may indicate that the prongs and/or ports of the second power connector 132 are connected with the prongs and/or ports of the first power connector 6108. The interface 6335 may transmit the connection parameters responsive to the machine power system 6305 evaluating the connection between the lift device 10 and the charge system 6345. For example, the machine power system 6305 may conduct a test on the connection to check for any welded contactors. In some embodiments, the charge system 6345 may perform similar tests on the connection between charge system 6345 and the lift device 10. Stated otherwise, the machine power system 6305 may check the connection between the second power connector 132 and the first power connector 6108.

In some embodiments, step 6420 may include transmitting one or more Vehicle to Charger (V2C) signals. For example, the interface 6335 may provide V2C signals to the charge system 6345. In some embodiments, the V2C signals may initiate and/or indicate that the lift device 10 is ready for a charging sequence. For example, the V2C signals may indicate that the machine power system 6305 has closed contactors between the second power connector 132 and the internal energy storage system 6150 (e.g., the batteries 64 are ready to be electrically coupled with the power source 6340).

In some embodiments, step 6425 may include transmitting one or more parameters. For example, the interface 6335 may transmit one or more charging parameters to the charge system 6345. In some embodiments, the charging parameters may indicate at least one of a voltage level, a current level, and/or an amount of power. For example, the charging parameters may request, from the power source 6340, 10 Watts (e.g., an amount of power). In some embodiments, the machine power system 6305 may generate the charging parameters based on a status and/or a condition of the door 6104. For example, when the door 6104 is open, the machine power system 6305 may generate a first set of charging parameters. As another example, when the door 6104 is closed, the machine power system 6305 may generate a second set of charging parameters.

In some embodiments, the charge system 6345 may provide, from the power source 6340, an amount of power based on the charging parameters provided by the interface 6335. For example, the charge system 6345 may control the power source 6340 to provide 100 watts of power responsive to the machine power system 6305 asking for 100 watts. In some embodiments, the machine power system 6305 and the charge system 6345 may communicate and/or transmit the charging parameters via a CAN bus.

In some embodiments, the interface 6335 transmitting the charging parameters may initiate a charging session for the lift device 10. For example, the batteries 64 may receive, from the power source 6340, electrical power responsive to the transmission of the charging parameters. In some embodiments, the machine power system 6305 and the charge system 6345 may continuously and/or semi-continuously transmit charging parameters during a charging session. For example, the charge system 6345 may provide charging parameters that indicate and/or identify an amount of power that is being provided to the batteries 64. As another example, the machine power system 6305 may provide charging parameters that indicate a temperature of the batteries 64.

In some embodiments, step 6430 may include detecting a change in the position of the door 6104. For example, the machine power system 6305 may detect that the door 6104 moved to a closed position. In some embodiments, the door 6104 moving to the closed position may indicate that the connection between the first power connector 6108 and the second power connector 132 is isolated and/or confined within a housing of the lift device 10. In some embodiments, the machine power system 6305 may determine, responsive to detecting that the door 6104 is closed, that a fast-charging session may be initiated. For example, the machine power system 6305 may determine that the batteries 64 can receive one or more amounts of power indicative of fast charging.

In some embodiments, step 6435 may include transmitting one or more parameters. For example, the interface 6335 may transmit one or more second charging parameters to the charge system 6345. In some embodiments, the one or more second charging parameters may indicate and/or identify a charge to an amount of power to provide to the batteries 64. For example, the second charging parameters may request an amount of power that is greater than and/or larger than an amount of power currently being provided to the batteries 64. Stated otherwise, the second charging parameters may indicate a request for an increase to the amount of power being provided to the batteries 64. In some embodiments, the second charging parameters may indicate and/or identify one or more amounts of power indicative of fast charging. For example, the second charging parameters may indicate a request to receive 400 watts of power.

In some embodiments, the machine power system 6305 may monitor and/or evaluate the status of the batteries 64. For example, the sensors 330 may collect information to indicate an SoC and/or a charge level of the batteries 64. To continue this example, the machine power system 6305 may determine, based on the information collected by the sensors 330, a charge status and/or a level of charge for the batteries 64. In some embodiments, the charging of the batteries 64, based on the second charging parameters, may continue for a given amount of time and/or until a given battery charge level is reached. For example, the batteries 64 may receive amounts of power indicative of fast charging until the batteries 64 reach a 75% charge level. As another example, the batteries 64 may receive amounts of power indicative of fast charging for 40 minutes.

In some embodiments, the machine power system 6305 may detect and/or determine that the batteries 64 reached one or more thresholds. For example, the machine power system 6305 may detect that the batteries 64 reached a given charge level.

In some embodiments, step 6440 may include transmitting one or more parameters. For example, the interface 6335 may transmit one or more third charging parameters to indicate that the batteries 64 reached a given threshold. In some embodiments, the one or more third charging parameters may identify and/or indicate one or more amounts of power. For example, the one or more third charging parameters may indicate a request to receive zero amps (e.g., no and/or minimal amounts of current) from the power source 6340. In some embodiments, the interface 6335 transmitting the one or more third charging parameters may indicate and/or initiate a shutdown sequent to complete charging of the batteries 64. In some embodiments, the charge system 6345 may provide one or more parameters to indicate that the power source 6340 is provided the amount of power indicated by the one or more third charging parameters. For example, the charge system 6345 may provide one or more parameters that indicate that the power source 6340 is providing zero amps.

In some embodiments, step 6445 may include transmitting one or more signals to indicate completion of a charging session. For example, the interface 6335 may transmit one or more signals to the charge system 6345 to indicate that the connectors between the second power connector 132 and the internal energy storage system 6150 have been opened.

In some embodiments, step 6450 may include detecting that the door is in an open position. For example, the machine power system 6305 may detect that the door 6104 is in an open position.

In some embodiments, step 6455 may include determining that the first power connector 6108 and the second power connector 132 have been decoupled from one another. For example, the machine power system 6305 may detect that the first power connector 6108 has been unplugged from the second power connector 132. As another example, the machine power system 6305 may detect that the second power connector 132 is no longer connected with the first power connector 6108.

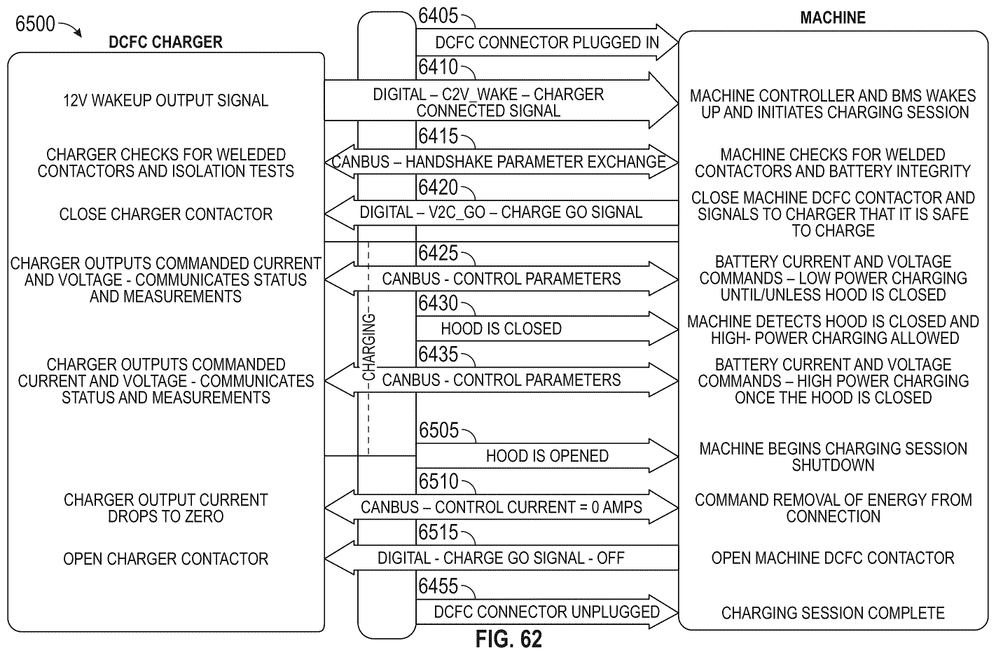

FIG. 62 depicts a sequence diagram of a process 6500 to control charging of a battery for a machine, according to some embodiments. In some embodiments, one or more steps of the process 6500 may be implemented to control charging of the batteries 64. At least one of the various systems, devices, and/or components described herein may perform at least one step of the process 6500. For example, the processing circuit 6315 may perform at least one step of the process 6500. As another example, the charge system 6345 may perform at least one step of the process 6500. In some embodiments, at least one of the various computing systems, circuits, circuitry, and/or processing circuits described herein may be coupled with memory storing executable code that cause a corresponding system to perform at least one step of the process 6500. For example, the controller 38 may include executable code to cause the controller 38 to perform at least one step of the process 6500. In some embodiments, the steps of the process 6500 may occur concurrently, sequentially, consecutively, simultaneously, in order, continuously, and/or semi-continuously. For example, a first step and a second step of the process 6500 may occur at the same time. As another example, a first step of the process 6400 may be followed by a second step of the process 6500.

In some embodiments, the process 6500 may include one or more steps similar to and/or described above with respect to the process 6400. For example, the process 6500 may include steps 6405-6435. In some embodiments, the process 6500 may include more steps and/or less steps than the number of steps illustrated in FIG. 62.

In some embodiments, the process 6500 may include initiating and/or establishing a charging session between the lift device 10 and the power source 6340. For example, the machine power system 6305 may transmit one or more signals to initiate a charging session between the batteries 64 and the power source 6340. In some embodiments, the machine power system 6305 may determine a position of the door 6104. For example, the machine power system 6305 may determine that the door 6104 is closed.

In some embodiments, step 6505 may include determining that the door (i.e., hood) has opened. For example, the machine power system 6305 may determine that door 6104 is in an open position. In some embodiments, the door 6104 being in the open position may indicate that a user may attempt to decouple the lift device 10 from the power source 6340. For example, the user may attempt to disconnect the first power connector 6108 from the second power connector 132. In some embodiments, the machine power system 6305 may initiate the shutdown sequent described herein responsive to detecting that the door 6104 is in the open position.

In some embodiments, step 6510 may include transmitting one or more parameters. For example, the interface 6335 may transmit one or more parameters to the charge system 6345. In some embodiments, the one or more parameters may indicate that the door 6104 is in the open position. The one or more parameters may also indicate and/or identify an amount of power. For example, the one or more parameters may indicate a request for zero amps from the power source 6340. In some embodiments, step 6510 may include transmitting signals and/or parameters similar to that described in step 6440.

In some embodiments, step 6515 may include transmitting one or more signals to indicate decoupling between the lift device 10 and the power source 6340. For example, the interface 6335 may provide one or more signals to indicate that the power source 6340 is no longer electrically coupled with the batteries 64. In some embodiments, the charge system 6345 may open one or more connectors to electrically decouple the power source 6340 with the first power connector 6108. For example, the charge system 6345 may open one or more switches to isolate the power source 6340 from the first power connector 6108. In some embodiments, step 6515 may include transmitting one or more signals and/or parameters similar that in step 6445.

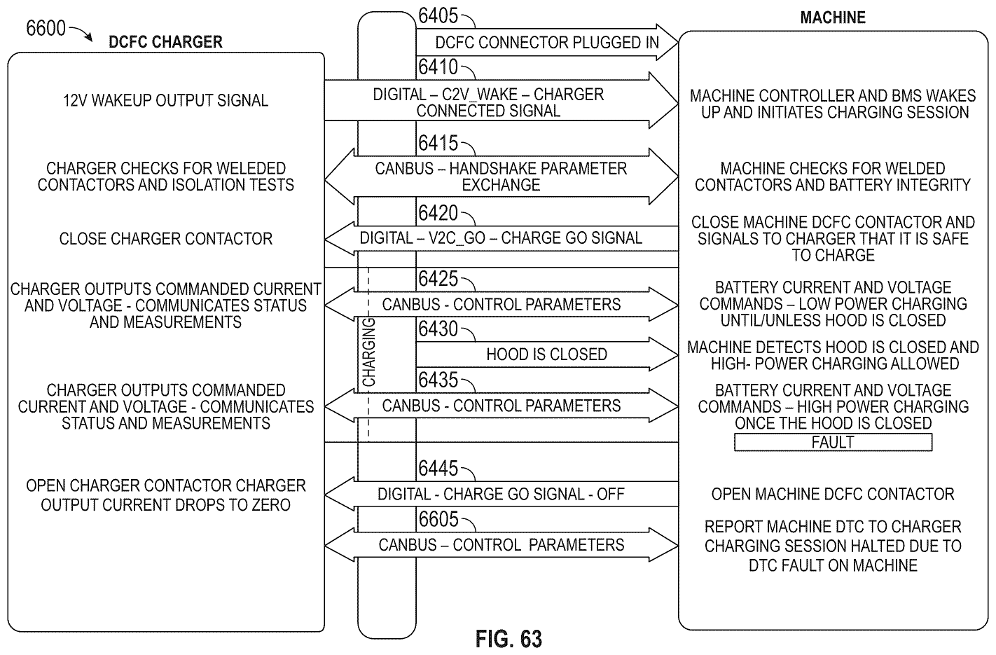

FIG. 63 depicts a sequence diagram of a process to control charging of a battery for a machine, according to some embodiments. In some embodiments, one or more steps of the process 6600 may be implemented to control charging of the batteries 64. At least one of the various systems, devices, and/or components described herein may perform at least one step of the process 6600. For example, the processing circuit 6315 may perform at least one step of the process 6600. As another example, the charge system 6345 may perform at least one step of the process 6600. In some embodiments, at least one of the various computing systems, circuits, circuitry, and/or processing circuits described herein may be coupled with memory storing executable code that cause a corresponding system to perform at least one step of the process 6600. For example, the controller 38 may include executable code to cause the controller 38 to perform at least one step of the process 6600. In some embodiments, the steps of the process 6600 may occur concurrently, sequentially, consecutively, simultaneously, in order, continuously, and/or semi-continuously. For example, a first step and a second step of the process 6600 may occur at the same time. As another example, a first step of the process 6600 may be followed by a second step of the process 6600.

In some embodiments, the process 6600 may include one or more steps similar to and/or described above with respect to at least one of the process 6400 and/or the process 6500. For example, the process 6600 may include steps 6405-6435. In some embodiments, the process 6600 may include more steps and/or less steps than the number of steps illustrated in FIG. 63.

In some embodiments, the process 6600 may include initiating and/or establishing a charging session between the lift device 10 and the power source 6340. For example, the machine power system 6305 may transmit one or more signals to initiate a charging session between the batteries 64 and the power source 6340. In some embodiments, the machine power system 6305 may determine a position of the door 6104. For example, the machine power system 6305 may determine that the door 6104 is closed.

In some embodiments, the machine power system 6305 may detect one or more faults. For example, the machine power system 6305 may receive one or more signals from a BMS for the batteries 64. To continue this example, the machine power system 6305 may detect, based on the signals provided by the BMS, one or more faults associated with the batteries 64. In some embodiments, the faults may include at least one of a battery temperature exceeding a predetermined threshold and/or level, a loss in communication between one or more components of the machine power system 6305, a loss in communication between one or more components of the lift device 10, one or more Diagnostic Trouble Codes (DTC), and/or other possible faults.

In some embodiments, step 6605 may include transmitting one or more signals. For example, the interface 6335 may transmit one or more signals to the charge system 6345. In some embodiments, the interface 6335 may transmit signals to indicate and/or identify the fault detected by the machine power system 6305. For example, the interface 6335 may transmit signals to indicate a fault in communication between the machine power system 6305 and the relays 6152 and 6156. In some embodiments, the interface 6335 transmitting the signals may halt and/or pause the charging session between the batteries 64 and the power source 6340.

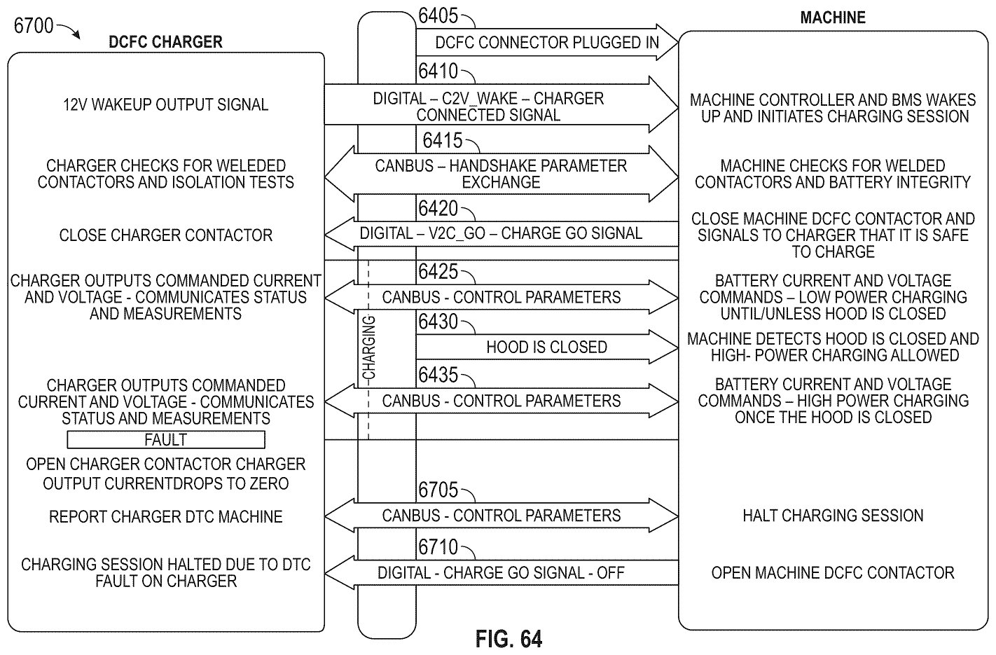

FIG. 64 depicts a sequence diagram of a process 6700 to control charging of a battery for a machine, according to some embodiments. In some embodiments, one or more steps of the process 6700 may be implemented to control charging of the batteries 64. At least one of the various systems, devices, and/or components described herein may perform at least one step of the process 6700. For example, the processing circuit 6315 may perform at least one step of the process 6700. As another example, the charge system 6345 may perform at least one step of the process 6700. In some embodiments, at least one of the various computing systems, circuits, circuitry, and/or processing circuits described herein may be coupled with memory storing executable code that cause a corresponding system to perform at least one step of the process 6700. For example, the controller 38 may include executable code to cause the controller 38 to perform at least one step of the process 6700. In some embodiments, the steps of the process 6700 may occur concurrently, sequentially, consecutively, simultaneously, in order, continuously, and/or semi-continuously. For example, a first step and a second step of the process 6700 may occur at the same time. As another example, a first step of the process 6700 may be followed by a second step of the process 6700.

In some embodiments, the process 6700 may include one or more steps similar to and/or described above with respect to at least one of the process 6400, the process 6500, and/or the process 6600. For example, the process 6700 may include steps 6405-6435. In some embodiments, the process 6700 may include more steps and/or less steps than the number of steps illustrated in FIG. 64.

In some embodiments, the process 6700 may include initiating and/or establishing a charging session between the lift device 10 and the power source 6340. For example, the machine power system 6305 may transmit one or more signals to initiate a charging session between the batteries 64 and the power source 6340. In some embodiments, the machine power system 6305 may determine a position of the door 6104. For example, the machine power system 6305 may determine that the door 6104 is closed.

In some embodiments, the charge system 6345 may monitor and/or observe performance of the power source 6340. For example, the charge system 6345 may compare a requested amount of power with an amount of power provided by the power source 6340. Stated otherwise, the charge system 6345 may provide a request for the power source 6340 to provide X amount of power and the charge system 6345 may compare the X amount of power with Y amount of power that is provided by the power source 6340. In some embodiments, the charge system 6345 may detect one or more faults. For example, the charge system 6345 may detect that the power source 6340 is providing an amount of power that is different than a requested amount of power. As another example, the charge system 6345 may detect a loss in a connection with the power source 6340.

In some embodiments, step 6705 may include transmitting one or more parameters. For example, the charge system 6345 may transmit, via one or more signals, parameters that indicate and/or identify the fault detected by the charge system 6345. In some embodiments, the charge system 6345 may isolate the power source 6340 from the lift device 10. For example, the charge system 6345 may open one or more switches and/or connectors. In some embodiments, the charge system 6345 may isolate the power source 6340 responsive to detecting one or more faults. In some embodiments, the charge system 6345 may transmit parameters to indicate that the power source 6340 has been isolated.

In some embodiments, the machine power system 6305 may halt and/or pause a charging system responsive to receiving the parameters from the charge system 6345. For example, the machine power system 6305 may provide signals having parameters to request zero amps. As another example, the interface 6335 may provide signals having parameters to indicate a request for zero power.

In some embodiments, step 6710 may include transmitting one or more signals. For example, the interface 6335 may transmit, to the charge system 6345, one or more signals to indicate a halt and/or a pause to a charging session. In some embodiments, the machine power system 6305 may pause and/or halt the charging session by isolating the internal energy storage system 6150 from the second power connector 132. In some embodiments, the interface 6335 may transmit one or more parameters, to charge system 6345, to indicate that the machine power system 6305 isolated (e.g., opened relays 6152 and 6156) the internal energy storage system 6150 from the second power connector 132.

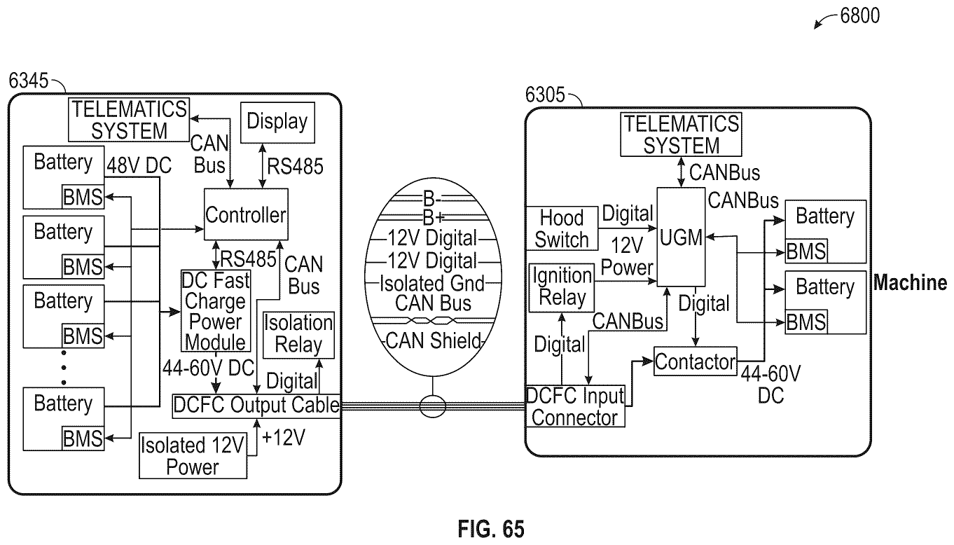

FIG. 65 depicts a schematic block diagram 6800, according to some embodiments. In some embodiments, the schematic block diagram 6800 may include one or more components of the system 6300. For example, the schematic block diagram 6800 may include the machine power system 6305 and the charge system 6345. FIG. 65 depicts a non-limiting example of the charge system 6345 including the power source 6340 (shown as battery). In some embodiments, the charge system 6345 may be housed within and/or included in a generator system. For example, the charge system 6345 may be included in a portable generator. The charge system 6345 is shown to include a Direct Current (DC) charge power module, a controller, a display, an isolation relay, a DC Fast Charge (FC) output cable, a telematics system (e.g., an external platform), and an isolated power source. In some embodiments, the one or more components of the charge system 6345, as shown in FIG. 65, may include similar components to that of the various systems and/or devices described herein. In some embodiments, the telematics system facilitates communication between the systems of the lift device 10 and a remote system. By way of example, the remote system may receive the data relating to the lift device 10 via the telematics system. The remote system may be configured to perform back-end processing of the lift device data. The remote system may be configured to transmit information, data, commands, and/or instructions to the lift device 10. By way of example, the remote system may send, via the telematics system, commands or instructions to the lift device 10 to implement.

As shown in FIG. 65, the charge system 6345 and the machine power system 6305 may be communicably coupled with one another via the DCFC output cable and the DCFC input cable. In some embodiments, the DCFC output cable may refer to and/or include the first power connector 6108. In some embodiments, the DCFC input cable may refer to and/or include the second power connector 132.

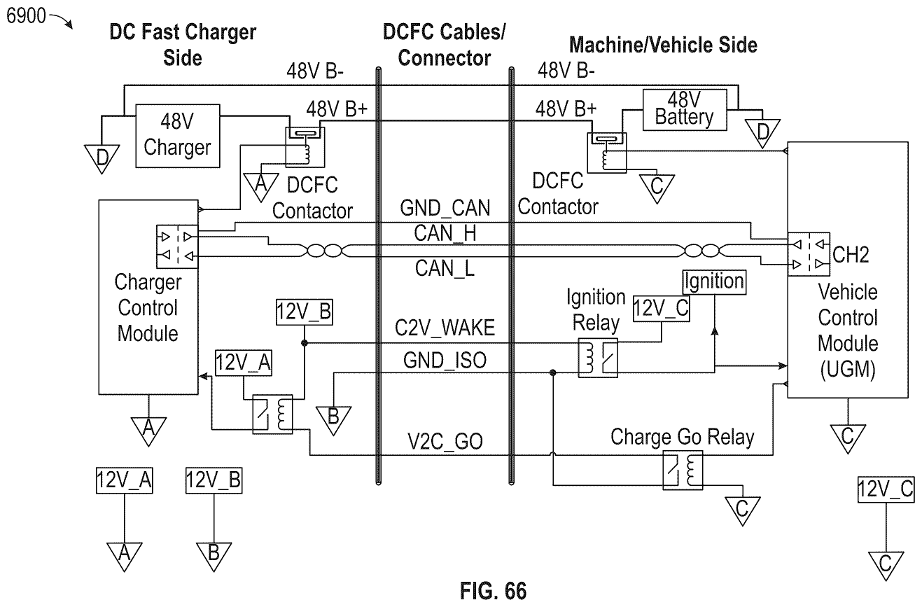

FIG. 66 depicts a schematic block diagram 6900, according to some embodiments. In some embodiments, the schematic block diagram 6900 may identify, illustrate, and/or indicate at least one of the various signals described herein. For example, in FIG. 66, the schematic block diagram 6900 is shown to include the C2V signals described herein. FIG. 66 depicts a non-limiting example of one or more relays and/or switches that may be implemented within the charge system 6345 and/or the machine power system 6305. For example, the machine power system 6305 and the charge system 6345 are both shown to include a DCFC contactor, as shown in FIG. 66. In some embodiments, the DCFC contactors may isolate and/or separate the batteries 64 from the power source 6340.

In some embodiments, the schematic block diagram 6900 may include a CANbus and the machine power system 6305 may communicate with the charge system 6345 via the CANbus. For example, the machine power system 6305 may provide, via the CANbus, charging parameters to the charge system 6345. As shown in FIG. 66, the UGM (e.g., the controller 6310) is shown to be communicably coupled with a charger control module (e.g., a controller of the charge system 6345) via the CANbus. In some embodiments, the various connections illustrated in FIG. 66 may be created and/or established responsive to connecting and/or coupling the first power connector 6108 with the second power connector 132.

### Manually Dischargeable Batteries

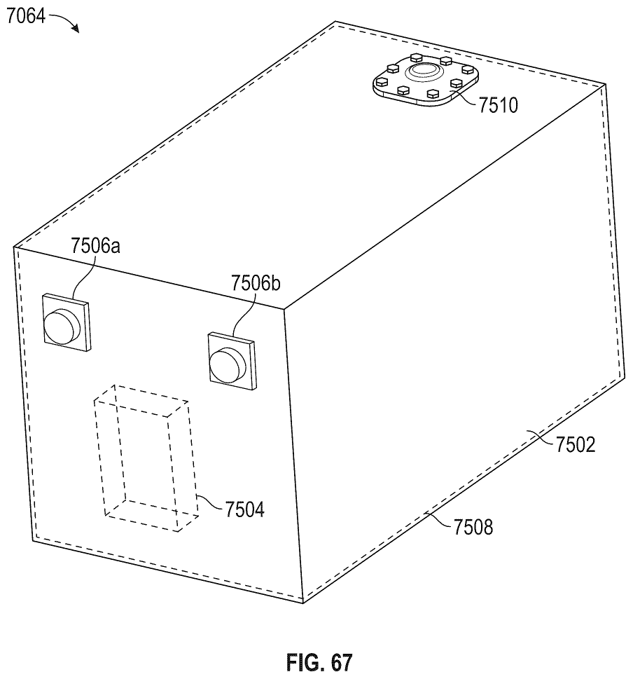

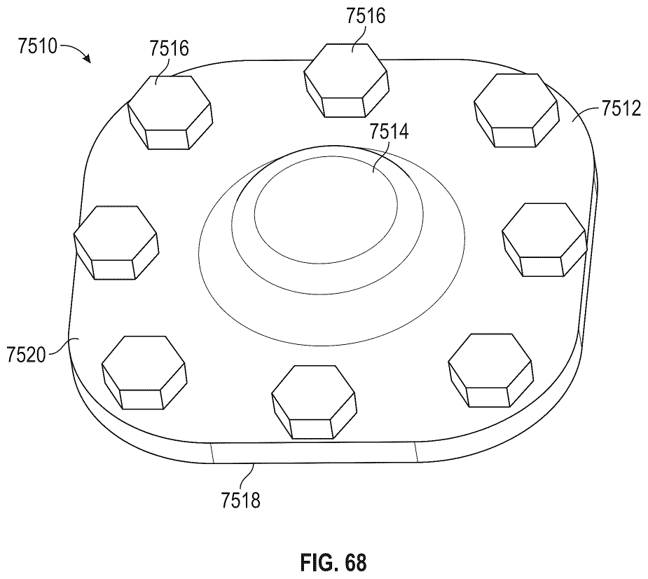

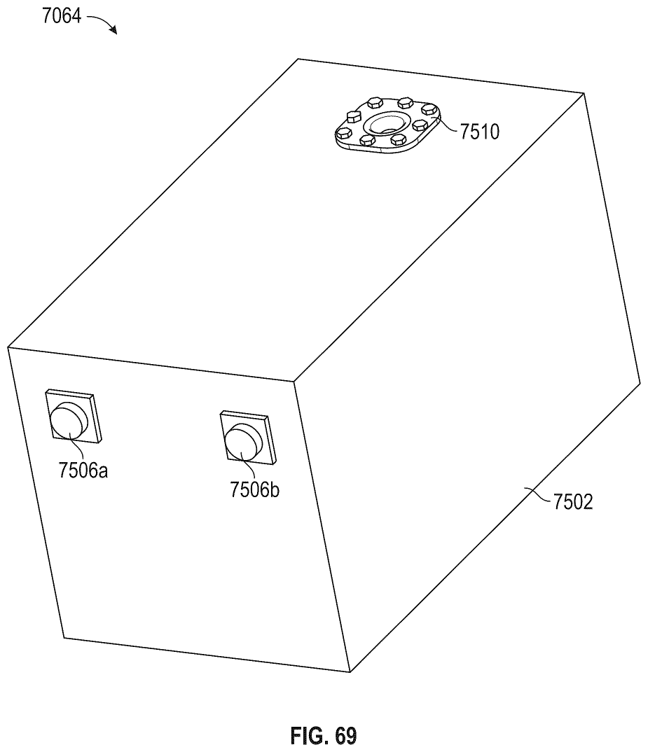

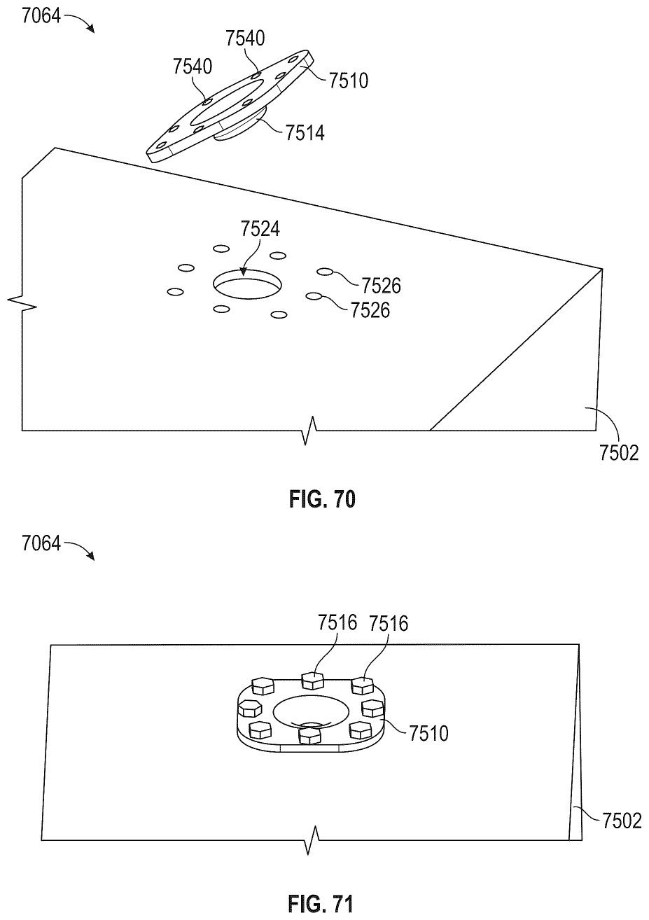

Referring to FIGS. 67-73, the batteries 64 may each include a housing 7502 (e.g., a shell, a structure, a modular unit, walls, sidewalls, an enclosure, a container, a capsule, a cover, a case, a covering, casing, a hull, etc.), that defines an inner volume 7508 (e.g., a space, a void, an area, etc.) within which one more cells 7504 (e.g., battery cells, energy storage cells, alkaline cells, lithium ion cells, etc.) are positioned. The cells 7504 may be electrically coupled (e.g., via wiring) with one or more terminals 7506 (e.g., a positive terminal 7506a and a negative terminal 7506b) that are accessible from an exterior of the housing 7502 in order to discharge electrical energy for devices (e.g., actuators, motors, etc.) that consume electrical energy in order to operate (e.g., electrical components of the lift device 10). In some embodiments, the batteries 64 each include a connector or power connector such that the cells 7504 of the batteries 64 can be quickly electrically coupled or de-coupled with other batteries 64 of the lift device 10 or with an energy distribution and discharge system of the lift device 10. The batteries 64 may be high-voltage or low-voltage batteries 64 configured to supply electrical energy for one or more high-voltage or low-voltage electrical devices of the lift device 10.

Referring particularly to FIGS. 67-71, the battery 64 may include a cap (e.g., a cover, a stopper, a lid, a top, a plug, etc.), shown as manual discharge member 7510. The manual discharge member 7510 may be a structural member that functions to both initiate a manual discharge and as a housing member that seals with the housing 7502 and forms or defines a portion of the housing 7502. In some embodiments, the manual discharge member 7510 is a removable, adjustable, repositionable, or re-orientable portion or member of the housing 7502. The manual discharge member 7510 is configured to removably couple with the housing 7502 in a first position (e.g., a first state) or orientation where the manual discharge member 7510 functions as a portion of the housing 7502, and a second position or orientation where the manual discharge member 7510 functions to initiate a complete discharge of the cells 7504 (e.g., a closed state or position, a second state). In some embodiments, the manual discharge member 7510 is positioned over an opening 7524 (e.g., a hole, a window, an aperture, a bore, a space, etc.) and is configured to be fastened to the housing 7502 via one or more fasteners 7516 and openings 7526 that are formed or define in the housing 7502 and disposed in an array or pattern surrounding the opening 7524. In some embodiments, the manual discharge member 7510 includes corresponding openings 7540 that are configured to receive the fasteners 7516 therethrough such that the manual discharge member 7510 can be fastened to the housing 7502 over the opening 7524.

Referring particularly to FIGS. 67, 68 and 77, the manual discharge member 7510 may have the form of a plate or planar member, shown as plate 7512 having a first side 7518, and a second side 7520 (e.g., a first and second surface, a first and second face, opposing faces or surfaces, opposing sides that are offset from each other, etc.). In some embodiments, the manual discharge member 7510 has a generally square or rectangular shape with rounded corners. In some embodiments, the manual discharge member 7510 has a circular or elliptical shape. The manual discharge member 7510 includes a protrusion 7514 (e.g., an extension, geometry that extends outwards, etc.) that extends from the second side 7520, according to some embodiments. The protrusion 7514 may extend a distance from the second side 7520. In some embodiments, the protrusion 7514 is positioned centrally on the second side 7520. The protrusion 7514 may be configured to engage an internal member of the battery 64 in order to initiate discharge of the cells 7504. When the manual discharge member 7510 is in the first position or orientation, the first side 7518 of the manual discharge member 7510 faces or contacts the housing 7502 and the protrusion 7514 faces outwards. When the manual discharge member 7510 is in the second position or orientation, the second side 7520 of the manual discharge member 7510 faces or contacts the housing 7502 such that the protrusion 7514 extends through the opening 7524 and is received within the inner volume 7508 of the housing 7502. In some embodiments, the manual discharge member 7510 may be maintained in the first position over a lifetime of the battery 64, and when complete discharge or manual discharge of remaining energy in the cells 7504 is desired (e.g., at an end of the life of the battery 64), the manual discharge member 7510 may be flipped over such that the protrusion 7514 extends into the inner volume 7508 of the housing 7502 (e.g., the second position or orientation) in order to initiate the discharge or depletion of the remaining energy in the cells 7504 for safe handling of the battery 64.

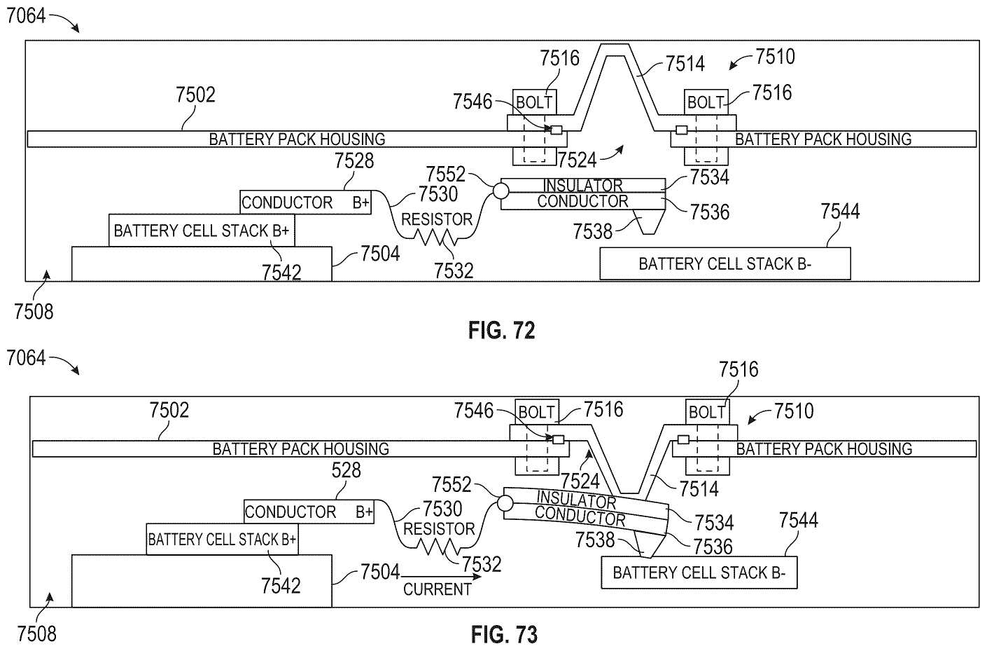

Referring particularly to FIGS. 72-73 and 74-75, the manual discharge member 7510 is shown in the first position (shown in FIG. 72) and the second position (shown in FIG. 73), according to some embodiments. When the manual discharge member 7510 is in the first position as shown in FIG. 72, the protrusion 7514 extends outwards from the housing 7502. As shown in FIGS. 72 and 73, the battery 64 includes a seal 7546 (e.g., an O-ring a flexible member, a sealing member, etc.) positioned between the manual discharge member 7510 and the housing 7502. The seal 7546 facilitates sealing between the manual discharge member 7510 and the housing 7502 when the manual discharge member 7510 is in the first position or the second position. In some embodiments, the seal 7546 is compressed between the manual discharge member 7510 and the housing 7502 when the manual discharge member 7510 is installed and fastened onto housing 7502. The seal 7546 facilitates maintaining integrity of the inner volume 7508 and reduces a likelihood that moisture may leak into the inner volume 7508 of the housing 7502.

Referring still to FIGS. 72 and 73, the battery 64 includes a positive internal terminal 7542 of the cells 7504 (e.g., a cathode) and a negative internal terminal 7544 (e.g., a ground). In some embodiments, the battery 64 includes a conductor 7528 (e.g., an electrically conductive element) that is coupled with (e.g., directly contacts with) the positive internal terminal 7542 such that the conductor 7528 can define an electrical energy flow path (e.g., a discharge path). The battery 64 also includes a wire 7530 (e.g., a cable, a cord, a copper wire, a conductive element, etc.) including a resistor 7532. The battery 64 also includes an adjustable conductive assembly including a conductor 7536, an insulator 7534, and a conductive tip 7538 (e.g., a conductive protrusion, a bump, etc.). The wire 7530 may electrically couple with the conductor 7536. In some embodiments, the wire 7530 is sandwiched between the insulator 7534 and the conductor 7536. The insulator 7534 may be provided on a first side of the conductor 7536 that faces the opening 7524. The conductive tip 7538 may be provided on a second side of the conductor 7536 proximate or facing the negative internal terminal 7544 (e.g., the ground, the anode or negative terminal of the battery cells 7504). In some embodiments, the insulator 7534 and the conductor 7536 are structurally secured relative to the housing 7502 of the battery 64 or relative to the cells 7504. For example, the insulator 7534 and the conductor 7536 may be fastened, secured, fixed, or rotatably coupled with the housing 7502 at a first end 7552 (e.g., a fixed end). In some embodiments, the insulator 7534, the conductor 7536, and the conductive tip 7538 have the form of a cantilever beam including a fixed and a free end.

Referring to FIGS. 72-73, the manual discharge member 7510 may be transitionable between the first position or orientation, shown in FIG. 72, and the second position or orientation, shown in FIG. 73. When the manual discharge member 7510 is transitioned into the second position or orientation, shown in FIG. 73, the protrusion 7514 of the manual discharge member 7510 is configured to contact, abut, or directly engage the insulator 7534 and thereby drive deflection or movement of the conductor 7536 such that the conductive tip 7538 contacts, abuts, directly engages, etc., the negative internal terminal 7544. When the conductive tip 7538 contacts the negative internal terminal 7544, electrical current flows between the positive internal terminal 7542 and the negative internal terminal 7544, through the conductor 7528, the resistor 7532, the wire 7530, the conductor 7536, and the conductive tip 7538. In this way, the cells 7504 may discharge any remaining electrical energy (e.g., residual energy) until the cells 7504 are completely depleted of energy and the battery 64 can be properly disposed of. In some embodiments, the conductive tip 7538 may be bias into or out of engagement with the negative internal terminal 7544 by transitioning the manual discharge member 7510 between the first position or orientation (shown in FIG. 72) and the second position or orientation (shown in FIG. 73). In this way, the manual discharge member 7510 may be transitionable between the first position or orientation and the second position or orientation in order to define an electrical flow path for discharge of the cells 7504 (e.g., to permanently and completely discharge the cells 7504). In some embodiments, the energy is dissipated at least partially as heat generated by transferring the remaining electrical energy through the resistor 7532.

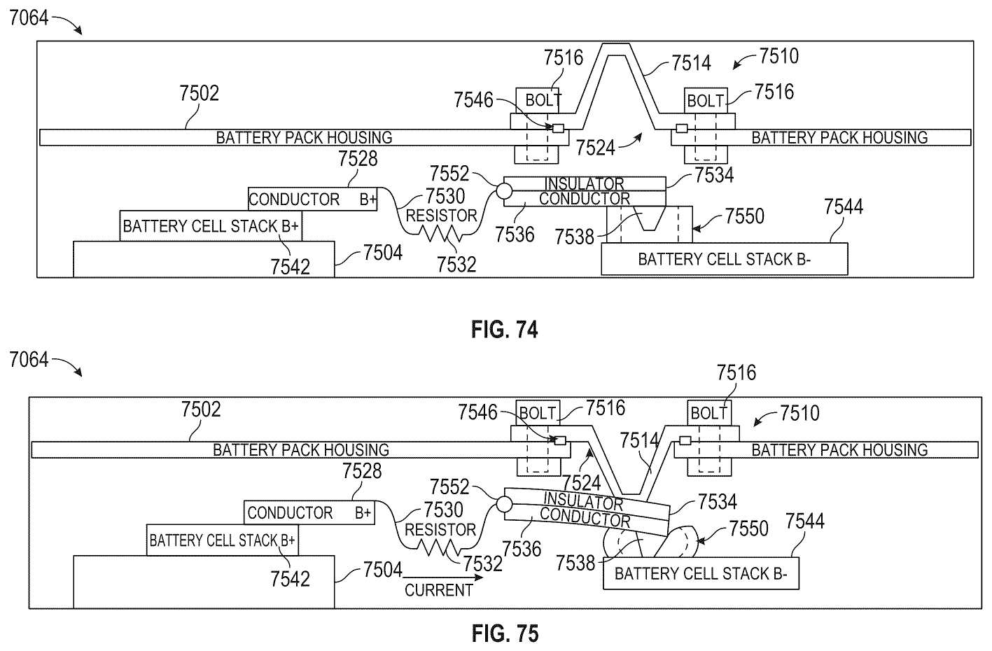

Referring to FIGS. 74 and 75, the battery 64 may also include a spacer 7550 (e.g., an insulator, a rubber member, a ring, a foam member, etc.). The spacer 7550 may have the form of a cylindrical or square member including a central opening within which the conductive tip 7538 is received. In some embodiments, the spacer 7550 is positioned on top of the negative internal terminal 7544. The spacer 7550 may reduce a likelihood that the conductive tip 7538 may accidentally engage or contact the negative internal terminal 7544 (e.g., accidental shorting or discharge). In some embodiments, the spacer 7550 is configured to compress and allow the conductive tip to engage the negative internal terminal 7544 when the manual discharge member 7510 is transitioned from the first orientation to the second orientation as shown in FIGS. 74-75.

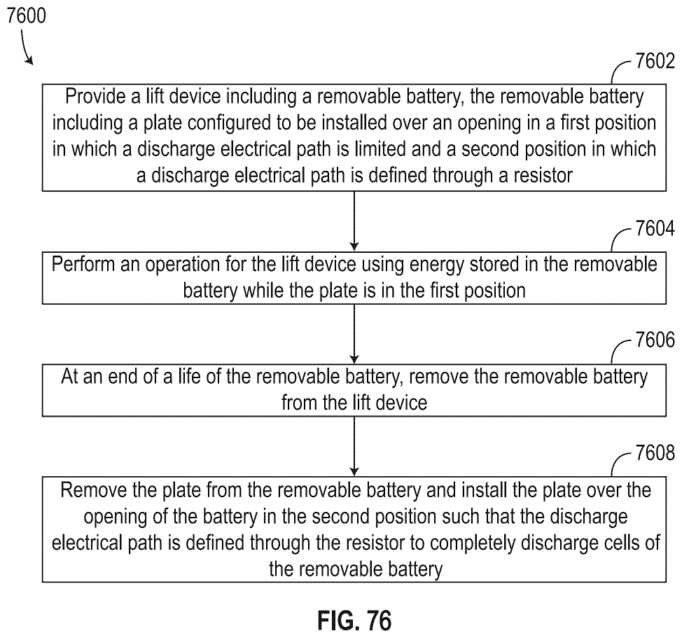

Referring to FIG. 76, a flow diagram of a process 7600 for manually discharging or completely depleting a battery of a lift device or other electrical machine includes steps 7602-7608, according to some embodiments. In some embodiments, the process 7600 is a method for decommissioning a battery at an end of its useful life. In some embodiments, steps 7602-7608 can be performed to use the battery for one or more functions (e.g., to power an electrical load such as lighting devices, electric motors, electric linear actuators, etc.) during a lifetime of the battery, and to permanently discharge (e.g., completely discharge or deplete cells of the battery) the battery at an end of a life of the battery. Advantageously, the process 7600 facilitates improved handling and disposal of batteries that have reached an end of their useful life.

The process 7600 includes providing a lift device including a removable battery, the removable battery including a plate configured to be installed over an opening in a first position (e.g., an open state) in which a discharge electrical path is limited and a second position in which a discharge electrical path is defined through a resistor (step 7602), according to some embodiments. In some embodiments, the lift device is the lift device 10 and the removable battery is one of the batteries 64 as described in greater detail above with reference to FIGS. 63-75. In some embodiments, the battery is a quick connect or disconnect battery. In other embodiments, the battery is fastened or secured on the lift device and is intended only to be removed during servicing operations of the lift device. The plate may be the manual discharge member 7510 which is coupleable (e.g., fastenable) on the housing 7502 of the removable battery in either the first position or orientation or the second position or orientation as described in greater detail above with reference to FIGS. 72-73 and 74-75.

The process 7600 includes performing an operation for the lift device using energy stored in the removable battery while the plate is in the first position (step 7604), according to some embodiments. In some embodiments, step 7604 is performed repeatedly over a lifetime of the removable battery. Step 7604 may include any charging or discharging operations of the removable battery. For example, the battery may discharge electrical energy to one or more electrical loads of the lift device 10 to perform driving operations, lifting operations, lighting operations, leveling operations, etc. The battery may be charged at appropriate intervals. Over a lifetime of the removable battery, one or more of the cells that store, receive, and discharge energy may degrade, thereby reducing an effectiveness of the removable battery (e.g., degradation due to usage of the cells). In some embodiments, step 7604 is performed by the electric motor 52, the actuators 34, or any other electrical components of the lift device 10 using energy provided by the removable battery.

The process 7600 includes, at an end of a life of the removable battery, removing the removable battery from the lift device (step 7606) and removing the plate from the removable battery, and re-installing the plate over the opening of the battery in the second position such that the discharge electrical path is defined through the resistor such that the cells of the removable battery completely discharge any remaining energy (step 7608), according to some embodiments. In some embodiments, steps 7606 and 7608 are performed by a technician. When the technician removes the plate and re-installs the plate in the second position, a positive terminal of the cells of the removable battery may be grounded through a resistor such that any remaining energy in the cells (e.g., residual energy) is completely depleted and at least partially converted into heat by the resistor. The discharge electrical path can be defined using any configuration of components as described in greater detail above with reference to FIGS. 72-73 and 74-75.

It should be understood that while the process 7600 as described herein is described as being useful at an end of a life of a battery, the process 7600 can also be performed for any battery that is to be transported (e.g., damaged batteries, defective batteries, end-of-life batteries, or any other battery that should be fully discharged). Advantageously, the techniques described herein with reference to FIGS. 67-75 facilitate complete discharge of batteries of battery packs that may have a high voltage (e.g., 7300 volts or greater across the terminals). The opening 7524 in the housing 7502 of the battery 64 may also provide access to measure cell stack voltage with a volt meter in order to confirm that the cells 7504 of the battery 64 have been fully discharged or depleted.

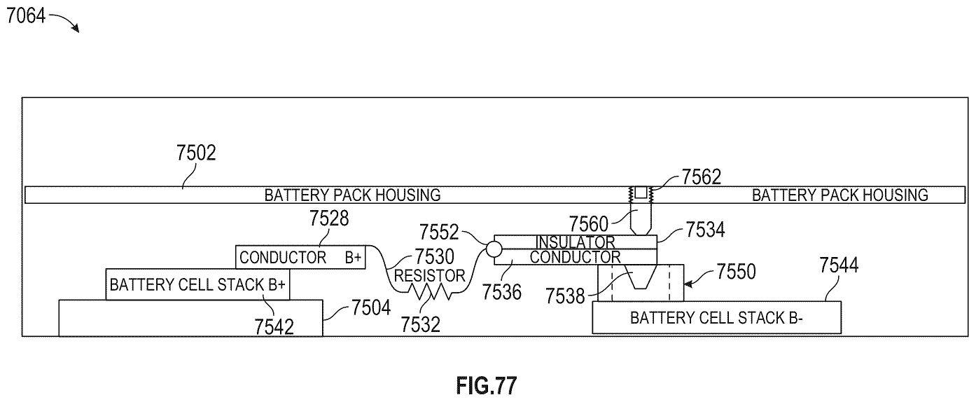

Referring to FIG. 77, the conductor 7536 or the conductive tip 7538 may otherwise be driven into engagement with the negative internal terminal 7544 such as by a screw 7560 (e.g., a grub screw) that is received through an opening 7562 in the housing 7502. In some embodiments, the screw 7560 is sub-flush with an exterior surface of the housing 7502. The screw 7560 may be threadingly coupled with an inner surface of the housing 7502 such that the screw 7560 can be driven (e.g., by a technician) to engage the insulator 7534 and translate, bend, rotate, or deform the conductor 7536 into engagement with the negative internal terminal 7544 (e.g., at the conductive tip 7538). In some embodiments, the conductor 7536 is otherwise driven to contact or electrically couple with the negative internal terminal 7544 in order to discharge or deplete the cells 7504. Advantageously, the systems and methods described herein with reference to FIGS. 67-76 facilitate an internal mechanism for discharging the cells 7504 of the battery 64.

### Rotary Sensor Mount

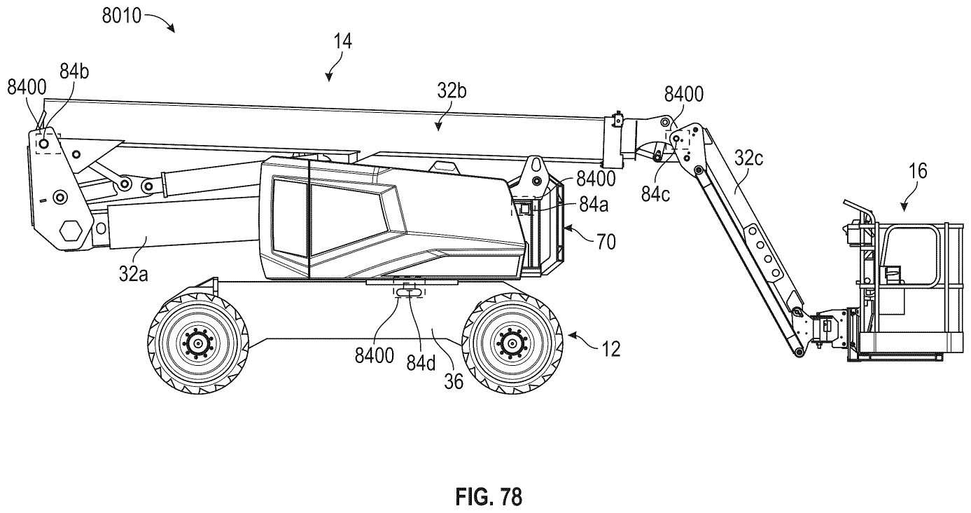

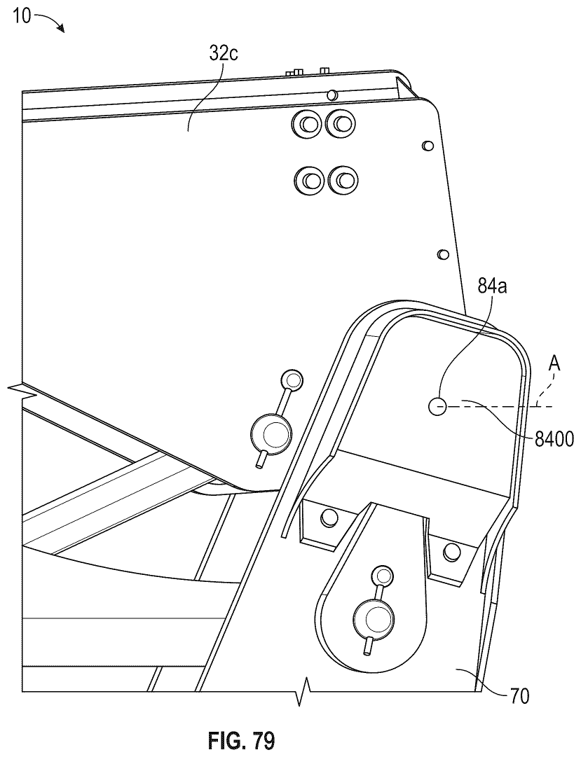

Referring to FIG. 78, a side view of the lift device 10 is shown according to an exemplary embodiment. The lift device 10 includes a base assembly 12 including a base 36, and a turntable 70 rotatably coupled to the base 36 about pivot point 84d. A lift assembly 14 is coupled to the turntable 70 and configured to position the platform 16. The lift assembly 14 includes lift arms 32a, 32b, and 32c which are rotated by one or more actuators (e.g., actuators 34a, 34b, 34c, and 34d) relative to each other and the base assembly 12 about the pivot points 84a-84c. The lift device 10 includes one or more rotary angle sensors shown as sensors 8400 configured to measure a rotation of one of the lift arms 32a, 32b, or 32c, or the turntable 70, respectively. In some embodiments, the sensor 8400 is configured to measure a rotation of the lift arm 32a relative to the turntable 70 or a tower arm of the turntable 70. In some embodiments, the sensor 8400 is configured to measure a rotation of the lift arm 32b relative to the lift arm 32a. In some embodiments, the sensor 8400 is configured to measure a rotation of the lift arm 32c relative to the lift arm 32b. In some embodiments, the sensor 8400 is configured to measure the rotation of the turntable 70 relative to the base 36. The sensor 8400 can be used at any rotatable joint or coupling of the lift device 10. For example, the sensor 8400 can measure the rotation at any rotating pin-joint in the lift device 10, and in some embodiments multiple sensors 8400 may be used to measure multiple pivot points and rotatable joints or couplings.

Referring to FIG. 79, a perspective view of a pivot point 84 is shown, according to an exemplary embodiment. A portion of the turntable 70 shown as a tower boom is rotatably coupled to the lift arm 32a a rotatable axis shown as axis A. A sensor 8400 is positioned axially on axis A to measure the rotation of the lift arm 32a relative to the turntable 70. The sensor 8400 may be mounted on either rotatable segment of a joint. For example, referring still to FIG. 79, the sensor 8400 can be mounted to the tower arm of turntable 70 or to the lift arm 32c.

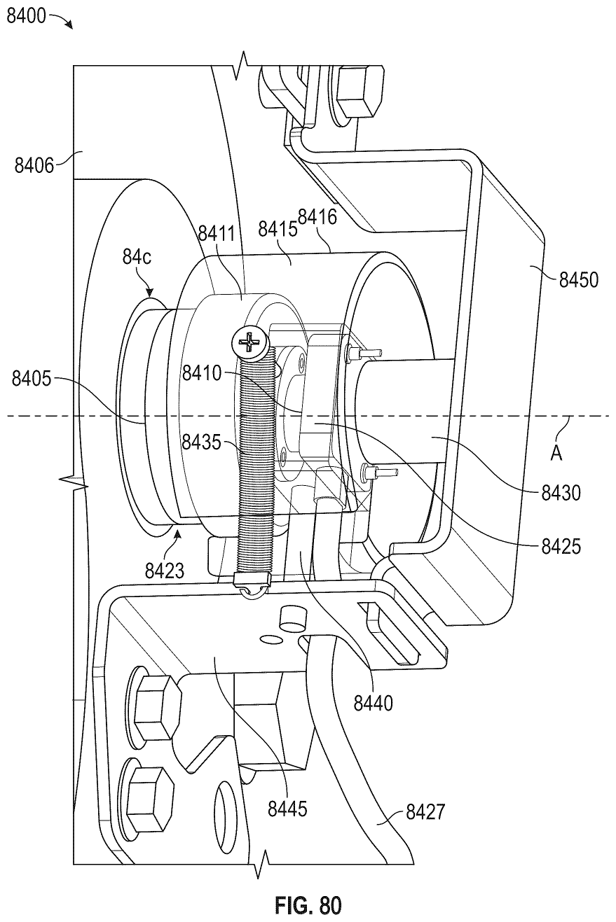

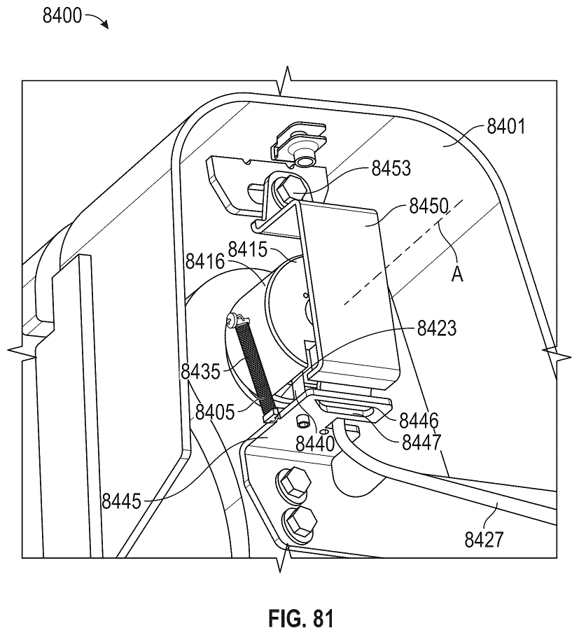

Referring now to FIGS. 80 and 81, a perspective view of an interior of the sensor 8400 is shown, according to an exemplary embodiment. Pivot point 84a includes a rotating member (e.g., pin, rod, axle, shaft, etc.) shown as pin 8405 that rotates around the axis A. The pin 8405 extends into a housing 8401 of the sensor 8400. The pin 8405 is fixedly coupled to the rotating element being tracked (e.g. lift arm 32a-32c) such that the rotation of the rotating element corresponds with the rotation of the pin 8405 about the axis A. Coupled to the pin 8405 is a tracked element (e.g., magnet, visual marker, etc.) shown as sensor magnet 8410. Sensor magnet 8410 can be a sensor magnet 8410 for a Hall effect sensor. In some embodiments, the sensor magnet 8410 is coupled to the pin 8405 via an adapter, shown as adaptor 8411. The adaptor 8411 may be fixedly coupled to the pin 8405 such that the adaptor 8411 rotates with the pin 8405 and fixedly coupled to the sensor magnet 8410 such that the rotation of the sensor magnet 8410 corresponds to the rotation of the pin 8405. Beneficially, the adaptor 8411 can couple to pins of various sizes while standardizing the mounting surface for the sensor magnet 8410. In some embodiments, this lets the sensor 8400 be installed on a variety of pin-joints. In other embodiments, the sensor magnet 8410 may be directly coupled to the end of the pin 8405.

Referring still to FIGS. 80 and 81, a sensor mount, shown as mounting cup 8415, receives the end of the pin 8405 including the sensor magnet 8410 and the adaptor 8411, if present. The mounting cup 8415 receives the end of the pin 8405 while still letting the pin 8405 rotate relative to the mounting cup 8415. The mounting cup 8415 is positioned axially along the axis A and rotate independent of the pin 8405. The mounting cup 8415 is circular. In some embodiments, the mounting cup 8415 is another shape and may have one or more planar sides.

A sensor (e.g., Hall effect sensor, camera, etc.) shown as magnetic sensor 8425 is supported within the mounting cup. The magnetic sensor 8425 is positioned axially along the axis A collinearly with the pin 8405 and the sensor magnet 8410. The magnetic sensor 8425 may be coupled to the mounting cup 8415 using one or more screws, fasteners, clips, adhesives, etc. The mounting cup 8415 positions the magnetic sensor 8425 both axially and radially relative to the sensor magnet 8410. Rotary sensors can suffer from large angle errors based on several factors such as an improper axial distance or airgap between the sensed element (i.e., the sensor magnet 8410) and the sensor (i.e., the magnetic sensor 8425), an angular misalignment between a plane of the sensed element and the sensor, or a radial misalignment between the axis of sensed element and the sensor. The mounting cup 8415 receives the end of the first pin 8405 ensuring the axes of the sensor magnet 8410 and the magnetic sensor 8425 are aligned, while the magnetic sensor 8425 mounting position within the mounting cup 8415 ensures the planes of the sensor magnet 8410 and the magnetic sensor 8425, as well as the axial distance between them, are fixed. A wire, shown as wire 8427 electrically coupling the magnetic sensor 8425 to the lift device 10 exits the mounting cup 8415 via the a gap 8423 in a rim of the mounting cup 8415.

While shown with the sensor magnet 8410 coupled to the pin 8405 to rotate relative to the magnetic sensor 8425, in some embodiments the magnetic sensor 8425 is coupled to the pin 8405 to rotate relative to the sensor magnet 8410.

Referring still to FIGS. 80 and 81, a force exerting member (e.g., a resilient member, an actuator, etc.) shown as first spring 8430 is positioned between the mounting cup 8415 and a bracket 8450. When positioned between the mounting cup 8415 and the bracket 8450, the first spring 8430 is compressed and exerts an axial force substantially parallel and colinear with the axis A to push the mounting cup 8415 against the pin 8405, or the adaptor 8411 if present. The compression force provided by the first spring 8430 helps to ensure the mounting cup 8415 stays in contact with the pin 8405 as the pin rotates. The compression force also makes sure the airgap between the sensor magnet 8410 and the magnetic sensor 8425 remains relatively constant. In some embodiments, additionally and/or alternatively to the first spring 8430, a resilient member including an expandable foam is added to exert the axial force against the mounting cup 8415 onto the pin 8405.

A second force exerting member, shown as second spring 8435 is coupled to an outer lateral surface of the mounting cup 8415, shown as exterior 8416. An opposing end of the second spring 8435 is fixedly coupled to an anchor point such as the turntable 70, the sensor housing 8401, or the bracket 8450. The second spring 8435 exerts a pulling force on the mounting cup 8415 offset from the axis A by a moment arm equal to a radius of the mounting cup 8415, such that the second spring 8435 exerts a rotational force on the mounting cup 8415 about the axis A. The rotational force exerted by the second spring 8435 acts to counteract any rotation imparted to the mounting cup 8415 by the pin 8405 or the adaptor 8411. Due to the first spring 8430 applying a compression force to seat the mounting cup 8415 on the pin 8405 or the adaptor 8411, friction between the rotating pin 8405 and the mounting cup 8415 may impart a small rotational force on the mounting cup 8415. The force exerted by the second spring 8435 resists the rotational force due to the pin 8405 by pre-loading or biasing the mounting cup 8415. In some embodiments, the compressive force and the rotational force are provided by more or fewer force exerting members. For example, in some embodiments the first spring 8430 is an open-wound torsion spring which can provide both the compressive force between the mounting cup 8415 and the bracket 8450 as well as the rotational force to resist the rotational forces acting on the mounting cup 8415, and the second spring 8435 may not be included.

To prevent rotation of the mounting cup 8415 based on the pre-loading of the second spring 8435, a fixed, non-rotatable member (e.g., pin, rod, plate, etc.) shown as rod 8440 extends at least partially into the mounting cup 8415 via the gap 8423. At first, as the second spring 8435 is loaded it exerts a tension force downward on the mounting cup 8415. The rod 8440 engages with a wall of the gap 8423 and prevents the mounting cup 8415 from rotating. In some embodiments, a different braking mechanism can prevent rotation of the mounting cup 8415. For example, an inelastic wire or cord can be coupled to the mounting cup 8415 and fixed at the other end such that the second spring 8435 rotates the mounting cup 8415 until the inelastic cord is taunt. Still, in other embodiments, a rack and pinion or any other mechanism for inhibiting partial or complete rotation (e.g., 360 degrees) of the mounting cup 8415 may be used. In other embodiments, a shoulder bolt or a wedge may be used.

Referring still to FIGS. 80 and 81, second spring 8435 may be coupled to a first part of the bracket 8450, shown as first part 8445. The first part 8445 may also include a cutout or aperture to let the wire 8427 pass through. In some embodiments, the first part 8445 includes a second cutout, aperture or hole, shown as aperture 8446 to receive a clip end of the bracket 8450, shown as tab 8447. At an opposing end, the bracket 8450 is coupled to the sensor housing 8401 by a fastener, shown as bolt 8453. The bracket 8450 is removed by removing the bolt 8453 so the bracket 8450 is free at one end and removing the tab 8447 from the aperture 8446. In some embodiments, the bracket 8450 and first part 8445 may be made out of an elastic material (e.g., aluminum, steel, plastic, etc.) such that the first part 8445 can be pulled off the tab 8447 to release the bracket 8450. Upon releasing the bracket 8450, the first spring 8430 is also released and the mounting cup 8415 no longer experiences the first force to seat the mounting cup 8415 to the pin 8405. The bracket 8450 may act as backstop to one or more force exerting members (i.e., resilient members) exerting a force on the mounting cup 8415.

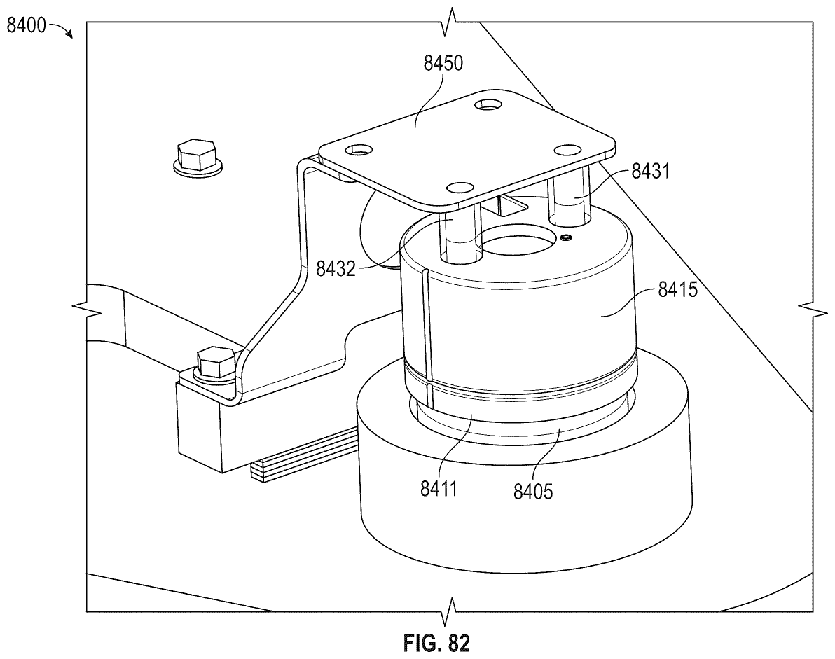

Referring now to FIG. 82, in some embodiments the sensor 8400 includes two compression springs 8431 and 8432 between the bracket 8450 and the mounting cup 8415. The compression springs 8431 and 8432 can prevent rotation of the mounting cup 8415 and help to ensure the mounting cup 8415 stays in contact with the pin 8405 as the pin rotates. The compression force also makes sure the airgap between the sensor magnet 8410 and the magnetic sensor 8425 remains relatively constant. Due to friction between the rotating pin 8405 and the mounting cup 8415 a small rotational force can be imparted on the mounting cup 8415. In addition to providing a compressive force, the springs 8431 and 8432 can counteract the rotational forces acting on the mounting cup 8415 to hold it in a generally stationary position. The springs 8431 and 8432 have an inherent resistance to buckling and thereby resist the rotational forces acting the mounting cup 8415. In such embodiments, the second spring 8435 may be excluded, and all rotational resistance provided by the springs 8431 and 8432.

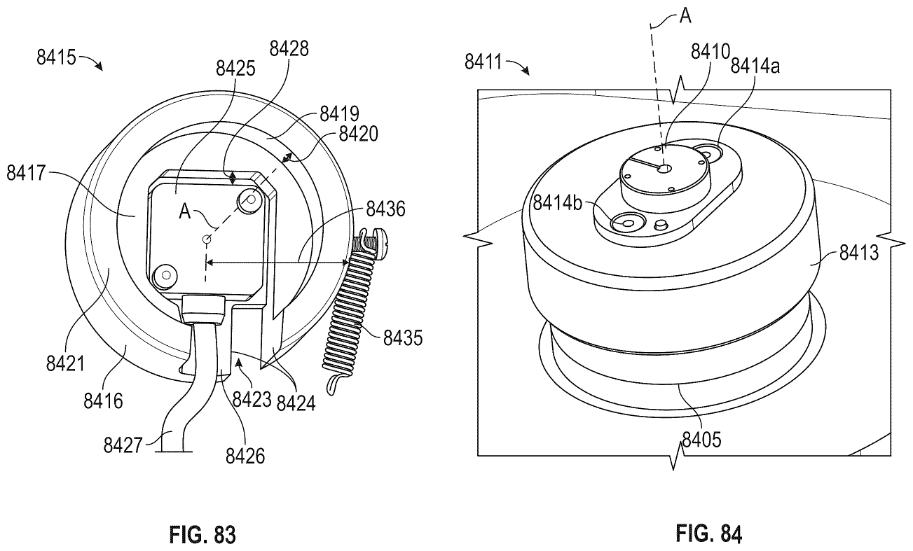

Referring now to FIG. 83, the mounting cup 8415 is shown, according to an exemplary embodiment. The mounting cup 8415 includes an outer lateral surface shown as exterior 8416. The magnetic sensor 8425 is coupled to a sensor mounting surface 8426. The mounting cup 8415 includes a second, intermediate surface, shown as engagement surface 8417. The engagement surface 8417 is offset along the axis A from the sensor mounting surface 8426 a distance 8428. Extending around the perimeter of the mounting cup 8415 is an outer rim, shown as rim 8421. Rim 8421 is offset along the axis A from the engagement surface a distance 420. The inner lateral wall of the rim 8421 is shown as the horizontal engagement surface 8419. The rim 8421 includes a gap, cutout, notch, etc., shown as gap 8423. The gap 8423 allows a wire 8427 extending from the magnetic sensor 8425 to exit the mounting cup 8415. The gap 8423 also provides vertical surfaces 424. The vertical surfaces 424 engage with the rod 8440 to prevent the mounting cup 8415 from rotating greater than the arc length of the gap 8423. The second spring 8435 is shown coupled to an exterior 8416 of the mounting cup a distance 8436 from the axis A and a center of the magnetic sensor 8425.

Referring now to FIG. 84, the pin 8405 is shown, according to an exemplary embodiment. The pin 8405 is coupled to the adaptor 8411. The adaptor 8411 is shaped to correspond to the inner perimeter of the rim 8421 of the mounting cup 8415, such that the adaptor can be received within the mounting cup 8415. The adaptor 8411 and the mounting cup 8415 can be any pair of corresponding shapes. The adaptor 8411 includes a vertical engagement surface, shown as vertical engagement surface 8412 and a horizontal engagement surface shown as the outer lateral surface 8413. The sensor magnet 8410 is coupled to the adaptor 8411 at the vertical engagement surface 8412 by one or more fasteners, shown as fasteners 8414a and 8414b. The sensor magnet 8410 is positioned to be axially aligned with the axis A of the pin 8405. In other embodiments, the sensor magnet 8410 is mounted to any one or more surfaces of the adaptor 8411, such that the sensor magnet 8410 position is maintained at an appropriate distance from the magnetic sensor 8425.

Referring now to FIGS. 83 and 84, when the mounting cup 8415 receives the adaptor 8411 and the sensor magnet 8410, the engagement surface 8417 of the mounting cup 8415 abuts or is adjacent to the vertical engagement surface 8412 of the adaptor 8411. The engagement surface 8417 and the vertical engagement surface 8412 are substantially parallel, such that the surfaces prevent angular misalignment between magnetic sensor 8425 in the mounting cup 8415 and the sensor magnet 8410. When the mounting cup 8415 receives the adaptor 8411 and the sensor magnet 8410, the horizontal engagement surface 8419 of the sensor mount abuts or is adjacent to the outer lateral surface 8413 of the adaptor 8411. The horizontal engagement surface 8419 and the outer lateral surface 8413 are substantially parallel, such that the horizontal engagement surface 8419 retains the adaptor 8411 axially along the axis A and the magnetic sensor 8425 is maintained in a concentric position relative the pin 8405.

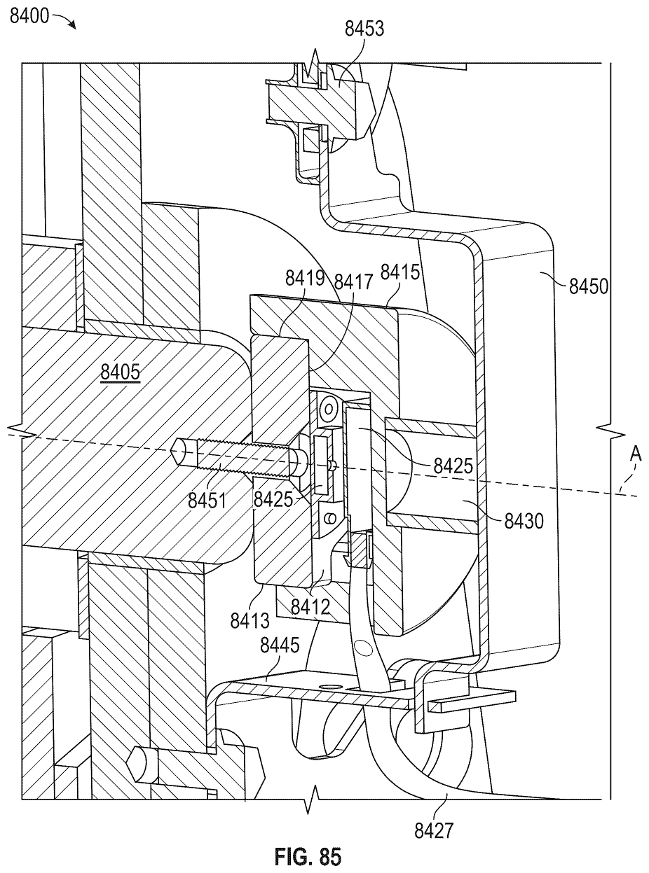

Referring now to FIG. 85, the adaptor 8411 is coupled to the pin 8405 via a fastener, screw, bolt, etc. shown as screw 8451. Screw 8451 is threaded into the pin 8405 and threaded into the adaptor 8411 to retain the adaptor and fixedly couple it to the pin 8405.

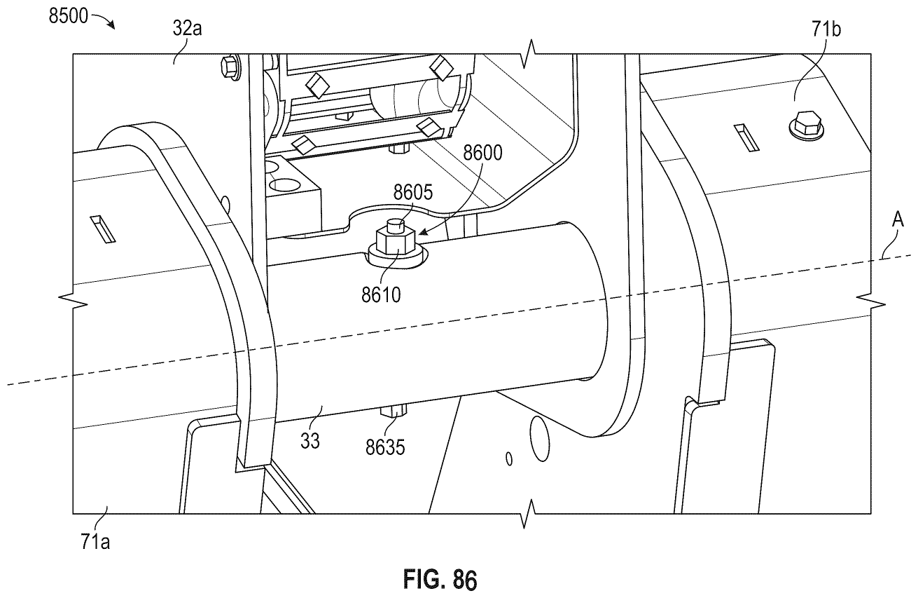

Referring now to FIGS. 86-88, a perspective view of a pin-joint 8500 is shown, according to an exemplary embodiment. The pin-joint 8500 can correspond to one or more of the pivot points 84a-84c of the lift device 10. The pin-joint 8500 includes a fork, shown as fork with a first fork arm and a second fork arm shown as first fork arm 71a and second fork arm 71b. The first fork arm 71a and the second fork arm 71b are spaced apart to form a gap to receive an eye 33 of a rotatable member (e.g., a lift arm), shown as lift arm 32a. The eye 33 is rotatable relative to the first fork arm 71a and the second fork arm 71b.

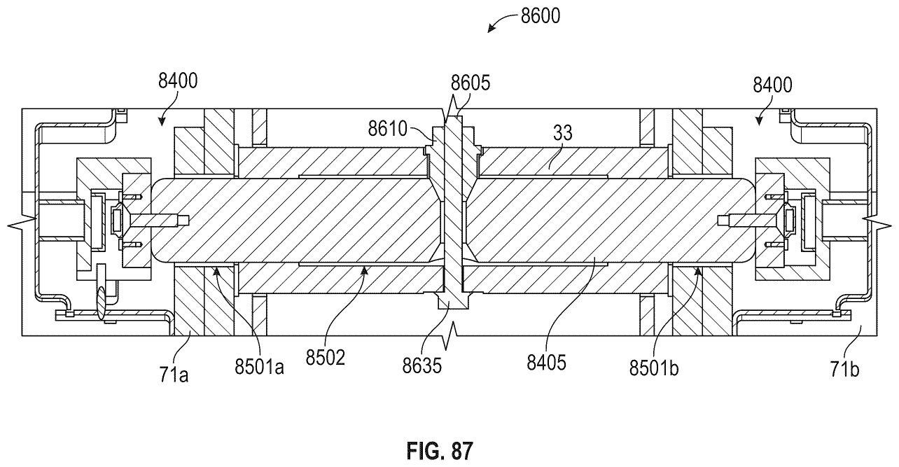

Referring particularly to FIG. 87, the first fork arm 71a, the second fork arm 71b and the eye 33 include concentric apertures 8501a, 8501b, and 8502 to receive the pin 8405. The pin 8405 extends through the aperture 8502 of the eye 33 and through each aperture 8501a and 8501b into individual sensors 8400 at each end of the pin 8405. The pin 8405 is fixedly coupled to the eye 33 by a bolt, shown as a threaded bolt 8605. The threaded bolt 8605 fixes the pin 8405 to the eye 33 such that rotation of the eye 33 rotates the pin 8405.

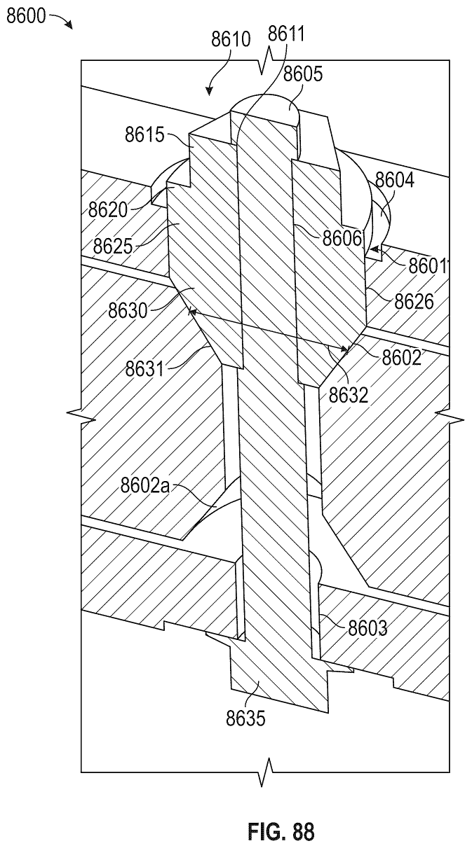

Referring particularly to FIG. 88, the bolt assembly 8600 includes a threaded bolt 8605. The bolt 8605 is retained in a tapered cone, shown as cone 8610. The cone 8610 includes a flange, rim or stop, shown as flange 8620. Extending from the flange 8620 away from the pin 8405 is a head, shown head 8615. The head 8615 may be a hex head, however the head 8615 may have any number of planar or non-planar surface for driving the cone 8610. Extending away from the flange 8620 opposite the head 8615 is the cone 8610 includes a threaded lateral surface, shown as intermediate portion 8625 with threads 8626. Extending away from the intermediate portion 8625 is a tapered end of the cone 8610, shown as taper 8630. A diameter 8632 of the taper 8630 decreases as the taper 8630 extends away from the intermediate portion 8625. In some embodiments, the taper 8630 extends entirely around the cone 8610. In other embodiments, the taper extends around only a portion of the cone 8610.

The bolt 8605 passes through a threaded central aperture of the cone 8610 shown as aperture 8611, which extends through the head 8615, the flange 8620, the intermediate portion 8625, and the taper 8630. The bolt 8605 also passes through the first threaded aperture 8601 of the eye 33, a tapered aperture 8602 of the pin 8405, and a second aperture 8603 of the eye 33. The threads of the bolt 8605 engage with internal threads 8606 of the central aperture 8611 of the cone 8610 to secure the bolt 8605 with the cone 8610. When the cone 8610 is inserted in the first threaded aperture 8601, external threads 8626 of the cone engage with the internal threads of the first threaded aperture 8601 until the flange 8620 of the cone 8610 engages with a rim of the first threaded aperture 8601, shown as rim 8604, to seat the cone 8610.

Still referring to FIG. 88, as the cone 8610 is threaded into the eye 33, a tapered surface 8631 of the taper 8630 of the cone 8610 engages with a corresponding taper of tapered aperture 8602 of the pin 8405. The taper 8630 and the corresponding tapered aperture 8602 are parallel or substantially parallel and concentric or substantially concentric with a longitudinal axis of the bolt 8605. The cone 8610 is fixedly coupled to the eye 33. For example, the cone 8610 is threaded into the first threaded aperture 8601 until the flange 8620 and the taper 8630 engage the rim 8604 and the tapered aperture 8602, respectively. In other embodiments, the cone 8610 may be welded, glued, or otherwise removably coupled or permanently coupled to the eye 33. An end of the bolt 8605 opposing the cone 8610 includes a bolt head 8635 for driving the bolt 8605 through the eye 33, the pin 8405 and into the threaded cone 8610. The bolt 8605 is threaded into the cone 8610 and engages with the internal threads 8606 to further secure the threaded cone 8610. In some embodiments, an additional nut is threaded onto the bolt 8605 opposite the bolt head 8635 to secure the bolt 8605 with the eye 33, the pin 8405, and the threaded cone 8610. In such embodiments, the internal threads 8606 of the cone 8610 may be excluded, and the bolt 8605 is solely retained with the nut on the bolt end opposing the bolt head 8635. In some embodiments, the external threads 8626 of the threaded cone 8610 are excluded, and the threaded cone 8610 is instead retained in place solely by the bolt 8605. In other embodiments, the bolt 8605 is excluded and the threaded cone 8610 is retained in place by the external threads 8626 of the threaded cone 8610 engaging with the first threaded aperture 8601.

Beneficially, the tapered cone 8610 reduces the relative motion between the eye 33 and the pin 8405. Reducing the relative motion or rotational backlash between the eye 33 and the pin 8405 improves the accuracy of rotary sensors such as the sensors 8400. In some embodiments, the pin 8405 includes an additional tapered aperture shown as tapered aperture 8602a, and a second cone 8610 is used opposite the first cone 8610. In some embodiments, multiple bolt assemblies 8600 are used axially along the axis A to secure the eye 33 with the pin 8405. While shown as separate components, in some embodiments, the bolt 8605 and the cone 8610 may be integrated into a single component.

In some embodiments, the tapered cone 8610 engages with the eye 33 via the threads 8626, without the use of the bolt 8605. In such embodiments, the taper 8630 of the cone may still engage with a corresponding taper of tapered aperture 8602 of the pin 8405.

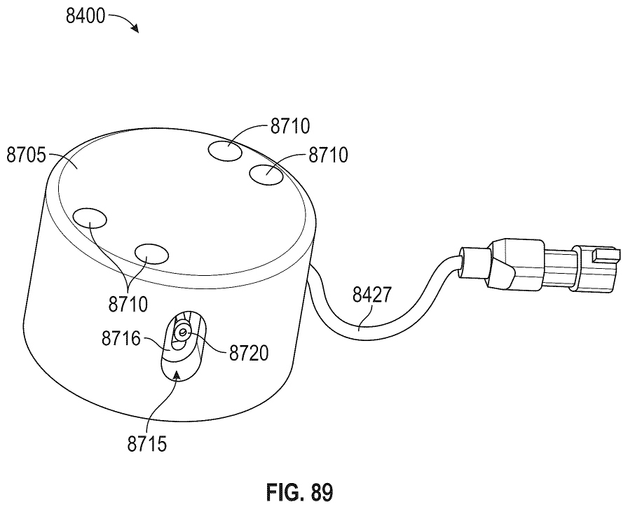

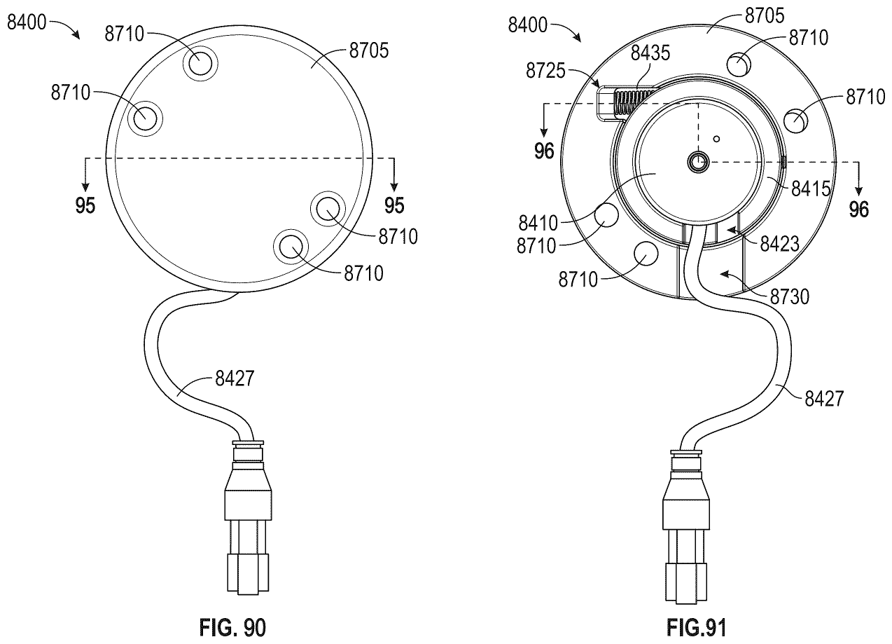

Referring now to FIGS. 89 and 90 the sensor 8400 is shown according to another embodiment. The sensor 8400 includes an external cup or cover, shown as external cup 8705. The external cup 8705 partially surrounds the mounting cup 8415 as shown in FIG. 91. A bottom of the external cup 8705 is open to allow for the external cup 8705 to be slid onto the mounting cup 8415. The external cup 8705 includes a plurality of slots 8710. The slots 8710 allow for one or more fasteners (e.g., bolts, screws, pins, or other fastening means) to couple the external cup 8705 to a lift device, such as at a pivot point 84. In some embodiments, the external cup 8705 replaces the bracket 8450, and holds the mounting cup 8415 in place as well as any force exerting members (i.e., resilient members) acting on the mounting cup 8415.

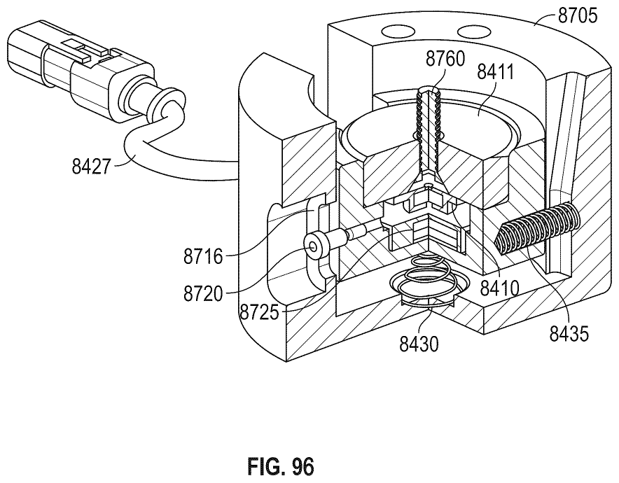

The external cup 8705 includes a hole, slot, or aperture, shown as slot 8715, extending at least partially along a vertical axis of the external cup 8705, from the open bottom end towards the closed top end. Extending from the slot 8715 is a shoulder bolt 8720, explained in further detail below with reference to FIGS. 93-96. The slot 8715 includes a sunken portion forming a ledge 8716, that extends only partially into the external cup 8705. The ledge 8716 surrounds the interior of the slot 8715 which extends entirely through the external cup 8705. In some embodiments, the slot is angled or jagged. In some embodiments, the slot 8715 includes one or more horizontal and/or one or more vertical portions. The external cup 8705 also includes an aperture to allow the wire 8427 to pass through.

Referring now to FIG. 91, a bottom view of the sensor 8400 of FIG. 89 is shown. The external cup 8705 is shown surrounding the mounting cup 8415. Within the mounting cup 8415 is the sensor magnet 8410. Behind the sensor magnet 8410 is the magnetic sensor 8425, for example as shown in FIGS. 80 and 85. The wire 8427 extends through a gap 8423 in the mounting cup 8415 and a gap 8730 in the external cup 8705.

As shown in FIG. 91, the external cup 8705 includes a cavity, shown as spring cavity 8725. Spring cavity 8725 extends from the inside of the external cup 8705 at least partially through the external cup 8705. Retained within the spring cavity 8725 is the second spring 8435. In the sensor 8400 shown in FIG. 91, rather than the second spring 8435 being coupled to the bracket 8450 as shown in FIG. 80, the second spring 8435 is coupled to the external cup 8705. When the external cup 8705 is secured to a pivot point of a lift device (e.g., pivot point 84) the external cup 8705 acts as a fixed point from which the second spring 8435 may act against. The external cup 8705 and the second spring 8435 thus act to prevent rotation of the mounting cup 8415 relative to the its mounting location and the sensor magnet 8410 (though the sensor magnet 8410 is free to rotate relative to the mounting cup 8415. While only a single spring cavity 8725 is shown, in some embodiments there may be multiple spring cavities 8725. For example, there may be opposing spring cavities. In some embodiments, the spring cavity 8725 may be curved. In some embodiments, the spring cavity 8725 may extend entirely through the external cup 8705 and the second spring 8435 is retained by a fastener coupled to an exterior of the external cup 8705.

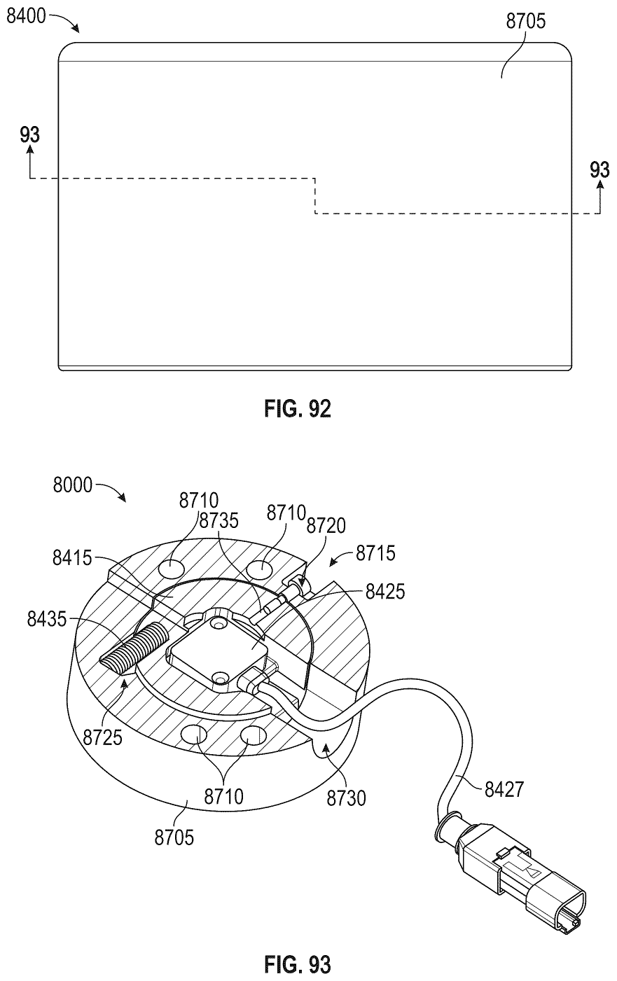

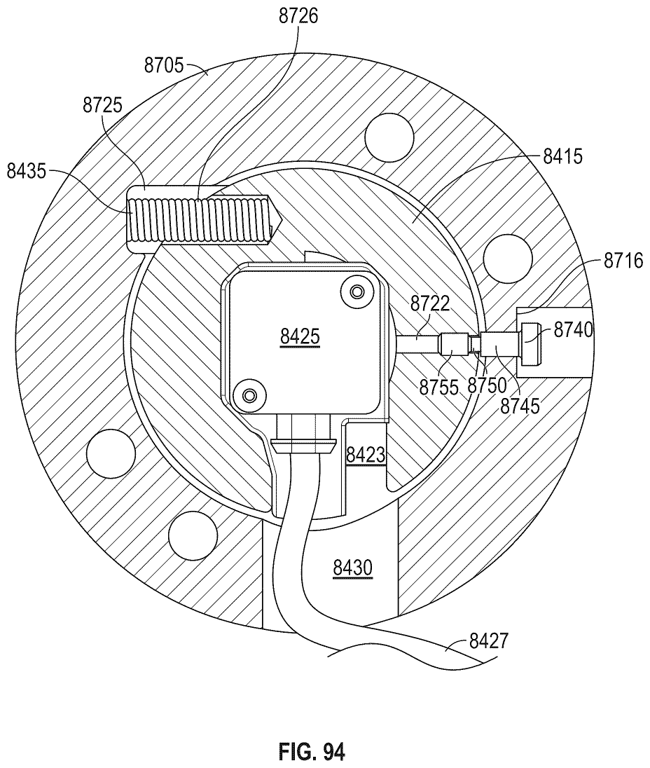

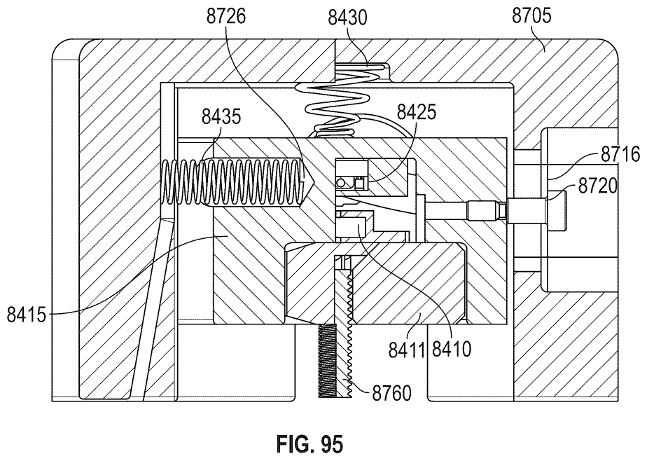

Referring to FIG. 92, a front of the sensor 8400 of FIG. 89 is shown, according to an embodiment. FIG. 93 is a section view of the sensor 8400 of FIG. 89 at the section line 93 shown in FIG. 92 and FIG. 94 is a top down view of the section view of FIG. 93.

Referring now to FIGS. 93 and 94, section 93 shows the slot 8715 of the external cup 8705 and the shoulder bolt 8720. The shoulder bolt 8720 passes through the slot 8715 of the external cup 8705 and into a slot or aperture, shown as slot 8735 of the mounting cup 8415. The shoulder bolt 8720 includes a head, shown as head 8740, adapted to receive one or more tools for installing the shoulder bolt 8720. Extending away from the head 8740 is an upper shoulder 8745. The upper shoulder 8745 is separate by a narrow portion shown as connection portion 8750 from a lower shoulder 8755. The lower shoulder 8755 may have a diameter less than a diameter of the upper shoulder 8745. The lower shoulder 8755 extends at least partially into the slot 8735. In some embodiments, the lower shoulder 8755 is threaded and is threadably coupled with the mounting cup 8415. The shoulder bolt 8720 acts to inhibit or limit rotation of the mounting cup 8415, and in turn the magnetic sensor 8425, relative to the external cup 8705, and in turn the lift device. In some embodiments, the shoulder bolt 8720 functions similarly to the rod 8440 discussed above. As one of the external cup 8705 or the mounting cup 8415 rotates relative to other of the external cup 8705 or the mounting cup 8415, the upper shoulder 8745 contacts the slot 8715 an and prevents any further rotation of the external cup 8705 relative to the mounting cup 8415. In some embodiments, the second spring 8435 is pre-tensioned to cause the shoulder bolt 8720 to engage with the slot 8715 in a resting or default position. While a diameter of the upper shoulder 8745 is shown as substantially equal to a diameter of the slot 8715, in some embodiments the diameter of the upper shoulder 8745 is less than the diameter of the slot 8715 to allow for a predetermined amount of play between the external cup 8705 and the mounting cup 8415.

Referring still to FIGS. 93 and 94, the second spring 8435 is shown to extend at least partially into the mounting cup 8415 in second spring cavity 8726. In a resting or stable condition, the second spring cavity 8726 is shown aligned with the spring cavity 8725. If the one of the external cup 8705 or the mounting cup 8415 were to rotate relative to the other, the spring cavity 8725 and the second spring cavity 8726 would move apart from each other. As the second spring 8435 is coupled to each of the spring cavity 8725 and the second spring cavity 8726, this movement causes the second spring 8435 to stretch and impart a force in the opposite direction of rotation. The second spring 8435 may be mechanically fastened, glued, potted, or otherwise couple to the mounting cup 8415 in the second spring cavity 8726 and the spring cavity 8725.

Referring now to FIG. 95, a section view across the section line 95 of FIG. 90 is shown, according to an exemplary embodiment. As discussed above with reference to at least FIGS. 80 and 82, a force exerting member (e.g., a resilient member such as a spring or expanding foam) applies an axial force onto the mounting cup 8415 substantially parallel with an axis of rotation of the pivot point the sensor 8400 is coupled to. As shown in FIG. 95, the first spring 8430 is positioned between the external cup 8705 and the mounting cup 8415. The first spring 8430 is shown as a coil spring, and applies an axial force down towards the open end of the external cup 8705.

Still referring to FIG. 95, the magnetic sensor 8425 is positioned above the sensor magnet 8410 which is coupled to the adaptor 8411. As discussed above, the adaptor 8411 may be fixedly coupled to a pin such as pin 8405 such that rotation of the pin 8405 causes rotation of adaptor 8411 and in turn the sensor magnet 8410. A threaded rod 760 is shown extending from the adaptor 8411 to couple the adaptor 8411 to pin. As further shown in FIG. 95, the head 8740 of the shoulder bolt 8720 engages the ledge 8716 of the slot 8715 to capture the external cup 8705. FIG. 95 shows a section view across section line 96 of FIG. 91, and similarly shows the shoulder bolt 8720 engaged with the ledge 8716 of the slot 8715.

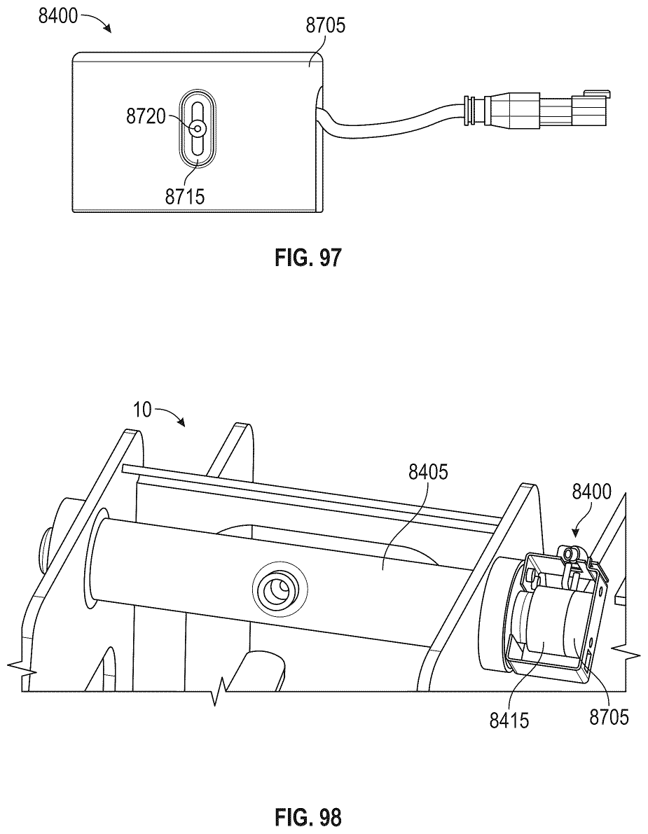

Referring now to FIG. 97, a side view of the sensor 8400 of FIG. 89 is shown, according to an exemplary embodiment. The shoulder bolt 8720 is shown positioned within the slot 8715 of the external cup 8705. The slot 8715 is shown extending vertically along an axis parallel or substantially parallel with a rotation axis of the sensor magnet 8410. This slot 8715 allows the mounting cup 8415 to move vertically relative to the external cup 8705, for example due to the force of the first spring 8430, without being impeded by the shoulder bolt 8720.

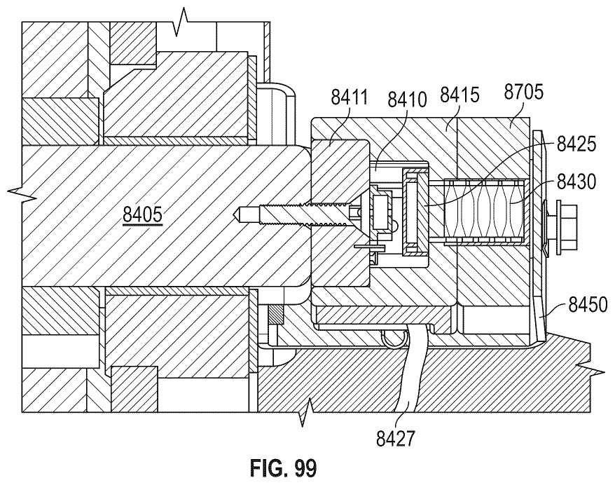

Referring now to FIG. 98, the sensor 8400 is shown mounted to a lift device 10, according to an exemplary embodiment. The sensor includes a mounting cup 8415 and a external cup 8705. The external cup 8705 in FIG. 98 is shown as having a diameter substantially the same as the mounting cup 8415, such that the mounting cup 8415 rests below but not within the external cup 8705. As shown in FIG. 99 the external cup 8705 contains the first spring 8430 in engagement with the mounting cup 8415. The external cup 8705 is coupled to the bracket 8450 to maintain its position.

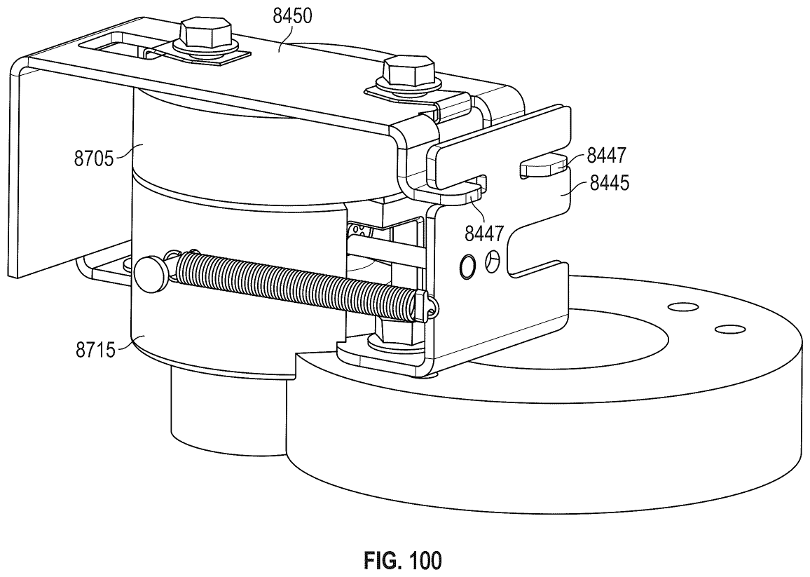

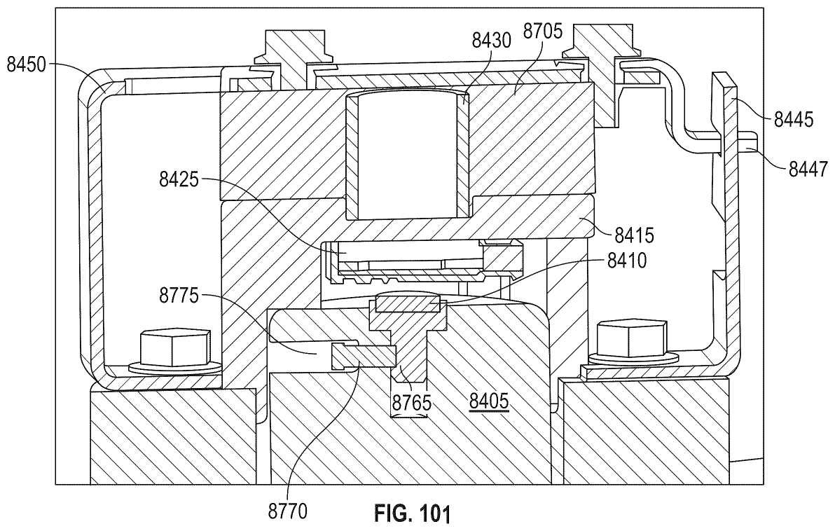

Referring now to FIG. 100, the sensor 8400 is shown with the external cup 8705, according to another embodiment. The external cup 8705 is retained in place by bracket 8450. As described above, bracket 8450 may be made of metal such as stamped steel or aluminum and provide support to the sensor 8400. Referring now to FIG. 101, a section view of the sensor 8400 of FIG. 100 is shown. In the sensor 8400 of FIG. 100, the sensor magnet 8410 is secured to the pin 8405 by a set screw 8711 in a slot 8775 of the pin 8405.

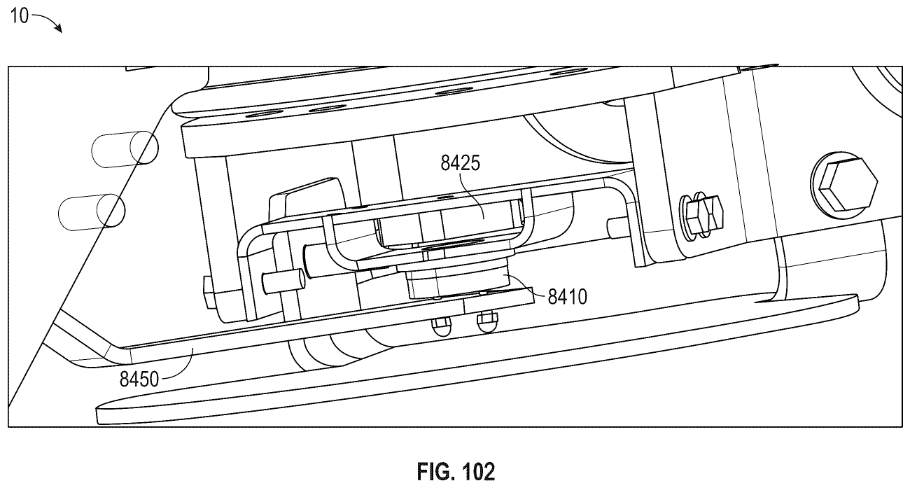

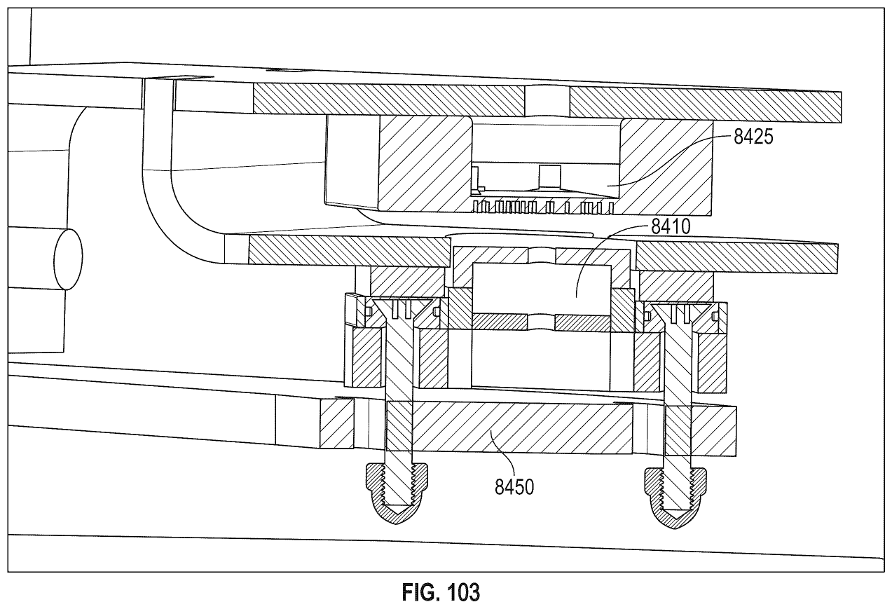

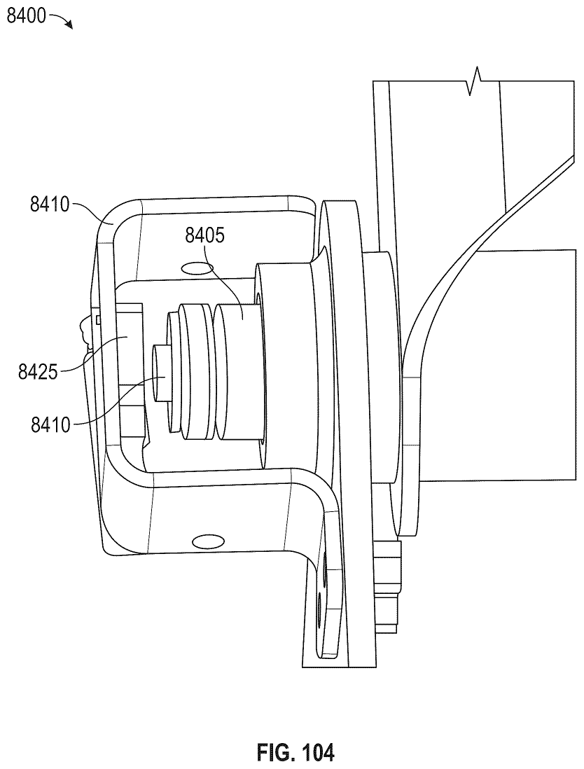

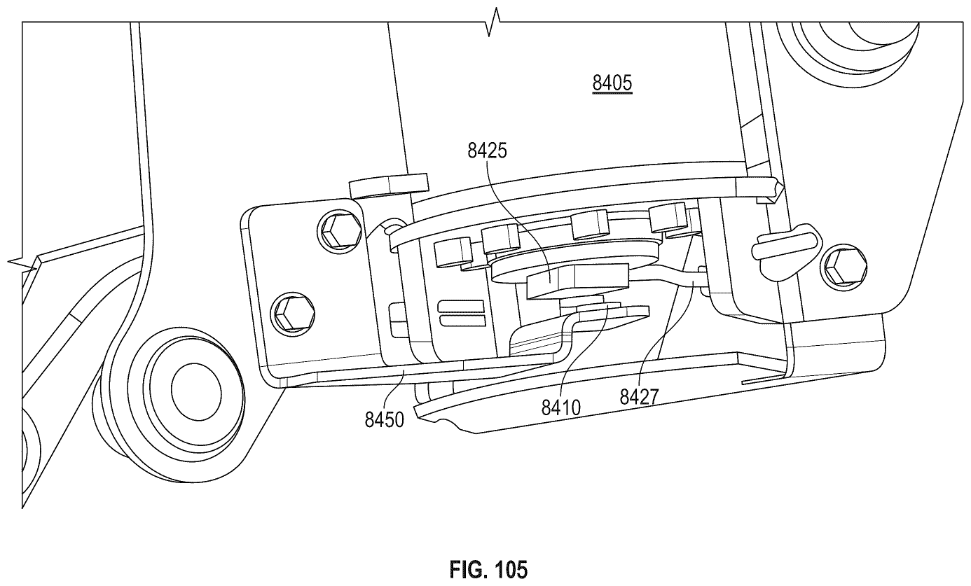

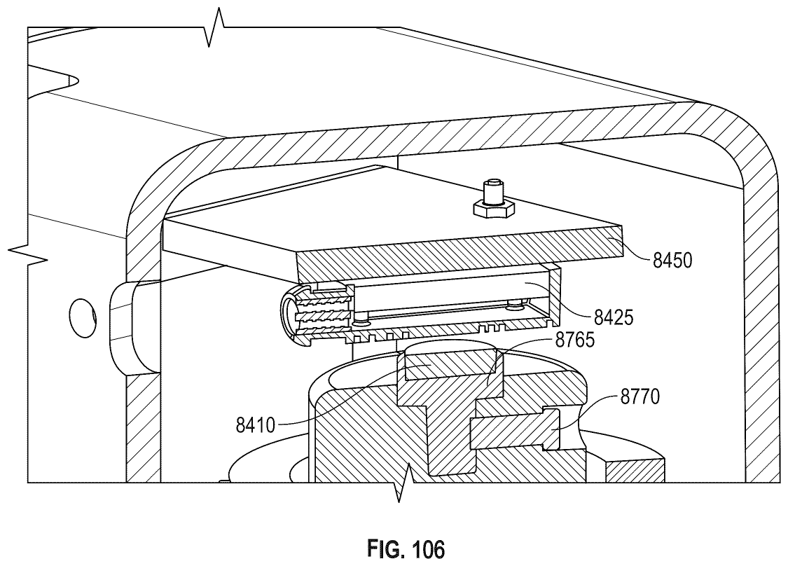

FIGS. 102-106 discloses additional embodiments of the sensor 8400 in which an air gap is maintained between the magnetic sensor 8425 and the sensor magnet 8410 without the use of the mounting cup 8415. For example, as shown in FIG. 102, the sensor magnet may be coupled to the bracket 8450 and the magnetic sensor 8425 coupled to the pin 8405 for rotation. FIG. 103 shows a section view of the sensor 8400 of FIG. 101. The additional embodiments illustrated in FIGS. 102-106 includes alternative arrangements of bracket 8450 to support one of the magnetic sensor 8425 and the sensor magnet 8410 relative to the other. For example, FIG. 104 shows a sensor 8400 with an airgap between the magnetic sensor 8425 and the sensor magnet 8410 coupled to the pin 8405. The magnetic sensor 8425 is supported by bracket 8450. FIG. 105 shows a sensor 8400 with the magnetic sensor 8425 coupled to the pin 8405 and the sensor magnet 8410 supported by the bracket 8450. FIG. 106 shows a section view of a sensor 8400 with an air gap between the magnetic sensor 8425 and the sensor magnet 8410. As discussed above, in some embodiments, the magnetic sensor 8425 is fixed to the pin 8405 and rotates relative to the magnetic sensor 8425 which is kept in a fixed orientation, while in other embodiments the sensor magnet 8410 is fixed to the pin 8405 and rotates relative to the magnetic sensor 8425 which is kept in a fixed orientation.

### Configuration of the Exemplary Embodiments

As utilized herein with respect to numerical ranges, the terms “approximately,” “about,” “substantially,” and similar terms generally mean+/−10% of the disclosed values. If values are not disclosed, they mean+/−10% from the null, zero, or absolute value. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure. For example, although the sensor 8400 is shown with the sensor magnet 8410 coupled to the pin 405 and the magnetic sensor 425 remains stationary relative to the pin 405, it should be noted that the positions can be reversed, with the magnetic sensor 425 coupled to the pin while the sensor magnet 410 remains stationary relative to the pin 405.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing control systems including computer processors, processing circuitry, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon that cause processing circuitry to perform multiple actions. Such machine-readable media can be any available media that can be accessed by a general purpose or special purpose computer (e.g., processing circuitry) or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

It is important to note that the construction and arrangement of the lift device 10, control system 2100, coil management system 3200, control system 4100, system 6100, and battery 64 as shown in the various exemplary embodiments is illustrative only. Additionally, any element disclosed in one embodiment may be incorporated or utilized with any other embodiment disclosed herein. For example, the techniques of the platform sensors 202, the platform sensors 4202, and the construction of the system of the exemplary embodiment shown in at least FIGS. 13, 47, 50-57, 59, 60, 65, 66, and 86 may be incorporated in the lift device 10 of the embodiment shown in at least FIG. 5. Although only one example of an element from one embodiment that can be incorporated or utilized in another embodiment has been described above, it should be appreciated that other elements of the various embodiments may be incorporated or utilized with any of the other embodiments disclosed herein.

1-20. (canceled)

21. A lift device comprising:
a base assembly including a drive motor;
a platform assembly;
a lift assembly coupled between the base assembly and the platform assembly and including a lift actuator configured to raise or lower the platform assembly;
a rotary motor configured to rotate the platform assembly; and
a controller in communication with the drive motor, the lift actuator, and the rotary motor, the controller being configured to:
record steps performed by the lift actuator and the rotary motor during a positioning event that moves the platform assembly from an initial position to a work site; and
operate the lift actuator and the rotary motor to perform the steps performed during the positioning event in a reverse order and in a movement direction that is opposite to a direction of the steps recorded during the positioning event to automate movement of the platform assembly from the work site to the initial position.

22. The lift device of claim 21, wherein the controller is configured to, after operating the lift actuator and the rotary motor to perform the steps in the reverse order, operate the lift actuator and the rotary motor in a forward order to automate movement of the platform assembly from the initial position back to the work site.

23. The lift device of claim 21, further comprising an initiate input in communication with the controller, wherein the controller is configured to begin to record the steps performed in the positioning event in response to receiving an initiate signal from the initiate input.

24. The lift device of claim 23, wherein the controller is configured to stop recording the steps performed in the positioning event in response to receiving a stop signal from the initiate input.

25. The lift device of claim 23, wherein the controller is configured to stop recording the steps performed in the positioning event in response to the platform assembly being stationary for a predefined amount of time.

26. The lift device of claim 21, further comprising a execute replay input, wherein the controller is configured operate the lift actuator and the rotary motor to perform the steps performed during the positioning event in the reverse order in response to receiving an execute reverse replay signal from the execute replay input.

27. The lift device of claim 26, wherein the execute replay input is prevented from outputting an execute forward replay signal after the controller initially records the steps in the positioning event.

28. The lift device of claim 27, wherein the after operating the lift actuator and the rotary motor to perform the steps in the reverse order, the controller is configured to receive the execute forward replay signal from the execute replay input and operate the lift actuator and the rotary motor in a forward order to automate movement of the platform assembly from the initial position back to the work site.

29. The lift device of claim 21, further comprising an object detection sensor coupled to the platform assembly or the lift assembly, wherein the controller is in communication with the object detection sensor and configured to stop operation of the lift actuator and the rotary motor in response to detecting an object.

30. A lift device comprising:
a base assembly including a drive motor;
a platform assembly;
a lift assembly coupled between the base assembly and the platform assembly and including a plurality of actuators configured to move the platform assembly relative to the base assembly;
a user interface configured to receive one or more inputs and control operation of the plurality of actuators; and
a controller in communication with the plurality of actuators and the user interface, the controller being configured to:
record steps input to the user interface during a positioning event that moves the platform assembly from an initial position to a work site, wherein each of the steps in the positioning event includes a first direction and a magnitude associated with moving one of the plurality of actuators; and
operate the plurality of actuators to perform the steps recorded during the positioning event in a reverse order to automate movement of the platform assembly from the work site to the initial position, wherein each of the steps performed in the reverse order include a second direction, opposite to the first direction, and the magnitude associated with moving the one of the plurality of actuators recorded during the positioning event.

31. The lift device of claim 30, further comprising an initiate input in communication with the controller, wherein the controller is configured to begin to record the steps performed in the positioning event in response to receiving an initiate signal from the initiate input.

32. The lift device of claim 31, wherein the controller is configured to stop recording the steps performed in the positioning event in response to receiving a stop signal from the initiate input.

33. The lift device of claim 31, wherein the controller is configured to stop recording the steps performed in the positioning event in response to the platform assembly being stationary for a predefined amount of time.

34. The lift device of claim 30, further comprising a execute replay input, wherein the controller is configured operate the plurality of actuators to perform the steps recorded during the positioning event in the reverse order in response to receiving an execute reverse replay signal from the execute replay input.

35. The lift device of claim 34, wherein the execute replay input is prevented from outputting an execute forward replay signal after the controller initially records the steps in the positioning event.

36. The lift device of claim 35, wherein the after operating the plurality of actuators to perform the steps recorded during the positioning event in the reverse order, the controller is configured to receive the execute forward replay signal from the execute replay input and operate the steps of the positioning event in a forward order to automate movement of the platform assembly from the initial position back to the work site.

37. The lift device of claim 30, further comprising an object detection sensor coupled to the platform assembly or the lift assembly, wherein the controller is in communication with the object detection sensor and configured to stop operation of the plurality of actuators in response to detecting an object.

38. The lift device of claim 30, wherein the controller is configured to, after operating the plurality of actuators to perform the steps recorded during the positioning event in the reverse order, operate the plurality of actuators in a forward order to automate movement of the platform assembly from the initial position back to the work site.

39. A method for controlling a platform assembly of a lift device, the method comprising:
recording an input to a user interface during a positioning event that results in movement a platform assembly from an initial position to a work site, wherein the input is recorded as a step that includes moving an actuator or motor in a first direction with a magnitude; and
triggering a travel replay procedure; and
in response to triggering the travel replay procedure, performing the step recorded during the positioning event in a reverse order to automate movement of the platform assembly from the work site to the initial position, wherein the step performed in the reverse order includes moving the actuator or motor in a second direction, opposite to the first direction, and the magnitude.

40. The method of claim 39, further comprising:
stopping operation of the actuator or motor in response to detecting an object in a path of the platform assembly.

41-140. (canceled)
